(19) United States
(12) Patent Application Publication
(10) Pub. No.: US 2024/0381346 A1
(43) Pub. Date: Nov. 14, 2024

(54) FULL POWER UPLINK TRANSMISSION

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 18/639,839

(22) Filed: Apr. 18, 2024

Related U.S. Application Data
(60) Provisional application No. 63/462,898, filed on Apr. 28, 2023.
(60) Provisional application No. 63/470,378, filed on Jun. 1, 2023.
(60) Provisional application No. 63/533,860, filed on Aug. 21, 2023.
(60) Provisional application No. 63/534,277, filed on Aug. 23, 2023.
(60) Provisional application No. 63/534,509, filed on Aug. 24, 2023.
(60) Provisional application No. 63/537,312, filed on Sep. 8, 2023.

(51) Int. Cl. H04W 72/1268; H04B 7/06; H04L 5/00; H04W 72/51

(52) U.S. Cl. CPC H04W 72/1268; H04B 7/0639; H04L 5/0051; H04W 72/51

(57) ABSTRACT

Apparatuses and methods for enabling full power uplink (UL) transmission. A method performed by a user equipment (UE) includes transmitting UE capability information including (i) information for a codebook-based UL transmission using eight antenna ports and (ii) information indicating whether the UE supports a UL full power transmission mode of fullpowerMode1 or fullpowerMode2; receiving a physical uplink shared channel (PUSCH) configuration; and receiving a transmit precoding matrix indicator (TPMI). The PUSCH configuration includes parameters indicating a codebook for the TPMI and ul-FullPowerTransmission8Tx. The method further includes determining a PUSCH transmission based on the PUSCH configuration, determining a power level for the PUSCH transmission based on the PUSCH configuration, and transmitting the PUSCH transmission with the determined power level. The power level corresponds to full power if the TPMI is a full power TPMI. The TPMI indicates a precoding matrix and a number of layers for the PUSCH transmission.

### CROSS-REFERENCE TO RELATED AND CLAIM OF PRIORITY

The present application claims priority under 35 U.S.C. § 119(e) to U.S. Provisional Patent Application No. 63/462,898 filed on Apr. 28, 2023; U.S. Provisional Patent Application No. 63/470,378 filed on Jun. 1, 2023; U.S. Provisional Patent Application No. 63/533,860 filed on Aug. 21, 2023; U.S. Provisional Patent Application No. 63/534,277 filed on Aug. 23, 2023; U.S. Provisional Patent Application No. 63/534,509 filed on Aug. 24, 2023; and U.S. Provisional Patent Application No. 63/537,312 filed on Sep. 8, 2023, which are hereby incorporated by reference in their entirety.

### TECHNICAL FIELD

The present disclosure relates generally to wireless communication systems and, more specifically, the present disclosure is related to apparatuses and methods for enabling full power uplink (UL) transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to enabling full power UL transmission.

In one embodiment, a user equipment (UE) is provided. The UE includes a transceiver configured to transmit UE capability information including (i) information for a codebook-based UL transmission using eight antenna ports and (ii) information indicating whether the UE supports a UL full power transmission mode of fullpowerMode1 or fullpowerMode2, receive a physical uplink shared channel (PUSCH) configuration, and receive a transmit precoding matrix indicator (TPMI). The PUSCH configuration includes a first parameter indicating a codebook for the transmit precoding matrix indicator (TPMI) and a second parameter ul-FullPowerTransmission8Tx. The UE further includes a processor operably coupled to the transceiver. The processor, based on the PUSCH configuration, is configured to determine a PUSCH transmission and determine a power level for the PUSCH transmission. The transceiver is further configured to transmit the PUSCH transmission with the determined power level. The power level corresponds to full power if the TPMI is a full power TPMI. The TPMI indicates a precoding matrix and a number of layers for the PUSCH transmission.

In another embodiment, a base station (BS) is provided. The BS includes a transceiver configured to receive, from a UE, UE capability information including (i) information for a codebook-based UL transmission using eight antenna ports and (ii) information indicating whether the UE supports a UL full power transmission mode of fullpowerMode1 or fullpowerMode2, transmit a PUSCH configuration, transmit a TPMI, and receive a PUSCH associated with the PUSCH configuration. The PUSCH configuration includes a first parameter indicating a codebook for the TPMI and a second parameter ul-FullPowerTransmission8Tx. A power level for the PUSCH corresponds to full power if the TPMI is a full power TPMI. The TPMI indicates a precoding matrix and a number of layers for the PUSCH.

In yet another embodiment, a method performed by a UE is provided. The method includes transmitting UE capability information including (i) information for a codebook-based UL transmission using eight antenna ports and (ii) information indicating whether the UE supports a UL full power transmission mode of fullpowerMode1 or fullpowerMode2; receiving a PUSCH configuration; and receiving a TPMI. The PUSCH configuration includes a first parameter indicating a codebook for the TPMI and a second parameter ul-FullPowerTransmission8Tx. The method further includes determining a PUSCH transmission based on the PUSCH configuration, determining a power level for the PUSCH transmission based on the PUSCH configuration, and transmitting the PUSCH transmission with the determined power level. The power level corresponds to full power if the TPMI is a full power TPMI. The TPMI indicates a precoding matrix and a number of layers for the PUSCH transmission.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of example antenna port layouts at a UE according to embodiments of the present disclosure;

FIG. 7 illustrates a diagram of example virtualized and non-virtualized sounding reference signal (SRS) ports according to embodiments of the present disclosure;

FIG. 8 illustrates a diagram of an example TPMI index according to embodiments of the present disclosure; and

FIG. 9 illustrates an example method performed by a UE in a wireless communication system according to embodiments of the present disclosure.

### DETAILED DESCRIPTION

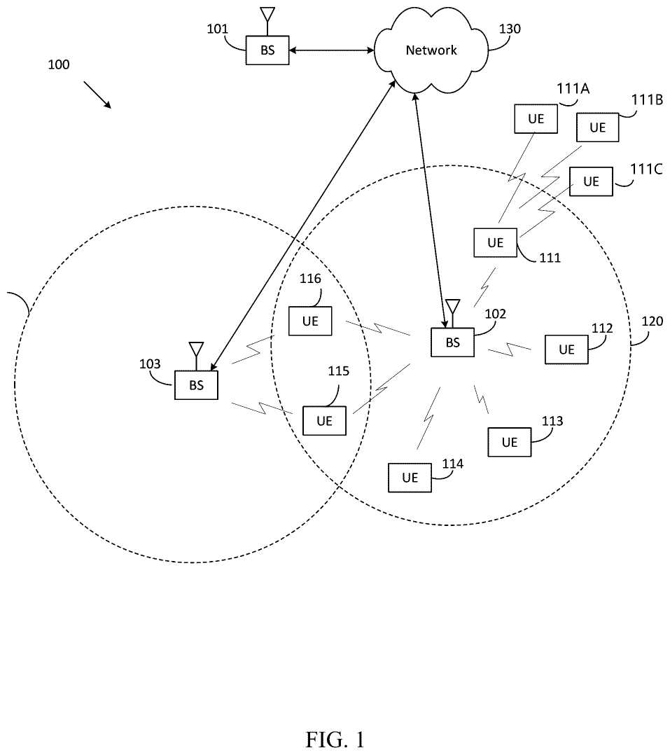

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 36.211 v17.0.0, “E-UTRA, Physical channels and modulation;” [2] 3GPP TS 36.212 v17.0.0, “E-UTRA, Multiplexing and Channel coding;” [3] 3GPP TS 36.213 v17.0.0, “E-UTRA, Physical Layer Procedures;” [4] 3GPP TS 36.321 v17.0.0, “E-UTRA, Medium Access Control (MAC) protocol specification;” [5] 3GPP TS 36.331 v17.0.0, “E-UTRA, Radio Resource Control (RRC) Protocol Specification;” [6] 3GPP TS 38.211 v17.0.0, “NR, Physical channels and modulation;” [7] 3GPP TS 38.212 v17.0.0, “NR, Multiplexing and Channel coding;” [8] 3GPP TS 38.213 v17.0.0, “NR, Physical Layer Procedures for Control;” [9] 3GPP TS 38.214 v17.0.0, “NR, Physical Layer Procedures for Data;” [10] 3GPP TS 38.215 v17.0.0, “NR, Physical Layer Measurements;” [11]3GPP TS 38.321 v17.0.0, “NR, Medium Access Control (MAC) protocol specification;” [12] 3GPP TS 38.331 v17.0.0, “NR, Radio Resource Control (RRC) Protocol Specification;” and [13] 3GPP TS 38.306 v17.4.0.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for performing full power UL transmission in a wireless communication system. In certain embodiments, and one or more of the gNBs 101-103 includes circuitry, programing, or a combination thereof, for supporting the enabling of full power UL transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

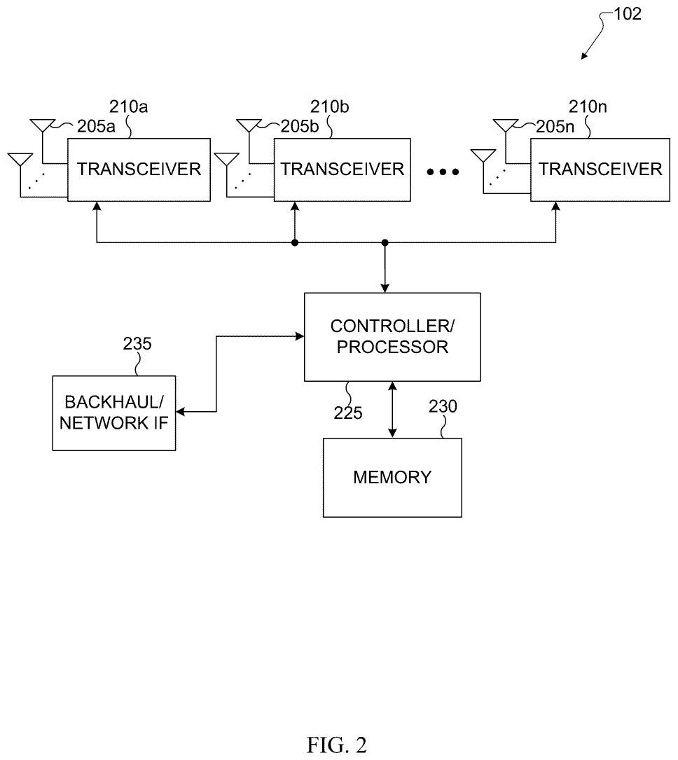

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting the enabling of full power UL transmission in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

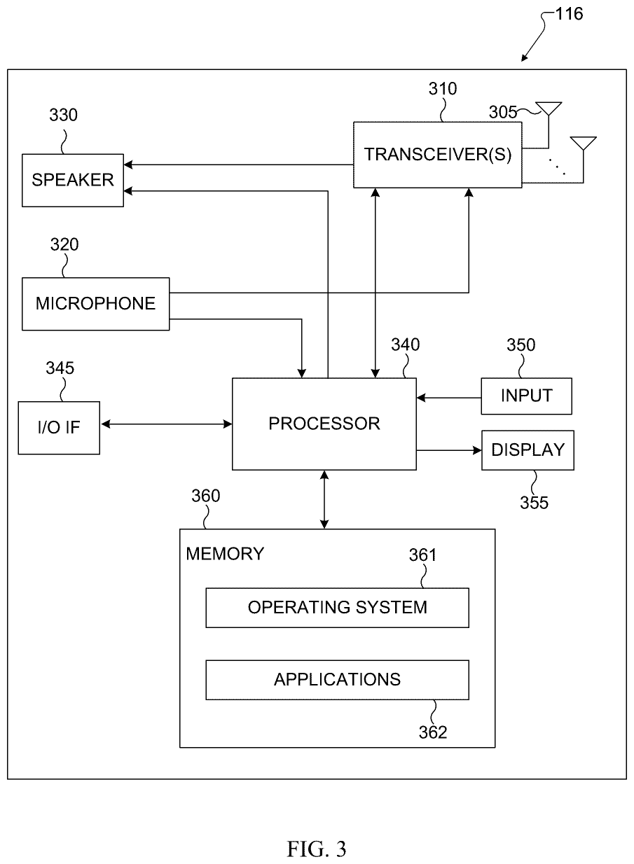

FIG. 3 illustrates an example UE according to embodiments of the present disclosure. The embodiment of the UE illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE includes antenna(s) 305, a transceiver(s) 310, and a microphone 320. The UE also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a sidelink (SL) channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE. For example, the processor 340 could control the reception of DL channels and/or signals and SL channels and/or signals and the transmission of UL channels and/or signals and SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for full power UL transmission in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE can use the input 350 to enter data into the UE. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE configured as a mobile telephone or smartphone, UEs could be configured to operate as other types of mobile or stationary devices.

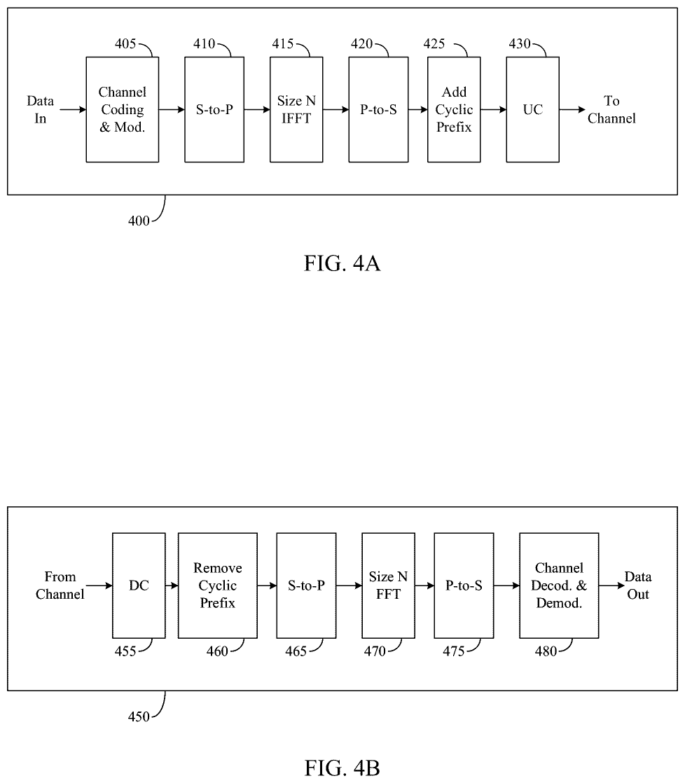

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE). However, it will be understood that the receive path 450 can be implemented in a gNB and that the transmit path 400 can be implemented in a UE. In some embodiments, the transmit path 400 is enabled to perform full power UL transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE, or a spatial TX filter for transmission of uplink channels from the UE.

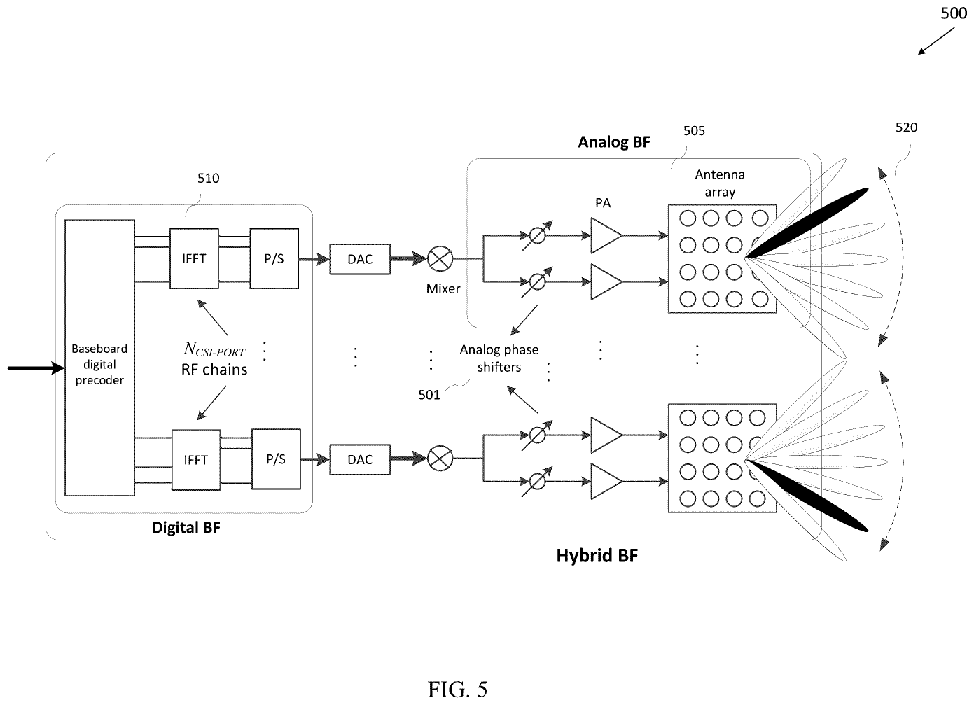

FIG. 5 illustrates an example of a transmitter structure 500 for beamforming according to embodiments of the present disclosure. In certain embodiments, one or more of gNB 102 or UE includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The present disclosure relates generally to wireless communication systems and, more specifically, to full power codebook-based UL transmission.

In NR, two transmission schemes are supported for physical uplink shared channel (PUSCH): codebook based transmission and non-codebook based transmission. The UE (e.g., UE 116) is configured with codebook based transmission when the higher layer parameter txConfig in pusch-Config is set to ‘codebook’, the UE is configured non-codebook based transmission when the higher layer parameter txConfig is set to ‘nonCodebook’.

According to Section 6.1.1.1 [REF9], the following is supported for codebook based UL transmission.

For codebook-based transmission, PUSCH can be scheduled by downlink control information (DCI) format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRS resource indicator (SRI), TPMI and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 is defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . ν−1} and that corresponds to the SRS resource selected by the SRI when multiple SRS resources are configured, or if a single SRS resource is configured TPMI is used to indicate the precoder to be applied over the layers {0 . . . ν−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the physical downlink control channel (PDCCH) carrying the SRI.

For codebook-based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fullyAndPartialAndNonCoherent’.

A UE reporting its UE capability of ‘nonCoherent’ transmission shall not expect to be configured by either codebookSubset or codebookSubsetForDCI-Format0-2 with ‘fullyAndPartialAndNonCoherent’ or with ‘partialAndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook-based transmission, only one SRS resource can be indicated based on the SRI from within the SRS resource set. Except when higher layer parameter ul-FullPowerTransmission is set to ‘fullpowerMode2’, the maximum number of configured SRS resources for codebook-based transmission is 2. If aperiodic SRS is configured for a UE, the SRS request field in DCI triggers the transmission of aperiodic SRS resources.

A UE shall not expect to be configured with higher layer parameter ul-FullPowerTransmission set to ‘fullpowerMode1’ and codebookSubset or codebookSubsetDCI-0-2 set to ‘fullAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The DM-RS antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for these SRS resources.

In the rest of the present disclosure, ‘fullAndPartialAndNonCoherent’, ‘partialAndNonCoherent’, and ‘Non-Coherent’ are referred to codebookSubsets depending on three coherence type/capability, where the term ‘coherence’ implies each or a subset of antenna ports at the UE that can be used to transmit a layer coherently. In particular:
the term ‘full-coherence’ (FC) implies each of the antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset=‘fullAndPartialAndNonCoherent’, the UL codebook includes three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W=1 for single-layer transmission on a single antenna port, otherwise by Table 1 to Table 6, which are copied below.

The rank (or number of layers) and the corresponding precoding matrix Ware indicated to the UE using TRI and transmit precoding matrix indicator (TPMI), respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 1
Precoding matrix W for single-layer transmission using two antenna ports

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single-layer transmission using four antenna ports with transform
precoding disabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix W for two-layer transmission using two antenna ports with
transform precoding disabled

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 4
Precoding matrix W for two-layer transmission using four antenna ports with transform
precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for three-layer transmission using four antenna ports with transform
precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6
Precoding matrix W for four-layer transmission using four antenna ports with transform
precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 7 and Table 8, where rank=r corresponds to (and is equivalent to) r layers.

TABLE 7
Total power of precoding matrix W for 2 antenna ports

| | |
|---|---|
| Non-Coherent | Full-Coherent |
| (NC) TPMIs | (FC) TPMIs |

| | TPMI | Total | TPMI | Total |
|---|---|---|---|---|
| Rank | indices | power | indices | power |
| 1 | 0-1 | ½ | 2-5 | 1 |
| 2 | 0 | 1 | 1-2 | 1 |

TABLE 8
Total power of precoding matrix W for 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9
TPMI indices for codebookSubsets for 2 antenna ports

| | Non- | |
|---|---|---|
| Rank | Coherent | fullAndPartialAndNonCoherent |
| 1 | 0-1 | 0-5 |
| 2 | 0 | 0-2 |

TABLE 10
TPMI indices for codebookSubsets for 4 antenna ports

| | Non- | | |
|---|---|---|---|
| Rank | Coherent | partialAndNonCoherent | fullAndPartialAndNonCoherent |
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

The total power of the pre-coding matrix W for different rank and coherence types is summarized in Table and Table. We can observe the following issues.
For non-coherent and partial-coherent TPMIs, total power increases as rank increases, which implies that the TPMI selection will be biased to higher rank. In particular, even for cell-edge UEs, rank 1 TPMI may not be selected, which can severely affect cell-edge performance.
For a given rank, total power of non-coherent TPMIs≤total power of partial-coherent TPMIs≤total power of full-coherent TPMIs. The reason for this trend is that the power of non-zero antenna ports does not change across three types of TPMIs. This may be beneficial in some scenarios, for example, UE implementation for power saving. However, this may not be desired always.

Embodiments of the present disclosure recognize that the abovementioned issues can be handled by TPMI or TPMI group signalling from the UE (as part of UE capability signalling), where the signalling indicates TPMIs or TPMI groups for which the UE can achieve full power in UL transmission. In Rel.16 NR specification [TS 38.306, 38.331], the TPMI or TPMI group signaling is supported for 2 or 4 antenna ports at the UE.

In this disclosure, several embodiments are provided for the TPMI grouping signalling for >4 antenna ports (e.g., 8 antenna ports) at the UE.

The present disclosure relates to TPMI group signaling (from the UE) for >4 (e.g., 8) antenna ports. The present disclosure includes the following:
TPMI groups based on common TPMI groups (for 2 or 4 antenna ports)
New TPMI groups (different from common) for >4 antenna ports
Associated signaling/configuration

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, for brevity, both frequency division duplexing (FDD) and time division duplexing (TDD) are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure covers several components which can be used in conjunction or in combination with one another, or can operate as standalone schemes.

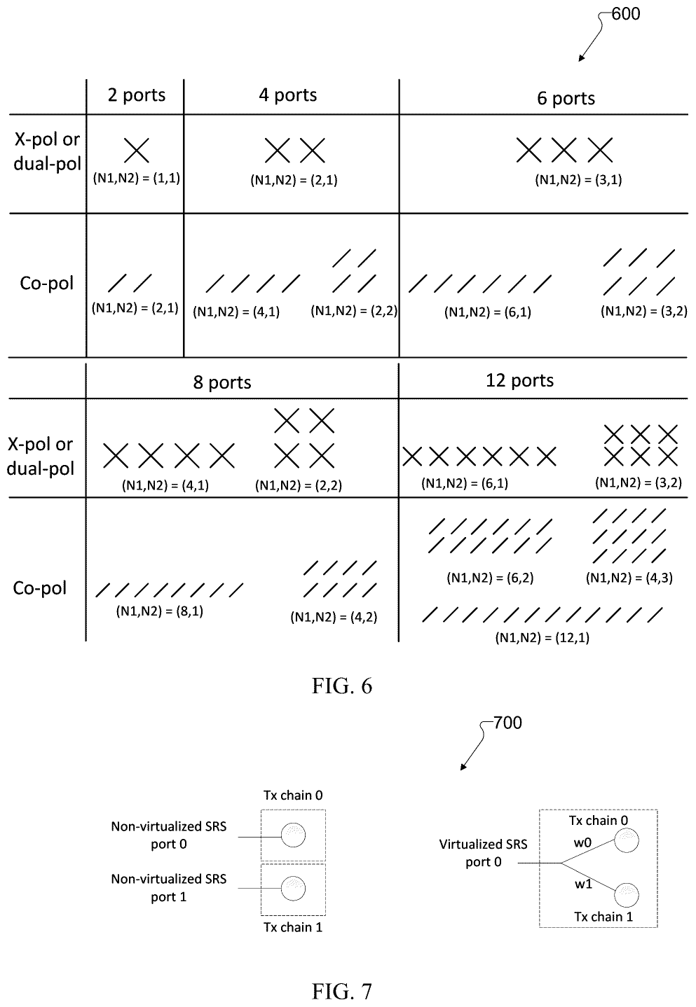

FIG. 6 illustrates a diagram of example antenna port layouts 600 at a UE according to embodiments of the present disclosure. For example, antenna port layouts 600 at a UE can be implemented in any of the UEs 111-116 of FIG. 1. This example is for illustration only and other embodiments can be used without departing from the scope of the present disclosure.

In one example, we assume each of the antenna ports of the UE (e.g., UE 116) belong to a single antenna panel (i.e., they are co-located, for example, at one plane, side, or edge of the UE). We further assume that N₁ and N₂ are the number of antenna ports with the same polarization in the first and second dimensions, respectively. For 2D antenna port layouts, we have N₁>1, N₂>1, and for 1D antenna port layouts, we either have N₁>1 and N₂=1 or N₂>1 and N₁=1. In the rest of the present disclosure, 1D antenna port layouts with N₁>1 and N₂=1 is considered. The present disclosure, however, is applicable to the other 1D port layouts with N₂>1 and N₁=1. Also, in the rest of the present disclosure, we assume that N₁≥N₂. The present disclosure, however, is applicable to the case when N₁<N₂, and the embodiments for N₁>N₂ applies to the case N₁<N₂ by swapping/switching (N₁, N₂) with (N₂, N₁). For a (single-polarized) co-polarized antenna port layout, the total number of antenna ports is N₁N₂ and for a dual-polarized antenna port layout, the total number of antenna ports is 2N₁N₂. An illustration of antenna port layouts for {2, 4, 6, 8, 12} antenna ports at UE is shown in Table 11.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

In one example, the UL codebook W for P antenna ports at the UE is based on pre-coding vectors which are according to one of the two alternatives in Table 11 depending on whether the antenna ports are co-polarized or cross-/dual-polarized.

TABLE 11
Pre-coding vectors

| Co-pol | Dual-pol |
|---|---|
| ${v}_{l , m} = \frac{{v}_{l , m}}{\sqrt{{N}_{1} {N}_{2}}}$ | ${v}_{l , m , n} = \frac{1}{\sqrt{2 {N}_{1} {N}_{2}}} [ \begin{matrix}{v}_{l , m} \\ {φ}_{n} {v}_{l , m}\end{matrix} ]$ |

Here, v_{l,m} is a Kronecker product (⊗) of vectors wₗ and uₘ of lengths N₁ and N₂, respectively. In one example, wₗ and uₘ are oversampled DFT vectors, i.e.,

$${w}_{l} = [ \begin{matrix}1 & {e}^{j \frac{2 π l}{{O}_{1} {N}_{1}}} & {e}^{j \frac{4 π l}{{O}_{1} {N}_{1}}} & ⋯ & {{e}^{j \frac{2 π l ( {N}_{1} - 1 )}{{O}_{1} {N}_{1}}} ]}^{T}\end{matrix}$$

$${u}_{m} = \{ \begin{matrix}[ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}$$

where O₁ and O₂ are oversampling factors in two dimensions, and v_{l,m} is then given by

$${v}_{l , m} = {w}_{l} ⊗ {u}_{m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T}$$

In one example, both O₁, O₂∈{2,4,8}. In one example, O₁ and O₂ can take the same values as Rel.15 NR Type I codebook (cf. 5.2.2.2.1, TS 38.214), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g., via higher layer).

The quantity φₙ is a co-phase for dual-polarized antenna port layouts. In one example, φₙ=e^{jπn/2}, where n∈{0,1,2,3} implying that φₙ belongs to QPSK alphabet {1, j, −1, −j}.

In one example, the values of N₁ and N₂ are configured, e.g., with the higher layer parameter n1-n2-ul. The supported configurations of (N₁, N₂) for a given number of antenna ports (P) is given in Table 12.

TABLE 12
Configurations of (N₁, N₂)

| Number of | Dual-pol | Co-pol |
|---|---|---|
| antenna ports, P | (N₁, N₂) | (N₁, N₂) |
| 2 | (1, 1) | (2, 1) |
| 4 | (2, 1) | (2, 2), (4, 1) |
| 6 | (3, 1) | (3, 2), (6, 1) |
| 8 | (2, 2), (4, 1) | (4, 2), (8, 1) |
| 12 | (3, 2), (6, 1) | (4, 3), (6, 2), (12, 1) |
| 16 | (4, 2), (8, 1) | (8, 2), (4, 4), (16, 1) |

In one example, the values of N₁ and N₂ are fixed for a given number of antenna ports. For example, (N₁, N₂)=(P, 1) for co-pol and

$$( \frac{P}{2} , 1 )$$

for dual-pol antenna. In one example, only one (N₁, N₂) is supported for each value of P, where the supported (N₁, N₂) is one of pairs in Table 12.

The dual-polarized antenna layout is assumed in the rest of the disclosure. The number of antenna ports is assumed to be P=8 in the rest of the disclosure.

In one example, P antenna ports can be divided into multiple groups. Let N_{g} be the number of antenna port groups. When each group comprises the same number of antenna ports, then each groups has the antenna layout with (N₁, N₂) value as shown in Table 13.

TABLE 13

| N_{g} | (N₁, N₂) |
|---|---|
| 1 | (4, 1), (2, 2) |
| 2 | (2, 1) |
| 4 | (1, 1) |
| 8 | Not applicable |

In one example, N_{g}=1 corresponds to a single antenna panel. In one example, N_{g}=1 corresponds to a full coherent (FC) UE or FC antenna layout.

In one example, N_{g}=2 corresponds to two antenna panels. In one example, N_{g}=2 corresponds to a partial coherent (PC) UE or PC antenna layout.

In one example, N_{g}=4 corresponds to four antenna panels. In one example, N_{g}=4 corresponds to a partial coherent (PC) UE or PC antenna layout.

In one example, N_{g}=8 corresponds to eight antenna panels. In one example, N_{g}=8 corresponds to a non-coherent (NC) UE or NC antenna layout.

ul-FullPwrMode2-TPMIGroup-r16 indicates the UE supported TPMI group(s) which delivers full power. The capability signalling comprises the following values:
twoPorts-r16 indicates a 2-bit bitmap, where the leading/leftmost bit (bit 0) corresponds to {TPMI index=0}. The next bit (bit 1) corresponds to {TPMI index=1} and the TPMI index is as specified in Table 6.3.1.5-1 of TS 38.211 [6].
fourPortsNonCoherent-r16 indicates the TPMI groups {G0-3}.
fourPortsPartialCoherent-r16 indicates the TPMI groups {G0-6}.

UE indicates support of this feature shall also indicate support of ul-FullPwrMode2-MaxSRS-ResInSet.

Definition of G0˜G6 can be found in the table below:

TABLE 14

| ID | TPMI groups | | | |
|---|---|---|---|---|
| G0 | $\frac{1}{2} [ \begin{matrix}1 \\ 0 \\ 0 \\ 0\end{matrix} ] ,$ | | | |
| G1 | | $\frac{1}{2} [ \begin{matrix}1 \\ 0 \\ 0 \\ 0\end{matrix} ] ,$ | $\frac{1}{2} [ \begin{matrix}0 \\ 0 \\ 1 \\ 0\end{matrix} ] ,$ | $\frac{1}{2} [ \begin{matrix}1 & 0 \\ 0 & 0 \\ 0 & 1 \\ 0 & 0\end{matrix} ] ,$ |

| | | | | | | |
|---|---|---|---|---|---|---|
| G2 | $\frac{1}{2} [ \begin{matrix}1 \\ 0 \\ 0 \\ 0\end{matrix} ] ,$ | $\frac{1}{2} [ \begin{matrix}0 \\ 1 \\ 0 \\ 0\end{matrix} ] ,$ | $\frac{1}{2} [ \begin{matrix}0 \\ 0 \\ 1 \\ 0\end{matrix} ] ,$ | $\frac{1}{2} [ \begin{matrix}1 & 0 \\ 0 & 0 \\ 0 & 1 \\ 0 & 0\end{matrix} ] ,$ | $\frac{1}{2} [ \begin{matrix}1 & 0 \\ 0 & 1 \\ 0 & 0 \\ 0 & 0\end{matrix} ] ,$ | $\frac{1}{2} [ \begin{matrix}0 & 0 \\ 1 & 0 \\ 0 & 1 \\ 0 & 0\end{matrix} ] ,$ |

| | $\frac{1}{2} [ \begin{matrix}1 & 0 & 0 \\ 0 & 1 & 0 \\ 0 & 0 & 1 \\ 0 & 0 & 0\end{matrix} ]$ | | | | |
|---|---|---|---|---|---|
| G3 | | $\frac{1}{2} [ \begin{matrix}1 & 0 \\ 0 & 0 \\ 0 & 1 \\ 0 & 0\end{matrix} ] ,$ | $\frac{1}{2} [ \begin{matrix}1 & 0 \\ 0 & 1 \\ 0 & 0 \\ 0 & 0\end{matrix} ] ,$ | $\frac{1}{2} [ \begin{matrix}0 & 0 \\ 1 & 0 \\ 0 & 1 \\ 0 & 0\end{matrix} ] ,$ | $\frac{1}{2} [ \begin{matrix}1 & 0 & 0 \\ 0 & 1 & 0 \\ 0 & 0 & 1 \\ 0 & 0 & 0\end{matrix} ]$ |

| | | | | | |
|---|---|---|---|---|---|
| G4 | $\frac{1}{2} [ \begin{matrix}1 \\ 0 \\ 1 \\ 0\end{matrix} ] ,$ | $\frac{1}{2} [ \begin{matrix}1 \\ 0 \\ - 1 \\ 0\end{matrix} ] ,$ | $\frac{1}{2} [ \begin{matrix}1 \\ 0 \\ j \\ 0\end{matrix} ] ,$ | $\frac{1}{2} [ \begin{matrix}1 \\ 0 \\ - j \\ 0\end{matrix} ] ,$ | $\frac{1}{2} [ \begin{matrix}1 & 0 \\ 0 & 0 \\ 0 & 1 \\ 0 & 0\end{matrix} ]$ |
| G5 | $\frac{1}{2} [ \begin{matrix}1 \\ 0 \\ 1 \\ 0\end{matrix} ] ,$ | $\frac{1}{2} [ \begin{matrix}1 \\ 0 \\ - 1 \\ 0\end{matrix} ] ,$ | $\frac{1}{2} [ \begin{matrix}1 \\ 0 \\ j \\ 0\end{matrix} ] ,$ | $\frac{1}{2} [ \begin{matrix}1 \\ 0 \\ - j \\ 0\end{matrix} ]$ | $\frac{1}{2} [ \begin{matrix}1 & 0 \\ 0 & 0 \\ 0 & 1 \\ 0 & 0\end{matrix} ] ,$ |
| | | $\frac{1}{2} [ \begin{matrix}1 & 0 \\ 0 & 1 \\ 0 & 0 \\ 0 & 0\end{matrix} ] ,$ | $\frac{1}{2} [ \begin{matrix}0 & 0 \\ 1 & 0 \\ 0 & 1 \\ 0 & 0\end{matrix} ] ,$ | $\frac{1}{2} [ \begin{matrix}1 & 0 & 0 \\ 0 & 1 & 0 \\ 0 & 0 & 1 \\ 0 & 0 & 0\end{matrix} ]$ | |
| G6 | $\frac{1}{2} [ \begin{matrix}1 \\ 0 \\ 1 \\ 0\end{matrix} ] ,$ | $\frac{1}{2} [ \begin{matrix}1 \\ 0 \\ - 1 \\ 0\end{matrix} ] ,$ | $\frac{1}{2} [ \begin{matrix}1 \\ 0 \\ j \\ 0\end{matrix} ] ,$ | $\frac{1}{2} [ \begin{matrix}1 \\ 0 \\ - j \\ 0\end{matrix} ] ,$ | $\frac{1}{2} [ \begin{matrix}0 \\ 1 \\ 0 \\ 1\end{matrix} ] ,$ |

| | | |
|---|---|---|
| $\frac{1}{2} [ \begin{matrix}0 \\ 1 \\ 0 \\ - 1\end{matrix} ] ,$ | $\frac{1}{2} [ \begin{matrix}0 \\ 1 \\ 0 \\ j\end{matrix} ] ,$ | $\frac{1}{2} [ \begin{matrix}0 \\ 1 \\ 0 \\ - j\end{matrix} ]$ |

| | |
|---|---|
| $\frac{1}{2} [ \begin{matrix}1 & 0 \\ 0 & 1 \\ 0 & 0 \\ 0 & 0\end{matrix} ] ,$ | $\frac{1}{2} [ \begin{matrix}1 & 0 \\ 0 & 0 \\ 0 & 1 \\ 0 & 0\end{matrix} ] ,$ |

| | | | | |
|---|---|---|---|---|
| $\frac{1}{2} [ \begin{matrix}1 & 0 \\ 0 & 0 \\ 0 & 0 \\ 0 & 1\end{matrix} ] ,$ | $\frac{1}{2} [ \begin{matrix}0 & 0 \\ 1 & 0 \\ 0 & 1 \\ 0 & 0\end{matrix} ] ,$ | $\frac{1}{2} [ \begin{matrix}0 & 0 \\ 1 & 0 \\ 0 & 0 \\ 0 & 1\end{matrix} ] ,$ | $\frac{1}{2} [ \begin{matrix}0 & 0 \\ 0 & 0 \\ 1 & 0 \\ 0 & 1\end{matrix} ] ,$ | $\frac{1}{2} [ \begin{matrix}1 & 0 & 0 \\ 0 & 1 & 0 \\ 0 & 0 & 1 \\ 0 & 0 & 0\end{matrix} ]$ |

When a full coherent UE operates in mode 2, it reports TPMIs the same as a partial-coherent UE.

For 4 port partial-coherent or full-coherent UE, UE can report: 2-port {2-bit bitmap} and one of 4-port non-coherent {G0˜G3} and one of 4-port partial-coherent {G0˜G6}. For 4 port non-coherent UE, UE can report: 2-port {2-bit bitmap} and one of 4-port non-coherent {G0˜G3}. For 2 port UE, UE can report: 2-port {2-bit bitmap}.

A UE that supports this feature must report at least one of the values.

TABLE 15
mapping of 2-bit indication to TPMI or TPMI grouping for non-coherent UE with 2 antenna
ports

| 2-bit bitmap: TPMI | TPMI pre-coder/pre-coding | | TPMIs in Rel. 15 NR 2Tx UL |
|---|---|---|---|
| group | matrices | | codebook |
| 10: K0 | $\frac{1}{\sqrt{2}} [ \begin{matrix}1 \\ 0\end{matrix} ]$ | | Rank 1 TPMI 0 |
| 01: K1 | $\frac{1}{\sqrt{2}} [ \begin{matrix}0 \\ 1\end{matrix} ]$ | | Rank 1 TPMI 1 |
| 11: K2 | $\frac{1}{\sqrt{2}} [ \begin{matrix}1 \\ 0\end{matrix} ] ,$ | $\frac{1}{\sqrt{2}} [ \begin{matrix}0 \\ 1\end{matrix} ]$ | Rank 1 TPMI 0,1 |

In one embodiment, a UE equipped with >4 (e.g., 8) antenna ports reports, via UE capability signaling (e.g., ul-FullPwrMode2-TPMIGroup-r18 or ul-FullPwrMode2-TPMIGroup-8Tx), based on whether it is capable of full power UL transmission for codebook-based UL transmission based on fullPowerMode2. If it is capable, then it further indicates the UE supported TPMI group(s) which delivers full power. The capability signalling comprises the following values:
eightPortsNonCoherent-r18 indicates the TPMI groups S_{NC}
eightPortsPartialCoherentNg2-r18 indicates the TPMI groups S_{PC,Ng2}
eightPortsPartialCoherentNg4-r18 indicates the TPMI groups S_{PC,Ng4}

In one example, when the UE with 8 ports can be configured with a SRS resource with 2 or 4 SRS ports, then the UE can report at least one of the common (Rel.16) TPMI groups, i.e.,
For 8 port partial-coherent or full-coherent UE, UE can report: 2-port {2-bit bitmap} or/and one of 4-port non-coherent {G0˜G3} or/and one of 4-port partial-coherent {G0˜G6}, following common (Rel.16) TPMI groups.
For 8 port non-coherent UE, UE can report: 2-port {2-bit bitmap} or/and one of 4-port non-coherent {G0˜G3}, following common (Rel.16) TPMI groups.

In one example, when the UE with 8 ports can be configured with a SRS resource with 8 SRS ports, then the UE can report at least one of the 8Tx TPMI groups, described herein in the disclosure.

In one example, when the UE with 8 ports can be configured with a SRS resource with 2 or 4 or 8 SRS ports, then the UE can report at least one of the common (Rel.16) TPMI groups or/and one of the 8Tx TPMI groups, described herein in the disclosure.
For 8 port PC UE with N_{g}=2 or full-coherent UE, UE can report: one of 8-port PC TPMI groups in set S_{PC,Ng2}.
For 8 port PC UE with N_{g}=2 or full-coherent UE, UE can report: one of 4-port partial-coherent {G0˜G6} or/and one of 8-port PC TPMI groups in set S_{PC,Ng2}.
For 8 port PC UE with N_{g}=2 or full-coherent UE, UE can report: 2-port {2-bit bitmap} or/and one of 8-port PC TPMI groups in set S_{PC,Ng2}.
For 8 port PC UE with N_{g}=2 or full-coherent UE, UE can report: 2-port {2-bit bitmap} or/and one of 4-port partial-coherent {G0˜G6} or/and one of 8-port PC TPMI groups in set S_{PC,Ng2}.
For 8 port PC UE with N_{g}=2 or full-coherent UE, UE can report: 2-port {2-bit bitmap} or/and one of 4-port non-coherent {G0˜G3} or/and one of 4-port partial-coherent {G0˜G6}, or/and one of 8-port PC TPMI groups S_{PC,Ng2}.
For 8 port PC UE with N_{g}=4 or full-coherent UE, UE can report: one of 8-port PC TPMI groups in set S_{PC,Ng4}.
For 8 port PC UE with N_{g}=4 or full-coherent UE, UE can report: one of 4-port partial-coherent {G0˜G6} or/and one of 8-port PC TPMI groups in set S_{PC,Ng4}.
For 8 port PC UE with N_{g}=4 or full-coherent UE, UE can report: 2-port {2-bit bitmap} or/and one of 8-port PC TPMI groups in set S_{PC,Ng4}
For 8 port PC UE with N_{g}=4 or full-coherent UE, UE can report: 2-port {2-bit bitmap} or/and one of 4-port partial-coherent {G0˜G6} or/and one of 8-port PC TPMI groups in set S_{PC,Ng4}.
For 8 port PC UE with N_{g}=4 or full-coherent UE, UE can report: 2-port {2-bit bitmap} or/and one of 4-port non-coherent {G0˜G3} or/and one of 4-port partial-coherent {G0˜G6}, or/and one of 8-port PC TPMI groups S_{PC,Ng4}.
For 8 port NC UE, UE can report: one of 8-port NC TPMI groups in set S_{NC}.
For 8 port NC UE, UE can report: one of 4-port non-coherent {G0˜G3} or/and one of 8-port NC TPMI groups in set S_{NC}.
For 8 port NC UE, UE can report: 2-port {2-bit bitmap} or/and one of 8-port NC TPMI groups in set S_{NC}.
For 8 port NC UE, UE can report: 2-port {2-bit bitmap} or/and one of 4-port non-coherent {G0˜G3} or/and one of 8-port NC TPMI groups in set S_{NC}.

In one embodiment, a UE equipped with 8 antenna ports reports can report at least one of the 8Tx TPMI groups.

In one example, the UE can only be configured with TPMIs (precoders) according to its coherence capability.
A fully-coherent UE (N_{g}=1) can only be configured with precoders considered for N_{g}=1.
A partially-coherent UE with N_{g}=2 can only be configured with precoders considered for N_{g}=2.
A partially-coherent UE with N_{g}=4 can only be configured with precoders considered for N_{g}=4.
A non-coherent UE with N_{g}=8 can only be configured with precoders considered for N_{g}=8.

In this case, the set S_{PC,Ng2} includes TPMI groups corresponding to N_{g}=2 only, the set S_{PC,Ng4} includes TPMI groups corresponding to N_{g}=4 only, and the set S_{NC} includes TPMI groups corresponding to N_{g}=8 (NC) only.

In one example, the UE can be configured with TPMIs (precoders) according to its coherence capability or another (lower) coherence capability.
A fully-coherent UE (N_{g}=1) can be configured with precoders considered for N_{g}=1 or/and at least one of N_{g}=2,4,8.
   In one example, at least one of corresponds to N_{g}=2.
   In one example, at least one of corresponds to N_{g}=4.
   In one example, at least one of corresponds to N_{g}=8.
   In one example, at least one of corresponds to N_{g}=2,8.
   In one example, at least one of corresponds to N_{g}=4,8.
A partially-coherent UE with N_{g}=2 can be configured with precoders considered for N_{g}=2 or/and at least one of N_{g}=4,8.
   In one example, at least one of corresponds to N_{g}=4.
   In one example, at least one of corresponds to N_{g}=8.
A partially-coherent UE with N_{g}=4 can be configured with precoders considered for N_{g}=4 or/and N_{g}=8.
A non-coherent UE with N_{g}=8 can be configured with precoders considered for N_{g}=8.

In this case, at least one of the following examples are used/configured/supported regarding the 8Tx TPMI groups for a FC UE with 8 ports.
In one example, when the FC UE operates in mode 2, it reports TPMIs or TPMI groups the same as a PC UE with N_{g}=2.
In one example, when the FC UE operates in mode 2, it reports TPMIs or TPMI groups the same as a PC UE with N_{g}=4.
In one example, when the FC UE operates in mode 2, it reports TPMIs or TPMI groups the same as a NC UE with N_{g}=8.
In one example, when the FC UE operates in mode 2, it reports TPMIs or TPMI groups the same as a PC UE with N_{g}=4 or a NC UE with N_{g}=8.
In one example, when the FC UE operates in mode 2, it reports TPMIs or TPMI groups the same as a PC UE with N_{g}=2 or a NC UE with N_{g}=8.
In one example, when the FC UE operates in mode 2, it reports TPMIs or TPMI groups the same as a PC UE with N_{g}=2 or N_{g}=4 or a NC UE with N_{g}=8.

In this case, at least one of the following examples are used/configured/supported regarding the 8Tx TPMI groups for a PC UE with 8 ports and N_{g}=2.
In one example, the set S_{PC,Ng2} includes TPMI groups corresponding to N_{g}=2 only, and the UE can report at least one of TPMI groups from S_{PC,Ng2}.
In one example, the set S_{PC,Ng2} includes TPMI groups corresponding to N_{g}=4 only, and the UE can report at least one of TPMI groups from S_{PC,Ng4}.
In one example, the set S_{PC,Ng2} includes TPMI groups corresponding to N_{g}=8 only, and the UE can report at least one of TPMI groups from S_{PC,Ng8}.
In one example, the set S_{PC,Ng2} includes TPMI groups corresponding to N_{g}=2 or/and N_{g}=4, and the UE can report at least one of TPMI groups for N_{g}=2 or/and at least one TPMI groups for N_{g}=4.
In one example, the set S_{PC,Ng2} includes TPMI groups corresponding to N_{g}=2 or/and N_{g}=8, and the UE can report at least one of TPMI groups for N_{g}=2 or/and at least one TPMI groups for N_{g}=8.
In one example, the set S_{PC,Ng2} includes TPMI groups corresponding to N_{g}=4 or/and N_{g}=8, and the UE can report at least one of TPMI groups for N_{g}=4 or/and at least one TPMI groups for N_{g}=8.
In one example, the set S_{PC,Ng2} includes TPMI groups corresponding to N_{g}=2 or/and N_{g}=4 or/and N_{g}=8, and the UE can report at least one of TPMI groups for N_{g}=2 or/and at least one TPMI groups for N_{g}=4 or/and at least one TPMI groups for N_{g}=8.

In this case, at least one of the following examples are used/configured/supported regarding the 8Tx TPMI groups for a PC UE with 8 ports and N_{g}=4.
In one example, the set S_{PC,Ng4} includes TPMI groups corresponding to N_{g}=4 only, and the UE can report at least one of TPMI groups from S_{PC,Ng4}.
In one example, the set S_{PC,Ng4} includes TPMI groups corresponding to N_{g}=8 only, and the UE can report at least one of TPMI groups from S_{PC,Ng8}.
In one example, the set S_{PC,Ng4} includes TPMI groups corresponding to N_{g}=4 or/and N_{g}=8, and the UE can report at least one of TPMI groups for N_{g}=4 or/and at least one TPMI groups for N_{g}=8.

In this case, at least one of the following examples are used/configured/supported regarding the 8Tx TPMI groups for a NC UE with 8 ports and N_{g}=8. In one example, the set S_{NC} includes TPMI groups corresponding to N_{g}=8 only, and the UE can report at least one of TPMI groups from S_{NC}.

In one embodiment, the set S_{NC} includes TPMI groups corresponding to N_{g}=8.

In one example, the set S_{NC} includes TPMI groups for 8Tx based on 4-port non-coherent groups {G0˜G3}. Let where gᵢ=G₀˜G₃ and i=1, 2. The 8 antenna ports are divided into two parts, part X₁ including 4 antenna ports and part X₂ including remaining 4 antenna ports. In one example, X₁={0,1,2,3} and X₂={4,5,6,7}. In one example, X₁={0,1,4,5} and X₂={2,3,6,7}. In one example, X₁={0,2,4,6} and X₂={1,3,5,7}.
In one example, the TPMI groups comprise pairs (a₁, a₂)∈{(g₁, 0), (0, g₂), (g₁, g₂)} or {(g₁, NULL), (NULL, g₂), (g₁, g₂)}, and aᵢ corresponds to part Xᵢ.
In one example, the TPMI groups comprise one group a₁={g₁} or a pair (a₁, a₂)∈{(g₁, g₂)}. In one example, when one group, then g₁ corresponds to X₁ or one of X₁ and X₂ (which one is either configured or reported by the UE via UE capability reporting).

In one example, the 8Tx TPMI groups can be given by:
For one group: one or both of

$$[ \begin{matrix}{g}_{1} \\ 0\end{matrix} ] , [ \begin{matrix}0 \\ {g}_{2}\end{matrix} ]$$

For a pair of groups:

$$[ \begin{matrix}{g}_{1} \\ {g}_{2}\end{matrix} ] or [ \begin{matrix}{g}_{1} & 0 \\ 0 & {g}_{2}\end{matrix} ] .$$

A 3-bit bitmap b₀ . . . b₂ can be reported by the UE to indicate one group and a pair, {(g₁, 0), (0, g₂), (g₁, g₂)}, respectively. Or, if only at most one group can be reported between (g₁, 0), (0, g₂), then for each

$$⌈ {log}_{2} ( \begin{matrix}2 \\ 1\end{matrix} ) ⌉ = 1$$

bit indication can be used to report a group from (g₁, 0), (0, g₂).

In one example, a UE can report TPMI groups corresponding to only one of {(g₁, 0), (0, g₂), (g₁, g₂)}. In one example, a UE can report TPMI groups corresponding to {Y, (g₁, g₂)}, where Y is one of (g₁, 0), (0, g₂). In one example, a UE can report TPMI groups corresponding to each of {(g₁, 0), (0,g₂), (g₁,g₂)}. For a given Tᵢ, the gᵢ's are according to common (Rel.16) 2-port TPMI grouping.

In one example, the set S_{NC} includes TPMI groups for 8Tx based on 2-port bitmap or 2-port NC groups {K0˜K2}. Let where gᵢ=b₀b₁ or K₀˜K₂ and i=1, 2, 3, 4. The 8 antenna ports are divided into four parts, each part Xᵢ including 2 antenna ports. In one example, X₁={0,1}, X₂={2,3}, X₃={4,5}, X₄={6,7}. In one example, X₁={0,4}, X₂={1,5}, X₃={2,6}, X₄={3,7}. In one example, X₁={0,2}, X₂={1,3}, X₃={4,6}, X₄={5,7}.
In one example, the TPMI groups comprise quadruples (a₁, a₂, a₃, a₄)∈{T₁, T₂, T₃, T₄} and aᵢ corresponds to part Xᵢ. Here, T₁={(g₁, 0, 0, 0), (0, g₂, 0, 0), (0, 0, g₃, 0), (0, 0, 0, g₄)}, T₂={(g₁, g₂, 0, 0), (g₁, 0, g₃, 0), (g₁, 0, 0, g₄), (0, g₂, g₃, 0), (0, g₂, 0, g₃), (0, 0, g₂, g₃)}. T₃={(g₁, g₂, g₃, 0), (g₁, 0, g₃, g₄), (g₁, g₂, 0, g₄), (0, g₂, g₃, g₄)}. T₄={(g₁, g₂, g₃, g₄)}.
In one example, the TPMI groups comprise one group a₁={g₁} or a pair (a₁, a₂)∈{(g₁, g₂)} or a triple (a₁, a₂, a₃)∈{(g₁, g₂, g₃)} or a quadruple (a₁, a₂, a₃, a₄)∈{(g₁, g₂)}. In one example, when one group, then g₁ corresponds to X₁ or one of X₁, . . . , X₂ (which one is either configured or reported by the UE via UE capability reporting). In one example, when a pair of groups, then (g₁, g₂) corresponds to (X₁, X₂) or any two from X₁, . . . , X₄ (which two is either configured or reported by the UE via UE capability reporting). In one example, when a triple of groups, then (g₁, g₂, g₃) corresponds to (X₁, X₂, X₃) or any three from X₁, . . . , X₄ (which three is either configured or reported by the UE via UE capability reporting).

In one example, the 8Tx TPMI groups can be given by:
For T₁: 1 or 2 or 3 or each of

$$[ \begin{matrix}{g}_{1} \\ 0 \\ 0 \\ 0\end{matrix} ] , [ \begin{matrix}0 \\ {g}_{2} \\ 0 \\ 0\end{matrix} ] , [ \begin{matrix}0 \\ 0 \\ {g}_{3} \\ 0\end{matrix} ] , [ \begin{matrix}0 \\ 0 \\ 0 \\ {g}_{4}\end{matrix} ]$$

For T₂: 1 or 2 or 3 or 4 or 5 or each of

$$[ \begin{matrix}{g}_{1} \\ {g}_{2} \\ 0 \\ 0\end{matrix} ] , [ \begin{matrix}{g}_{1} \\ 0 \\ {g}_{3} \\ 0\end{matrix} ] , [ \begin{matrix}{g}_{1} \\ 0 \\ 0 \\ {g}_{4}\end{matrix} ] , [ \begin{matrix}0 \\ {g}_{2} \\ 0 \\ {g}_{4}\end{matrix} ] , [ \begin{matrix}0 \\ {g}_{2} \\ {g}_{3} \\ 0\end{matrix} ] , [ \begin{matrix}0 \\ 0 \\ {g}_{3} \\ {g}_{4}\end{matrix} ] , or \\ [ \begin{matrix}{g}_{1} & 0 \\ 0 & {g}_{2} \\ 0 & 0 \\ 0 & 0\end{matrix} ] , [ \begin{matrix}{g}_{1} & 0 \\ 0 & 0 \\ 0 & {g}_{3} \\ 0 & 0\end{matrix} ] , [ \begin{matrix}{g}_{1} & 0 \\ 0 & 0 \\ 0 & 0 \\ 0 & {g}_{4}\end{matrix} ] , [ \begin{matrix}0 & 0 \\ {g}_{2} & 0 \\ 0 & {g}_{3} \\ 0 & 0\end{matrix} ] , [ \begin{matrix}0 & 0 \\ {g}_{2} & 0 \\ 0 & 0 \\ 0 & {g}_{4}\end{matrix} ] , [ \begin{matrix}0 & 0 \\ 0 & 0 \\ {g}_{3} & 0 \\ 0 & {g}_{4}\end{matrix} ]$$

For T₃: 1 or 2 or 3 or each of

$$[ \begin{matrix}{g}_{1} \\ {g}_{2} \\ {g}_{3} \\ 0\end{matrix} ] , [ \begin{matrix}{g}_{1} \\ 0 \\ {g}_{3} \\ {g}_{4}\end{matrix} ] , [ \begin{matrix}{g}_{1} \\ {g}_{2} \\ 0 \\ {g}_{4}\end{matrix} ] , [ \begin{matrix}0 \\ {g}_{2} \\ {g}_{3} \\ {g}_{4}\end{matrix} ] or \\ [ \begin{matrix}{g}_{1} & 0 & 0 \\ 0 & {g}_{2} & 0 \\ 0 & 0 & {g}_{3} \\ 0 & 0 & 0\end{matrix} ] , [ \begin{matrix}{g}_{1} & 0 & 0 \\ 0 & {g}_{2} & 0 \\ 0 & 0 & 0 \\ 0 & 0 & {g}_{4}\end{matrix} ] , [ \begin{matrix}{g}_{1} & 0 & 0 \\ 0 & 0 & 0 \\ 0 & {g}_{3} & 0 \\ 0 & 0 & {g}_{4}\end{matrix} ] , [ \begin{matrix}0 & 0 & 0 \\ {g}_{2} & 0 & 0 \\ 0 & {g}_{3} & 0 \\ 0 & 0 & {g}_{4}\end{matrix} ]$$

For T₄:

$$[ \begin{matrix}{g}_{1} \\ {g}_{2} \\ {g}_{3} \\ {g}_{4}\end{matrix} ] or [ \begin{matrix}{g}_{1} & 0 & 0 & 0 \\ 0 & {g}_{2} & 0 & 0 \\ 0 & 0 & {g}_{3} & 0 \\ 0 & 0 & 0 & {g}_{4}\end{matrix} ] .$$

A 15-bit bitmap b₀ . . . b₁₄ can be reported by the UE to indicate one group, a pair, a triple, and a quadruple, e.g., b₀ . . . b₃ corresponds to groups in T₁, b₄ . . . b₉ corresponds to groups in T₂, b₁₀ . . . b₁₃ corresponds to groups in T₃, and b₁₄ corresponds to groups in T₄. Or, if only at most one group can be reported for each Tᵢ, then for each

$$i = 1 , 2 , 3 , 4 , ⌈ {log}_{2} ( \begin{matrix}4 \\ i\end{matrix} ) ⌉$$

bits indication can be used to report a group from Tᵢ.

In one example, a UE can report TPMI groups corresponding to only one of T₁, . . . T₄. In one example, a UE can report TPMI groups corresponding to only two of T₁, . . . T₄ (e.g., T₁, T₂ or T₁, T₄). In one example, a UE can report TPMI groups corresponding to only three of T₁, . . . T₄ (e.g., T₁, T₂, T₄ or T₁, T₂, T₃). In one example, a UE can report TPMI groups corresponding to each of T₁, . . . T₄. For a given Tᵢ, the gᵢ's are according to common (Rel.16) 2-port TPMI grouping.

In one example, the set S_{NG} includes TPMI groups for 8Tx based on 8×1 selection vectors with the scaling factor of

$$\frac{1}{2 \sqrt{2}} .$$

In one example, the set S_{NC} includes at least one of the TPMI groups shown in Table 16.

TABLE 16

| ID | TPMI groups | | | |
|---|---|---|---|---|
| G0 (1 full- rated PA) | $\frac{1}{2 \sqrt{2}} [ \begin{matrix}1 \\ 0 \\ 0 \\ 0 \\ 0 \\ 0 \\ 0 \\ 0\end{matrix} ]$ | | | |
| G1 (2 full- rated PA) | | $\frac{1}{2 \sqrt{2}} [ \begin{matrix}1 \\ 0 \\ 0 \\ 0 \\ 0 \\ 0 \\ 0 \\ 0\end{matrix} ] ,$ | $\frac{1}{2 \sqrt{2}} [ \begin{matrix}0 \\ 0 \\ 0 \\ 0 \\ 1 \\ 0 \\ 0 \\ 0\end{matrix} ] ,$ | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ]$ |

| | | | | | | | |
|---|---|---|---|---|---|---|---|
| G2 (3 full- rated PA) | $\frac{1}{2 \sqrt{2}} [ \begin{matrix}1 \\ 0 \\ 0 \\ 0 \\ 0 \\ 0 \\ 0 \\ 0\end{matrix} ] ,$ | $\frac{1}{2 \sqrt{2}} [ \begin{matrix}0 \\ 1 \\ 0 \\ 0 \\ 0 \\ 0 \\ 0 \\ 0\end{matrix} ] ,$ | $\frac{1}{2 \sqrt{2}} [ \begin{matrix}0 \\ 0 \\ 0 \\ 0 \\ 1 \\ 0 \\ 0 \\ 0\end{matrix} ] ,$ | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ]$ |

| | | | | |
|---|---|---|---|---|
| G3 (3 full- 3 dB PA) | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ]$ |

| | | | | |
|---|---|---|---|---|
| G4 (4 full- rated PA) | $\frac{1}{2 \sqrt{2}} [ \begin{matrix}1 \\ 0 \\ 0 \\ 0 \\ 0 \\ 0 \\ 0 \\ 0\end{matrix} ] ,$ | $\frac{1}{2 \sqrt{2}} [ \begin{matrix}0 \\ 1 \\ 0 \\ 0 \\ 0 \\ 0 \\ 0 \\ 0\end{matrix} ] ,$ | $\frac{1}{2 \sqrt{2}} [ \begin{matrix}0 \\ 0 \\ 0 \\ 0 \\ 1 \\ 0 \\ 0 \\ 0\end{matrix} ] ,$ | $\frac{1}{2 \sqrt{2}} [ \begin{matrix}0 \\ 0 \\ 0 \\ 0 \\ 0 \\ 1 \\ 0 \\ 0\end{matrix} ]$ |

| | | | | | |
|---|---|---|---|---|---|
| $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] ,$ | $\frac{1}{2 \sqrt{2}} [ \begin{matrix}1 & 0 \\ 0 & 0 \\ 0 & 0 \\ 0 & 0 \\ 0 & 0 \\ 0 & 1 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 0 \\ 0 & 1 \\ 0 & 0 \\ 0 & 0\end{matrix} ] ,$ | $\frac{1}{2 \sqrt{2}} [ \begin{matrix}0 & 0 \\ 0 & 0 \\ 0 & 0 \\ 0 & 0 \\ 1 & 0 \\ 0 & 1 \\ 0 & 0 \\ 0 & 0\end{matrix} ] ,$ |

| | | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0 \\ 0 & 0 & 0\end{matrix} ] ,$ | $\frac{1}{2 \sqrt{2}} [ \begin{matrix}1 & 0 & 0 \\ 0 & 0 & 0 \\ 0 & 0 & 0 \\ 0 & 0 & 0 \\ 0 & 1 & 0 \\ 0 & 0 & 1 \\ 0 & 0 & 0 \\ 0 & 0 & 0\end{matrix} ] ,$ | |
|---|---|---|---|---|---|---|
| | $\frac{1}{2 \sqrt{2}} [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$ | | | | | |
| G5 (4 full- 3 dB PA) | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] ,$ | $\frac{1}{2 \sqrt{2}} [ \begin{matrix}1 & 0 \\ 0 & 0 \\ 0 & 0 \\ 0 & 0 \\ 0 & 0 \\ 0 & 1 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 1 \\ 0 & 0 \\ 0 & 0 \\ 0 & 0\end{matrix} ] ,$ | $\frac{1}{2 \sqrt{2}} [ \begin{matrix}0 & 0 \\ 1 & 0 \\ 0 & 0 \\ 0 & 0 \\ 0 & 0 \\ 0 & 1 \\ 0 & 0 \\ 0 & 0\end{matrix} ] ,$ | $\frac{1}{2 \sqrt{2}} [ \begin{matrix}0 & 0 \\ 0 & 0 \\ 0 & 0 \\ 0 & 0 \\ 1 & 0 \\ 0 & 1 \\ 0 & 0 \\ 0 & 0\end{matrix} ] ,$ |
| | | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0 \\ 0 & 0 & 0\end{matrix} ] ,$ | $\frac{1}{2 \sqrt{2}} [ \begin{matrix}1 & 0 & 0 \\ 0 & 0 & 0 \\ 0 & 0 & 0 \\ 0 & 0 & 0 \\ 0 & 1 & 0 \\ 0 & 0 & 1 \\ 0 & 0 & 0 \\ 0 & 0 & 0\end{matrix} ]$ | |

| | $\frac{1}{2 \sqrt{2}} [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$ | | | | | |
|---|---|---|---|---|---|---|
| G6 (4 full- 4.5 dB PA) | | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ] ,$ | $\frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0 \\ 0 & 0 & 0\end{matrix} ] ,$ | $\frac{1}{2 \sqrt{2}} [ \begin{matrix}1 & 0 & 0 \\ 0 & 0 & 0 \\ 0 & 0 & 0 \\ 0 & 0 & 0 \\ 0 & 1 & 0 \\ 0 & 0 & 1 \\ 0 & 0 & 0 \\ 0 & 0 & 0\end{matrix} ] ,$ | $\frac{1}{2 \sqrt{2}} [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$ |

| | |
|---|---|
| G7 (5 | Similar to G4 |
| full PA) | |
| G8 (5 | Similar to G5 |
| full- | |
| 3 dB | |
| PA) | |
| G9 (5 | Similar to G6 |
| full- | |
| 4.5 dB | |
| PA) | |
| G10 (6 | Similar to G4 |
| full PA) | |
| G11 (6 | Similar to G5 |
| full- | |
| 3 dB | |
| PA) | |
| G12 (6 | Similar to G6 |
| full- | |
| 4.5 dB | |
| PA) | |
| G13 (6 | Similar to G6 |
| full- | |
| 6 dB | |
| PA) | |
| G14 (7 | Similar to G4 |
| full PA) | |
| G15 (7 | Similar to G5 |
| full- | |
| 3 dB | |
| PA) | |
| G16 (7 | Similar to G6 |
| full- | |
| 4.5 dB | |
| PA) | |
| G17 (7 | Similar to G6 |
| full- | |
| 6 dB | |
| PA) | |

In one example, the set S_{N}c includes TPMI groups for 8Tx based on 4-port non-coherent groups {G0˜G3} and 2-port {2-bit bitmap} or 2-port NC groups {K0˜K2}.
In one example, a TPMI groups comprises (a) a 2-bit bitmap indicates one or more of the two groups (each 4 ports), and (b) for each indicated group, one of the 4-port non-coherent groups {G0˜G3} is included in the TPMI group. The details about the groups are as described herein.
In one example, a TPMI groups comprises (a) a 4-bit bitmap indicates one or more of the 4 groups (each 2 ports), and (b) for each indicated group, 2-port bitmap or one of the 2-port groups K0˜G2 is included in the TPMI group. The details about the groups are as described herein.

In one example, the set S_{NC} includes TPMI groups for 8Tx based on (A) W groups, (B) for each of the W groups, an N-bit bitmap indicating one or more of the N antenna ports, N=8/W such that only the TPMIs associated with indicated port(s) can achieve full power, and (C) for each of the W groups, a value of (r₁, r₂), where r₁ is a value of the min rank (number of layers) and r₂ is a value of max rank (number of layers), that can be supported with the indicated ports associated with the group.

In one example, W=1, an 8-bit bitmap indicates one or more of the 8 antenna ports and rᵢ∈{1, . . . , 7}.

In one example, W=2, two 4-bit bitmaps (or 2 parts of 8-bit bitmap), each indicates none of or one of or more of the 4 antenna ports and rᵢ∈{0, . . . , 3} or rᵢ∈{0, . . . 4} such that 1≤Σᵢ₌₁^{W}rᵢ≤7.

In one example, W=4, four 2-bit bitmaps (or 4 parts of 8-bit bitmap), each indicates none of or one of or more of the 2 antenna ports and rᵢ∈{0, . . . , 1} or rᵢ∈{0, . . . , 2} such that 1≤Σᵢ₌₁^{W}rᵢ≤7.

In one example, the set S_{NC} includes NC (N_{g}=8) TPMI groups for 8Tx based on a bitmap, where the length (size) of the bitmap is B.
In one example, B=total number of non-full-power TPMIs across each rank (i.e., 1-7).
In one example, B=total number of non-full-power TPMIs across each rank r t, where t is fixed (e.g., 2 or 4) or reported by the UE via UE capability reporting.
In one example, B=total number of non-full-power TPMIs across each rank r≥t, where t is fixed (e.g., 2 or 4) or reported by the UE via UE capability reporting.
In one example, B=total number of non-full-power TPMIs across each rank s≤r≤t, where s, t is fixed (e.g. (1,2) or (2,4) or (1,4)) or reported by the UE via UE capability reporting.
In one example, B=total number of non-full-power TPMI groups across each rank (i.e., 1-7).
In one example, B=total number of non-full-power TPMI groups across each rank r≤t, where t is fixed (e.g., 2 or 4) or reported by the UE via UE capability reporting.
In one example, B=total number of non-full-power TPMI groups across each rank r≥t, where t is fixed (e.g., 2 or 4) or reported by the UE via UE capability reporting.
In one example, B=total number of non-full-power TPMI groups across each rank s≤r≤t, where s, t is fixed (e.g. (1,2) or (2,4) or (1,4)) or reported by the UE via UE capability reporting.

In one embodiment, the set S_{PC,Ng4} includes TPMI groups for N_{g}=4 that are based on Rel. 15 2Tx UL FC precoders (rank-1 2Tx TPMI=2, 3, 4, 5 and rank-2 2Tx TPMI=1, 2), either 1 or 2 or 3 or 4 2Tx FC TPMIs are used/indicated/configured, depending on lᵢ values, where i=1, 2, 3, 4 and lᵢ∈{0,1,2} is a number of layers associated with group i, and applied to the four antenna groups, based on an ordering (lₓ_{₁}, lₓ_{₂}, lₓ_{₃}, lₓ_{₄}), where (x₁, x₂, x₃, x₄) is one of the values in Table 17.

If numbering A is used to construct 8Tx precoders based on 2Tx FC precoders, then the 2Tx precoders are applied to consecutive 2 out of 8 ports, i.e., {(1,2), (3,4), (5,6), (7,8)} or {(0,1), (2,3), (4,5), (6,7)}. Or, if numbering B is used to construct 8Tx precoders based on 2Tx precoders, then the 2Tx precoders are applied to one or multiple of the following port pairs, {(1,5), (2,6), (3,7), (4,8)} or {(0,4), (1,5), (2,6), (3,7)}.

TABLE 17

| Signaling | (x₁, x₂, x₃, x₄) |
|---|---|
| 0-5 or v0-v5 | (1, 2, 3, 4), (1, 2, 4, 3), (1, 3, 2, 4), (1, 3, 4, 2), (1, 4, 2, 3), (1, 4, 3, 2) |
| 6-11 or v6-v11 | (2, 1, 3, 4), (2, 1, 4, 3), (2, 3, 1, 4), (2, 3, 4, 1), (2, 4, 1, 3), (2, 4, 3, 1), |
| 12-17 or v12-v17 | (3, 2, 1, 4), (3, 2, 4, 1), (3, 1, 2, 4), (3, 1, 4, 2), (3, 4, 2, 1), (3, 4, 1, 2), |
| 18-23 or v18-v23 | (4, 2, 3, 1), (4, 2, 1, 3), (4, 3, 2, 1), (4, 3, 1, 2), (4, 1, 2, 3), (4, 1, 3, 2), |

In one example, the ordering is fixed, e.g. (1,2,3,4). In one example, the ordering is configured/indicated to the UE, e.g., via higher layer or/and MAC control element (CE) based signaling. In one example, a 5-bit signaling (b) or a parameter (p) with 24 states is used to indicate one of the supported values. In one example, TPMIs according to each ordering are supported, and each of or a subset of them can be used to configure an 8Tx codebook to the UE.

In one example, the 8Tx PC precoders for N_{g}=4 are described (constructed) based on an ordered set of layer tuple values (lₓ_{₁}, lₓ_{₂}, lₓ_{₃}, lₓ_{₄}). At least one of the Table 18 through Table 23 can be used.

TABLE 18

| | T₁: Each layer in one | T₂: Layers split across | T₃: Layers split across | T₄: Layers split across |
|---|---|---|---|---|
| Rank | Antenna Group | 2 Antenna Groups | 3 Antenna Groups | 4 Antenna Groups |
| 1 | (0, 0, 0, 1) or 1 | | | |
| 2 | (0, 0, 0, 2) or 2 | (0, 0, 1, 1) | | |
| 3 | | (0, 0, 1, 2) | (0, 1, 1, 1) | |
| 4 | | (0, 0, 2, 2) | (0, 1, 1, 2) | (1, 1, 1, 1) |
| 5 | | | (0, 1, 2, 2) | (1, 1, 1, 2) |
| 6 | | | (0, 2, 2, 2) | (1, 1, 2, 2) |
| 7 | | | | (1, 2, 2, 2) |
| 8 | | | | (2, 2, 2, 2) |

TABLE 19

| | T₁: Each layer in one | T₂: Layers split across | T₃: Layers split across | T₄: Layers split across |
|---|---|---|---|---|
| Rank | Antenna Group | 2 Antenna Groups | 3 Antenna Groups | 4 Antenna Groups |
| 1 | (1, 0, 0, 0) or 1 | | | |
| 2 | (2, 0, 0, 0) or 2 | (1, 1, 0, 0) | | |
| 3 | | (2, 1, 0, 0) | (1, 1, 1, 0) | |
| 4 | | (2, 2, 0, 0) | (2, 1, 1, 0) | (1, 1, 1, 1) |
| 5 | | | (2, 2, 1, 0) | (1, 1, 1, 1) |
| 6 | | | (2, 2, 2, 0) | (2, 2, 1, 1) |
| 7 | | | | (2, 2, 2, 1) |
| 8 | | | | (2, 2, 2, 2) |

TABLE 20

| | T₁: Each layer | T₂: Layers split | T₄: Layers split |
|---|---|---|---|
| | in one | across 2 | across 4 |
| Rank | Antenna Group | Antenna Groups | Antenna Groups |
| 1 | (0, 0, 0, 1) or 1 | | |
| 2 | (0, 0, 0, 2) or 2 | (0, 0, 1, 1) | |
| 3 | | (0, 0, 1, 2) | |
| 4 | | (0, 0, 2, 2) | (1, 1, 1, 1) |
| 5 | | | (1, 1, 1, 2) |
| 6 | | | (1, 1, 2, 2) |
| 7 | | | (1, 2, 2, 2) |
| 8 | | | (2, 2, 2, 2) |

TABLE 21

| | T₁: Each layer | T₂: Layers split | T₄: Layers split |
|---|---|---|---|
| | in one | across 2 | across 4 |
| Rank | Antenna Group | Antenna Groups | Antenna Groups |
| 1 | (1, 0, 0, 0) or 1 | | |
| 2 | (2, 0, 0, 0) or 2 | (1, 1, 0, 0) | |
| 3 | | (2, 1, 0, 0) | |
| 4 | | (2, 2, 0, 0) | (1, 1, 1, 1) |
| 5 | | | (1, 1, 1, 1) |
| 6 | | | (2, 2, 1, 1) |
| 7 | | | (2, 2, 2, 1) |
| 8 | | | (2, 2, 2, 2) |

TABLE 22

| | T₁: Each layer in one | T₂: Layers split across | T₃: Layers split across | T₄: Layers split across |
|---|---|---|---|---|
| Rank | Antenna Group | 2 Antenna Groups | 3 Antenna Groups | 4 Antenna Groups |
| 1 | (0, 0, 0, 1) or 1 | | | |
| 2 | (0, 0, 0, 2) or 2 | (0, 0, 1, 1) | | |
| 3 | | (0, 0, 1, 2) | (0, 1, 1, 1) | |
| 4 | | (0, 0, 2, 2) | (0, 1, 1, 2) | (1, 1, 1, 1) |
| 5 | | | (0, 1, 2, 2) | (1, 1, 1, 2) |
| 6 | | | | (1, 1, 2, 2) |
| 7 | | | | (1, 2, 2, 2) |
| 8 | | | | (2, 2, 2, 2) |

TABLE 23

| | T₁: Each layer in one | T₂: Layers split across | T₃: Layers split across | T₄: Layers split across |
|---|---|---|---|---|
| Rank | Antenna Group | 2 Antenna Groups | 3 Antenna Groups | 4 Antenna Groups |
| 1 | (1, 0, 0, 0) or 1 | | | |
| 2 | (2, 0, 0, 0) or 2 | (1, 1, 0, 0) | | |
| 3 | | (2, 1, 0, 0) | (1, 1, 1, 0) | |
| 4 | | (2, 2, 0, 0) | (2, 1, 1, 0) | (1, 1, 1, 1) |
| 5 | | | (2, 2, 1, 0) | (1, 1, 1, 1) |
| 6 | | | | (2, 2, 1, 1) |
| 7 | | | | (2, 2, 2, 1) |
| 8 | | | | (2, 2, 2, 2) |

Note that the layer splitting according to T₁, T₂, T₃ are non-full-power (since at least one group has no layers) and T₄ is full-power (since each group has at least one layer). The set S_{PC,Ng4} therefore includes TPMI groups whose layer splitting is according to T₁, T₂, T₃.

In one example, the set S_{PC,Ng4} includes TPMI groups corresponding to N_{g}=4, where each TPMI group is according to at least one of the following types (Table 24).
In one example, the TPMI group type e₁ corresponds to 8Tx precoder type T₁, i.e., the TPMI group comprises B₁ which is a 2-bit bitmap or 2-port groups K0˜K2 (following common as described herein), or 2-port TPMI groups as shown in Table 25. In one example, the corresponding 1 antenna group (from the 4 antenna groups) is either fixed (e.g., group with ports (0,4)) or reported by the UE (with UE capability reporting, the UE can report only one or multiple values) or is configured (e.g., via higher layer RRC or MACE CE or DCI).
In one example, the TPMI group type e₂ corresponds to 8Tx precoder type T₂, i.e., the TPMI group comprises (B₁, B₂), Bᵢ is a 2-bit bitmap or one of the 2-port groups K0˜K2 (following common as described herein), or 2-port TPMI groups as shown in Table 25. In one example, the corresponding 2 antenna groups (from the 4 antenna groups) are either fixed (e.g., groups with ports (0,4), (1,5)) or reported by the UE (with UE capability reporting, the UE can report only one or multiple values) or is configured (e.g., via higher layer RRC or MACE CE or DCI).
In one example, the TPMI group type e₃ corresponds to 8Tx precoder type T₃, i.e., the TPMI group comprises (B₁, B₂, B₃), Bᵢ is a 2-bit bitmap or one of the 2-port groups K0˜K2 (following common as described herein), or 2-port TPMI groups as shown in Table 25. In one example, the corresponding 3 antenna groups (from the 4 antenna groups) are either fixed (e.g., groups with ports (0,4), (1,5), (2,6)) or reported by the UE (with UE capability reporting, the UE can report only one or multiple values) or is configured (e.g., via higher layer RRC or MACE CE or DCI).
In one example, the TPMI group type e₄ corresponds to 8Tx precoder type pair (Tᵢ, T₂)=(e₁(i₁), e₂(i_{2,1}, i_{2,2})), where i₁ is the index of the 1 antenna group (from the 4 antenna groups), and (i_{2,1}, i_{2,2}) are indices of the 2 antenna groups (from the 4 antenna groups).
   In one example, i₁=i_{2,1} is fixed, or i₁∈{i_{2,1}, i_{2,2}} is reported by the UE (with UE capability reporting, the UE can report only one or multiple values) or is configured (e.g., via higher layer RRC or MACE CE or DCI).
   In one example, e₁(i₁) with both i₁=i_{2,1} and i₁=i_{2,2} are included in the TPMI group reported by the UE (with UE capability reporting, the UE can report only one or multiple values) or is configured (e.g., via higher layer RRC or MACE CE or DCI).
   In one example, e₁(i₁) with one or both i₁=i_{2,1} or/and i₁=i_{2,2} are included in the TPMI group reported by the UE (with UE capability reporting, the UE can report only one or multiple values) or is configured (e.g. via higher layer RRC or MACE CE or DCI).
   In one example, e₁(i₁) with i₁≠i_{2,1} are included in the TPMI group reported by the UE (with UE capability reporting, the UE can report only one or multiple values) or is configured (e.g., via higher layer RRC or MACE CE or DCI).
   In one example, e₁(i₁) with i₁≠i_{2,2} are included in the TPMI group reported by the UE (with UE capability reporting, the UE can report only one or multiple values) or is configured (e.g., via higher layer RRC or MACE CE or DCI).
   In one example, e₁(i₁) with i₁≠i_{2,1} and i₁≠i_{2,2} are included in the TPMI group reported by the UE (with UE capability reporting, the UE can report only one or multiple values) or is configured (e.g., via higher layer RRC or MACE CE or DCI).
In one example, the TPMI group type e₅ corresponds to 8Tx precoder type pair (T₁, T₃)=(e₁(i₁), e₃(i_{3,1}, i_{3,2}, i_{3,3})), where it is the index of the 1 antenna group (from the 4 antenna groups), and (i_{3,1}, i_{3,2}, i_{3,3}) are indices of the 3 antenna groups (from the 4 antenna groups).
   In one example, i₁=i_{3,1} is fixed, or i₁∈{_{3,1}, i_{3,2}, i_{3,3}} is reported by the UE (with UE capability reporting, the UE can report only one or multiple values, the UE can report one or multiple values) or is configured (e.g. via higher layer RRC or MACE CE or DCI).
   In one example, e₁(i₁) with i₁=i_{3,x} and i₁=i_{3,y} are included in the TPMI group reported by the UE (with UE capability reporting, the UE can report only one or multiple values) or is configured (e.g., via higher layer RRC or MACE CE or DCI). Here, (x, y)∈{(1,2), (1,3), (2,3)}. In one example, (x, y) is fixed, or is reported by the UE (with UE capability reporting, the UE can report only one or multiple values, the UE can report one or multiple values), or is configured (e.g., via higher layer RRC or MACE CE or DCI).
   In one example, e₁(i₁) with one or both i₁=i_{3,x} or/and i₁=i_{3,y} are included in the TPMI group reported by the UE (with UE capability reporting, the UE can report only one or multiple values) or is configured (e.g. via higher layer RRC or MACE CE or DCI). Here, (x, y)∈{(1,2), (1,3), (2,3)}. In one example, (x, y) is fixed, or is reported by the UE (with UE capability reporting, the UE can report only one or multiple values, the UE can report one or multiple values), or is configured (e.g., via higher layer RRC or MACE CE or DCI).
   In one example, e₁(i₁) with i₁≠i_{3,x} are included in the TPMI group reported by the UE (with UE capability reporting, the UE can report only one or multiple values) or is configured (e.g., via higher layer RRC or MACE CE or DCI). Here, (x, y)∈{1,2,3}. In one example, x is fixed, or is reported by the UE (with UE capability reporting, the UE can report only one or multiple values, the UE can report one or multiple values), or is configured (e.g., via higher layer RRC or MACE CE or DCI).
   In one example, e₁(i₁) with i₁≠i_{3,x} and i₁≠i_{3,y} are included in the TPMI group reported by the UE (with UE capability reporting, the UE can report only one or multiple values) or is configured (e.g., via higher layer RRC or MACE CE or DCI). In one example, (x, y) is fixed, or is reported by the UE (with UE capability reporting, the UE can report only one or multiple values, the UE can report one or multiple values), or is configured (e.g., via higher layer RRC or MACE CE or DCI).
   In one example, e₁(i₁) with i₁≠i_{3,1}, i₁≠i_{3,2} and i₁≠i_{3,3} are included in the TPMI group reported by the UE (with UE capability reporting, the UE can report only one or multiple values) or is configured (e.g. via higher layer RRC or MACE CE or DCI).
In one example, the TPMI group type e₆ corresponds to 8Tx precoder type pair (T₂, T₃)=(e₂(i_{2,1}, i_{2,2}), e₃(i_{3,1}, i_{3,2}, i_{3,3})), where (i_{2,1}, i_{2,2}) are indices of the 2 antenna groups (from the 4 antenna groups), and (i_{3,1}, i_{3,2}, i_{3,3}) are indices of the 3 antenna groups (from the 4 antenna groups).
   In one example, (i_{2,1}, i_{2,2})=(i_{3,1}, i_{3,2}) is fixed, or (i_{2,1}, i_{2,2})∈{(i_{3,1}, i_{3,2}), (i_{3,1}, i_{3,3}), (i_{3,2}, i_{3,3})} is reported by the UE (with UE capability reporting, the UE can report only one or multiple values, the UE can report one or multiple values) or is configured (e.g. via higher layer RRC or MACE CE or DCI).
   In one example, e₁(i_{2,1}, i_{2,2}) with (i_{2,1}, i_{2,2})=(i_{3,x}_{₁}, i_{3,y}_{₁}) and (i_{2,1}, i_{2,2})=(i_{3,x}_{₂}, i_{3,y}_{₂}) are included in the TPMI group reported by the UE (with UE capability reporting, the UE can report only one or multiple values) or is configured (e.g. via higher layer RRC or MACE CE or DCI). Here, (xᵢ, yᵢ)∈{(1,2), (1,3), (2,3)}. In one example, (xᵢ, yᵢ) is fixed or is reported by the UE (with UE capability reporting, the UE can report only one or multiple values, the UE can report one or multiple values), or is configured (e.g., via higher layer RRC or MACE CE or DCI).
   In one example, e₁(i_{2,1}, i_{2,2}) with one or both (i_{2,1}, i_{2,2})=(i_{3,x}_{₁}, i_{3,y}_{₁}) or/and (i_{2,1}, i_{2,2})=(i_{3,x}_{₂}, i_{3,y}_{₂}) are included in the TPMI group reported by the UE (with UE capability reporting, the UE can report only one or multiple values) or is configured (e.g. via higher layer RRC or MACE CE or DCI). Here, (xᵢ, yᵢ)∈{(1,2), (1,3), (2,3)}. In one example, (xᵢ, yᵢ) is fixed or is reported by the UE (with UE capability reporting, the UE can report only one or multiple values, the UE can report one or multiple values), or is configured (e.g., via higher layer RRC or MACE CE or DCI).
   In one example, e₁(i_{2,1}, i_{2,2}) with (i_{2,1}, i_{2,2})≠(i_{3,x}_{₁}, i_{3,y}_{₁}) are included in the TPMI group reported by the UE (with UE capability reporting, the UE can report only one or multiple values) or is configured (e.g. via higher layer RRC or MACE CE or DCI). Here, (x₁, y₁)∈{(1,2), (1,3), (2,3)}. In one example, (x₁, yᵢ) is fixed or is reported by the UE (with UE capability reporting, the UE can report only one or multiple values, the UE can report one or multiple values), or is configured (e.g., via higher layer RRC or MACE CE or DCI).
   In one example, e₁(i_{2,1}, i_{2,2}) with (i_{2,1}, i_{2,2})≠(i_{3,1}, i_{3,y}_{₁}) and (i_{2,1}, i_{2,2})≠(i_{3,x}_{₂}, i_{3,y}_{₂}) are included in the TPMI group reported by the UE (with UE capability reporting, the UE can report only one or multiple values) or is configured (e.g. via higher layer RRC or MACE CE or DCI). In one example, (xᵢ, yᵢ) is fixed or is reported by the UE (with UE capability reporting, the UE can report only one or multiple values, the UE can report one or multiple values), or is configured (e.g., via higher layer RRC or MACE CE or DCI).
   In one example, e₁(i_{2,1}, i_{2,2}) with (i_{2,1}, i_{2,2})≠(i_{3,1}, i_{3,2}), (i_{2,1}, i_{2,2})≠(i_{3,1}, i_{3,3}) and (i_{2,1}, i_{2,2})≠(i_{3,2}, i_{3,3}) are included in the TPMI group reported by the UE (with UE capability reporting, the UE can report only one or multiple values) or is configured (e.g. via higher layer RRC or MACE CE or DCI).

TABLE 24

| | T₁: Each layer | T₂: Layers split | T₃: Layers split |
|---|---|---|---|
| TPMI group | in one | across 2 | across 3 |
| type | Antenna Group | Antenna Groups | Antenna Groups |
| e₁ | 1 | 0 | 0 |
| e₂ | 0 | 1 | 0 |
| e₃ | 0 | 0 | 1 |
| e₄ | 1 | 1 | 0 |
| e₅ | 1 | 0 | 1 |
| e₆ | 0 | 1 | 1 |
| e₇ | 1 | 1 | 1 |

In one example, TPMI groups for a 8Tx PC UE with N_{g}=4 is according to at least one of the TPMI groups as shown in Table 25. In one example, each TPMI group is supported. In one example, either (H0,H1), (I0,I1), or (J0,J1) are supported.

TABLE 25
full power 2Tx TPMI groups for each group (with 2 ports) of N_{g} = 4 groups

| TPMI | | | | | | TPMIs in Rel. 15 NR 2Tx UL |
|---|---|---|---|---|---|---|
| group | TPMI pre-coder/pre-coding matrices | | | | | codebook |
| H0 | $\frac{1}{\sqrt{2}} [ \begin{matrix}1 \\ 1\end{matrix} ]$ | | | | | Rank 1 TPMI 2 |
| H1 | $\frac{1}{2} [ \begin{matrix}1 & 1 \\ 1 & - 1\end{matrix} ]$ | | | | | Rank 2 TPMI 1 |
| I0 | | $\frac{1}{\sqrt{2}} [ \begin{matrix}1 \\ 1\end{matrix} ] ,$ | $\frac{1}{\sqrt{2}} [ \begin{matrix}1 \\ - 1\end{matrix} ] ,$ | $\frac{1}{2} [ \begin{matrix}1 \\ 0 \\ j \\ 0\end{matrix} ] ,$ | $\frac{1}{\sqrt{2}} [ \begin{matrix}1 \\ - j\end{matrix} ]$ | Rank 1 TPMI 2-5 |

| | | | |
|---|---|---|---|
| I1 | $\frac{1}{2} [ \begin{matrix}1 & 1 \\ 1 & - 1\end{matrix} ] ,$ | $\frac{1}{2} [ \begin{matrix}1 & 1 \\ j & - j\end{matrix} ]$ | Rank 2 TPMI 1-2 |
| J0: (H0, H1) | $\frac{1}{\sqrt{2}} [ \begin{matrix}1 \\ 1\end{matrix} ] ,$ | $\frac{1}{2} [ \begin{matrix}1 & 1 \\ 1 & - 1\end{matrix} ]$ | Rank 1 TPMI 2 + Rank 2 TPMI 1 |

| | | | | |
|---|---|---|---|---|
| J1: (I0, I1) | $\frac{1}{\sqrt{2}} [ \begin{matrix}1 \\ 1\end{matrix} ] ,$ $\frac{1}{\sqrt{2}} [ \begin{matrix}1 \\ - j\end{matrix} ] ,$ | $\frac{1}{\sqrt{2}} [ \begin{matrix}1 \\ - 1\end{matrix} ] ,$ $\frac{1}{2} [ \begin{matrix}1 & 1 \\ 1 & - 1\end{matrix} ] ,$ | $\frac{1}{\sqrt{2}} [ \begin{matrix}1 \\ j\end{matrix} ] ,$ $\frac{1}{2} [ \begin{matrix}1 & 1 \\ j & - j\end{matrix} ]$ | Rank 1 TPMI 2-5 + Rank 2 TPMI 1-2 |

In one example, when Ng=4, a UE can report one or more of the full power groups in Table 26 via UE capability reporting for mode 2.

TABLE 26

| Full Power Groups | Layer-splitting for Ng = 4 | Rank |
|---|---|---|
| Group1 (G1) | (1, 0, 0, 0), (2, 0, 0, 0) | 1, 2 |
| Group2 (G2) | (0, 1, 0, 0), (0, 2, 0, 0) | 1, 2 |
| Group3 (G3) | (0, 0, 1, 0), (0, 0, 2, 0) | 1, 2 |
| Group4 (G4) | (0, 0, 0, 1), (0, 0, 0, 2) | 1, 2 |
| Group5 (G5) | (1, 1, 0, 0), (2, 1, 0, 0), (2, 2, 0, 0) | 2, 3, 4 |
| Group6 (G6) | (1, 0, 1, 0), (2, 0, 2, 0), (2, 0, 1, 0) | 2, 3, 4 |
| Group7 (G7) | (1, 0, 0, 1), (2, 0, 0, 1), (2, 0, 0, 2) | 2, 3, 4 |
| Group8 (G8) | (0, 1, 1, 0), (0, 2, 1, 0), (0, 2, 2, 0) | 2, 3, 4 |
| Group9 (G9) | (0, 1, 0, 1), (0, 2, 0, 1), (0, 2, 0, 2) | 2, 3, 4 |
| Group10 (G10) | (0, 0, 1, 1), (0, 0, 2, 1), (0, 0, 2, 2) | 2, 3, 4 |
| Group11 (G11) | (1, 1, 1, 0), (2, 2, 2, 0) | 3, 6 |
| Group12 (G12) | (1, 1, 0, 1) | 3 |
| Group13 (G13) | (1, 0, 1, 1), (2, 0, 2, 1), (2, 0, 2, 2) | 3, 5, 6 |
| Group14 (G14) | (0, 1, 1, 1), (0, 2, 2, 1) | 3, 5 |

In one example, when Ng=4, a UE can report a length N bitmap (or a bitmap or bit sequence of N bits) to indicate the full power groups (or/and TPMI groups) via UE capability reporting for mode 2.
In one example, N=4, and each bit is associated with an antenna group (or/and associated TPMIs).
In one example, N=14, and each bit is associated with one of G1-G14 in Table 26.
In one example, N∈{4,14}, and the UE reports one of the two N values (either explicitly or implicitly) via UE capability reporting for mode 2.
   UE cap1: N=4.
   UE cap2: N=14.

In one example, when Ng=4, a UE can report one or more of the full power groups via UE capability reporting for mode 2. The full power TPMI groups include each of or a subset of groups in Table 26, and also include M≥1 additional TPMI groups, which is a combination of at least two of G1-G14.
In one example, M=10, and the additional TPMI groups include G15-G24 as defined in (Table 27).
In one example, M=14, and the additional TPMI groups include G15-G28 as defined in (Table 27).
In one example, M∈{10,14}, and the UE reports one of the two M values (either explicitly or implicitly) via UE capability reporting for mode 2.
   UE cap1: M=10.
   UE cap2: M=14.
In one example, M∈{4,14} and M∈{10,14}, and the UE reports a pair of values for (N, M) values (either explicitly or implicitly) via UE capability reporting for mode 2.
   UE cap1: (N, M)=(4,10).
   UE cap2: (N, M)=(4,14).
   UE cap3: (N, M)=(14,10).
   UE cap4: (N, M)=(14,14).

TABLE 27

| Full Power Groups | Combinations |
|---|---|
| G15 | {G1, G2, G5} |
| G16 | {G1, G3, G6} |
| G17 | {G1, G4, G7} |
| G18 | {G2, G3, G8} |
| G19 | {G2, G4, G9} |
| G20 | {G3, G4, G10} |
| G21 | {G1, G2, G3, G11} |
| G22 | {G1, G2, G4, G12} |
| G23 | {G1, G3, G4, G13} |
| G24 | {G2, G3, G4, G14} |
| G25 | {G1, G2, G3, G5, G6, G8, G11} |
| G26 | {G1, G2, G4, G5, G7, G9, G12} |
| G27 | {G1, G3, G4, G6, G7, G10, G13} |
| G28 | {G2, G3, G4, G8, G8, G10, G14} |

In one example, the set S_{PC,Ng4} includes TPMI groups corresponding to 8Tx precoders for N_{g}=8. The details of the TPMI groups for N_{g}=8 is according to at least one of the examples described herein.
In one example, TPMI groups corresponding to 8Tx precoders for N_{g}=8 are included.
In one example, a subset of TPMI groups corresponding to 8Tx precoders for N_{g}=8 are included.

In one example, the set S_{PC,Ng4} includes TPMI groups corresponding to 8Tx precoders for N_{g}=4 or/and 8Tx precoders for N_{g}=8. The details of the TPMI groups for N_{g}=8 is according to at least one of the examples described herein. The details of the TPMI groups for N_{g}=4 is according to at least one of the examples described herein.
In one example, TPMI groups corresponding to 8Tx precoders for N_{g}=4 are included and TPMI groups corresponding to 8Tx precoders for N_{g}=8 are included.
In one example, TPMI groups corresponding to 8Tx precoders for N_{g}=4 are included and a subset of TPMI groups corresponding to 8Tx precoders for N_{g}=8 are included.
In one example, a subset of TPMI groups corresponding to 8Tx precoders for N_{g}=4 are included and TPMI groups corresponding to 8Tx precoders for N_{g}=8 are included.
In one example, a subset of TPMI groups corresponding to 8Tx precoders for N_{g}=4 are included and a subset of TPMI groups corresponding to 8Tx precoders for N_{g}=8 are included.

If numbering A is used to construct 8Tx precoders based on 4Tx precoders, then the 4Tx precoders are applied to consecutive 4 out of 8 ports, i.e., 1,2,3,4 or 5,6,7,8 or 0,1,2,3 or 4,5,6,7. Or, if numbering B is used to construct 8Tx precoders based on 4Tx precoders, then the 4Tx precoders are applied to one of the following port tuples, 1,2,5,6 or 3,4,7,8 or 0,1,4,5 or 2,3,6,7.

In one embodiment, the set S_{PC,Ng2} includes TPMI groups for N_{g}=2 that are based on Rel. 15 4Tx UL FC precoders as described herein, except that either one 4Tx FC TPMI (case A) or two 4Tx TPMIs (case B) are indicated/configured, depending on lᵢ values, and the indicated/configured one or two TPMIs are applied to the two antenna groups based on an ordering (lₓ_{₁}, lₓ_{₂}), where (x₁, x₂)=(1,2) or (2,1). In one example, the ordering is fixed, e.g. (1,2) or (2,1). In one example, the ordering is configured/indicated to the UE, e.g., via higher layer or/and MAC CE based signaling. In one example, the ordering is reported by the UE, e.g., via UE capability reporting such as TPMI group indication. For instance:
In one example, a 1-bit signaling (b) or a parameter (p) with two states is used.
   For example, when b=0, (x₁, x₂)=(1,2), and when b=1, (x₁, x₂)=(2,1).
   For example, when b=1, (x₁, x₂)=(1,2), and when b=0, (x₁, x₂)=(2,1).
   For example, when p=v0, (x₁, x₂)=(1,2), and when p=v1, (x₁, x₂)=(2,1).
   For example, when p=v1, (x₁, x₂)=(1,2), and when p=v0, (x₁, x₂)=(2,1).
In one example, a signaling 2-bit signaling is used.

In one example, the PC precoders for N_{g}=2 are described (constructed) based on an ordered set of layer pair values (lₓ_{₁}, lₓ_{₂}). At least one of the Table 28 through Table 31 can be used.

TABLE 28

| | T₁: Each layer in | T₂: Layers split across |
|---|---|---|
| Rank | one Antenna Group | 2 Antenna Groups |
| 1 | (0, 1) or 1 | |
| 2 | (0, 2) or 2 | (1, 1) |
| 3 | (0, 3) or 3 | (1, 2) |
| 4 | (0, 4) or 4 | (1, 3), (2, 2) |
| 5 | | (1, 4), (2, 3) |
| 6 | | (2, 4), (3, 3) |
| 7 | | (3, 4) |
| 8 | | (4, 4) |

TABLE 29

| | T₁: Each layer in | T₂: Layers split across |
|---|---|---|
| Rank | one Antenna Group | 2 Antenna Groups |
| 1 | (1, 0) or 1 | |
| 2 | (2, 0) or 2 | (1, 1) |
| 3 | (3, 0) or 3 | (2, 1) |
| 4 | (4, 0) or 4 | (3, 1), (2, 2) |
| 5 | | (4, 1), (3, 2) |
| 6 | | (4, 2), (3, 3) |
| 7 | | (4, 3) |
| 8 | | (4, 4) |

TABLE 30

| | T₁: Each layer in | T₂: Layers split across |
|---|---|---|
| Rank | one Antenna Group | 2 Antenna Groups |
| 1 | (0, 1) or 1 | |
| 2 | (0, 2) or 2 | (1, 1) |
| 3 | (0, 3) or 3 | (1, 2) |
| 4 | (0, 4) or 4 | (2, 2) |
| 5 | | (2, 3) |
| 6 | | (3, 3) |
| 7 | | (3, 4) |
| 8 | | (4, 4) |

TABLE 31

| | T₁: Each layer in | T₂: Layers split across |
|---|---|---|
| Rank | one Antenna Group | 2 Antenna Groups |
| 1 | (1, 0) or 1 | |
| 2 | (2, 0) or 2 | (1, 1) |
| 3 | (3, 0) or 3 | (2, 1) |
| 4 | (4, 0) or 4 | (2, 2) |
| 5 | | (3, 2) |
| 6 | | (3, 3) |
| 7 | | (3, 4) |
| 8 | | (4, 4) |

Note that the layer splitting according to T₁ are non-full-power (since at least one group has no layers) and T₂ is full-power (since groups have at least one layer). The set S_{PC,Ng2} therefore includes TPMI groups whose layer splitting is according to T₁.

In one example, the set S_{PC,Ng2} includes TPMI groups corresponding to N_{g}=2, where each TPMI group is according to at least one of the following types (Table 32).
In one example, the TPMI group type e₁ corresponds to 8Tx precoder type T₁, i.e., the TPMI group comprises B₁ which is a one of the 4-port groups G0˜G6 (following common as described herein), or one of 4-port full-coherent TPMI groups as shown in Table 34 (e.g. J_{1,6} or J_{1,10}). In one example, the index of the corresponding 1 antenna group (from the 2 antenna groups) is either fixed (e.g., group with ports (0,1,4,5)) or reported by the UE (with UE capability reporting, the UE can report only one or multiple values) or is configured (e.g., via higher layer RRC or MACE CE or DCI). When reported by the UE, a 1-bit reporting or a parameter taking a value from {g1, g2} or (1,2) or

$$\{ [ \begin{matrix}{B}_{1} \\ 0\end{matrix} ] , [ \begin{matrix}0 \\ {B}_{2}\end{matrix} ] \}$$

can be used to indicate a (full power) one of the two antenna groups corresponding to the indicated TPMI group.
In one example, the TPMI group type e₂ corresponds to 8Tx precoder type T₂, i.e., the TPMI group comprises (B₁, B₂), Bᵢ is a one of the 4-port groups G0˜G6 (following common as described herein), or one of 4-port TPMI groups as shown in Table 34. In one example, the corresponding 2 antenna groups is reported by the UE (with UE capability reporting, the UE can report only one or multiple values) or is configured (e.g., via higher layer RRC or MACE CE or DCI).
In one example, the TPMI group type e₃ corresponds to 8Tx precoder type pair (T₁, T₂)=(e₁(i₁), e₂(i_{2,1}, i_{2,2})), where i₁ is the index of the 1 antenna group (from the 2 antenna groups), and (i_{2,1}, i_{2,2}) are indices of the 2 antenna groups.
   In one example, i₁=i_{2,1} is fixed, or i₁∈{i_{2,1}, i_{2,2}} is reported by the UE (with UE capability reporting, the UE can report only one or multiple values) or is configured (e.g., via higher layer RRC or MACE CE or DCI).
   In one example, e₁(i₁) with both i₁=i_{2,1} and i₁=i_{2,2} are included in the TPMI group reported by the UE (with UE capability reporting, the UE can report only one or multiple values) or is configured (e.g., via higher layer RRC or MACE CE or DCI).
   In one example, e₁(i₁) with one or both i₁=i_{2,1} or/and i₁=i_{2,2} are included in the TPMI group reported by the UE (with UE capability reporting, the UE can report only one or multiple values) or is configured (e.g. via higher layer RRC or MACE CE or DCI).
   In one example, e₁(i₁) with i₁≠i_{2,1} are included in the TPMI group reported by the UE (with UE capability reporting, the UE can report only one or multiple values) or is configured (e.g., via higher layer RRC or MACE CE or DCI).
   In one example, e₁(i₁) with i₁≠i_{2,2} are included in the TPMI group reported by the UE (with UE capability reporting, the UE can report only one or multiple values) or is configured (e.g., via higher layer RRC or MACE CE or DCI).
   In one example, e₁(i₁) with i₁≠i_{2,1} and i₁≠i_{2,2} are included in the TPMI group reported by the UE (with UE capability reporting, the UE can report only one or multiple values) or is configured (e.g., via higher layer RRC or MACE CE or DCI).

TABLE 32
N_{g} = 2

| | T₁: Each layer in | T₂: Each layer in |
|---|---|---|
| TPMI group type | one Antenna Group | two Antenna Groups |
| e₁ | 1 | 0 |
| e₂ | 0 | 1 |
| e₃ | 1 | 1 |

In one example of TPMI group type e₁, the set S_{PC,Ng2} includes TPMI groups {Gᵢ} based on (per) antenna group, i=1, 2. The antenna group X₁ including 4 antenna ports and antenna group X₂ including remaining 4 antenna ports. In one example, X₁={0,1,2,3} and X₂={4,5,6,7}. In one example, X₁={0,1,4,5} and X₂={2,3,6,7}. In one example, X₁={0,2,4,6} and X₂={1,3,5,7}.
In one example, the TPMI groups comprise pairs Gᵢ=(a₁, a₂)∈{(g₁, 0), (0, g₂), (g₁,g₂)} or {(g₁, NULL), (NULL, g₂), (g₁, g₂)}, and a₁ corresponds to antenna group Xᵢ.
In one example, the TPMI groups comprise one group a₁={g₁} or a pair (a₁, a₂)∈{(g₁, g₂)}. In one example, when one group, then g₁ corresponds to X₁ or one of X₁ and X₂ (which one is either configured or reported by the UE via UE capability reporting).
In one example, the TPMI groups comprise Gᵢ=(a₁, a₂), a₁={g₁} and a₂={g₂}. In one example, one of the two groups is reported by the UE via UE capability reporting (e.g., 1-bit UE reporting).

In one example, the 8Tx TPMI groups Gᵢ can be given by:
For one group: one or both of

$$[ \begin{matrix}{g}_{1} \\ 0\end{matrix} ] , [ \begin{matrix}0 \\ {g}_{2}\end{matrix} ]$$

For a pair of groups:

$$[ \begin{matrix}{g}_{1} \\ {g}_{2}\end{matrix} ] or [ \begin{matrix}{g}_{1} & 0 \\ 0 & {g}_{2}\end{matrix} ] .$$

A 3-bit bitmap b₀ . . . b₂ can be reported by the UE (e.g., UE 116) to indicate one group and a pair, {(g₁, 0), (0,g₂), (g₁,g₂)}, respectively. Or, if only at most one group can be reported between (g₁, 0), (0, g₂), then for each

$$⌈ {log}_{2} ( \begin{matrix}2 \\ 1\end{matrix} ) ⌉ = 1$$

bit indication can be used to report a group from (g, 0), (0, g₂), i.e., a single bit is used to indicate which of the antenna group has full power capability. For example, a bit value b=0 indicates first antenna group (or/and corresponding TPMIs), and a bit value b=1 indicates second antenna group (or/and corresponding TPMIs). Or a bit value b=1 indicates first antenna group (or/and corresponding TPMIs), and a bit value b=0 indicates second antenna group (or/and corresponding TPMIs).

In one example, a UE can report TPMI groups corresponding to only one of {(g₁, 0), (0, g₂), (g₁, g₂)}. In one example, a UE can report TPMI groups corresponding to {Y, (g₁, g₂)}, where Y is one of (g₁, 0), (0, g₂). In one example, a UE can report TPMI groups corresponding to each of {(g₁, 0), (0, g₂), (g₁, g₂)}. For a given Tᵢ, the gᵢ's are according to Rel. 15 4Tx full coherent TPMIs.

In one example, for an indicated group, full power is supported for ranks or/layer combinations or layer splitting. This is, for Ng=2, when Group1 is indicated, full power is supported for rank 1,2 and layer splitting; when Group2 is indicated, full power is supported for rank 1,2. In general, when Group n∈{1, . . . , N_{g}} is indicated, full power is supported for rank 1 . . . , N_{g}. An example is shown in Table 33.

In one example, for an indicated group, full power is supported for a subset of rank, e.g., only rank 1, or only rank 1-2, only rank 1,2,3 or only rank 1,2,3,4.

TABLE 33

| | layer-splitting | |
|---|---|---|
| Full Power Groups | cases for Ng = 2 | Rank |
| Group1 | (1, 0), (2, 0), | 1, 2, 3, 4 |
| | (3, 0), (4, 0) | |
| Group2 | (0, 1), (0, 2), | 1, 2, 3, 4 |
| | (0, 3), (0, 4) | |

In one example, TPMI groups for a 8Tx PC UE with N_{g}=2 is according to at least one of the TPMI groups as shown in Table 34, where groups Q₀, . . . , Q₃ are shown in Table 35.

TABLE 34
full power 4Tx TPMI groups for each group (with 4 ports) of N_{g} = 2 groups

| TPMI | TPMI pre-coder/pre-coding | |
|---|---|---|
| group | matrices | TPMIs in Rel. 15 NR 4Tx UL codebook |
| H₀ | $\frac{1}{2} [ \begin{matrix}1 \\ 1 \\ 1 \\ 1\end{matrix} ]$ | Rank 1 TPMI 12 |
| H₁ | $\frac{1}{2 \sqrt{2}} [ \begin{matrix}1 & 1 \\ 1 & 1 \\ 1 & - 1 \\ 1 & - 1\end{matrix} ]$ | Rank 2 TPMI 14 |
| H₂ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | Rank 3 TPMI 3 |
| H₃ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | Rank 4 TPMI 3 |
| I₀ | Q₀ | Rank 1 TPMI 12-27 |
| I₁ | Q₁ | Rank 2 TPMI 14-21 |
| I₂ | Q₂ | Rank 3 TPMI 3-6 |
| I₃ | Q₃ | Rank 4 TPMI 3-4 |
| J_{0,0} | (H₀, H₁) | Rank 1 TPMI 12 + Rank 2 TPMI 14 |
| J_{0,1} | (H₀, H₂) | Rank 1 TPMI 12 + Rank 3 TPMI 3 |
| J_{0,2} | (H₀, H₃) | Rank 1 TPMI 12 + Rank 4 TPMI 3 |
| J_{0,3} | (H₁, H₂) | Rank 2 TPMI 14 + Rank 3 TPMI 3 |
| J_{0,4} | (H₁, H₃) | Rank 1 TPMI 14 + Rank 4 TPMI 3 |
| J_{0,5} | (H₂, H₃) | Rank 3 TPMI 3 + Rank 4 TPMI 3 |
| J_{0,6} | (H₀, H₁, H₂) | Rank 1 TPMI 12 + Rank 2 TPMI 14 + Rank 3 TPMI 3 |
| J_{0,7} | (H₀, H₁, H₃) | Rank 1 TPMI 12 + Rank 2 TPMI 14 + Rank 4 TPMI 3 |
| J_{0,8} | (H₀, H₂, H₃) | Rank 1 TPMI 12 + Rank 3 TPMI 3 + Rank 4 TPMI 3 |
| J_{0,9} | (H₁, H₂, H₃) | Rank 2 TPMI 14 + Rank 3 TPMI 3 + Rank 4 TPMI 3 |
| J_{0,10} | (H₀, H₁, H₂, H₃) | Rank 1 TPMI 12 + Rank 2 TPMI 14 + Rank 3 TPMI 3 + |
| | | Rank 4 TPMI 3 |
| J_{1,0} | (I₀, I₁) | Rank 1 TPMI 12-27 + Rank 2 TPMI 14-21 |
| J_{1,1} | (I₀, I₂) | Rank 1 TPMI 12-27 + Rank 3 TPMI 3-6 |
| J_{1,2} | (I₀, I₃) | Rank 1 TPMI 12-27 + Rank 4 TPMI 3-4 |
| J_{1,3} | (I₁, I₂) | Rank 2 TPMI 14-21 + Rank 3 TPMI 3-6 |
| J_{1,4} | (I₁, I₃) | Rank 1 TPMI 14-21 + Rank 4 TPMI 3-4 |
| J_{1,5} | (I₂, I₃) | Rank 3 TPMI 3-6 + Rank 4 TPMI 3-4 |
| J_{1,6} | (I₀, I₁, I₂) | Rank 1 TPMI 12-27 + Rank 2 TPMI 14-21 + Rank 3 TPMI |
| | | 3-6 |
| J_{1,7} | (I₀, I₁, I₃) | Rank 1 TPMI 12-27 + Rank 2 TPMI 14-21 + Rank 4 TPMI |
| | | 3-4 |
| J_{1,8} | (I₀, I₂, I₃) | Rank 1 TPMI 12-27 + Rank 3 TPMI 3-6 + Rank 4 TPMI |
| | | 3-4 |
| J_{1,9} | (I₁, I₂, I₃) | Rank 2 TPMI 14-21 + Rank 3 TPMI 3-6 + Rank 4 TPMI |
| | | 3-4 |
| J_{1,10} | (I₀, I₁, I₂, I₃) | Rank 1 TPMI 12-27 + Rank 2 TPMI 14-21 + Rank 3 TPMI |
| | | 3-6 + Rank 4 TPMI 3-4 |

TABLE 35

| | Rank 1 | | | | | | | | |
|---|---|---|---|---|---|---|---|---|---|
| TPMI | TPMI | W | | | | | | | |
| group | Index | (ordered from left to right in increasing order of TPMI index) | | | | | | | |
| Q0 | 12-19 | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ |
| | 20-27 | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ |

| | Rank 2 | | | | |
|---|---|---|---|---|---|
| TPMI | TPMI | W | | | |
| group | Index | (ordered from left to right in increasing order of TPMI index) | | | |
| Q1 | 14-17 | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ |
| | 18-21 | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |
| | Rank 3 | | | | |
| TPMI | TPMI | W | | | |
| group | Index | (ordered from left to right in increasing order of TPMI index) | | | |
| Q2 | 3-6 | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |

| | Rank 4 | | |
|---|---|---|---|
| TPMI | TPMI | W | |
| group | Index | (ordered from left to right in increasing order of TPMI index) | |
| Q3 | 3-4 | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

In one example, the set S_{PC,Ng2} includes TPMI groups corresponding to 8Tx precoders for N_{g}=8. The details of the TPMI groups for N_{g}=8 is according to at least one of the examples described herein.
In one example, TPMI groups corresponding to 8Tx precoders for N_{g}=8 are included.
In one example, a subset of TPMI groups corresponding to 8Tx precoders for N_{g}=8 are included.

In one example, the set S_{PC,Ng2} includes TPMI groups corresponding to 8Tx precoders for N_{g}=2 or/and 8Tx precoders for N_{g}=8. The details of the TPMI groups for N_{g}=8 is according to at least one of the examples in described herein. The details of the TPMI groups for N_{g}=2 is according to at least one of the examples described herein.
In one example, TPMI groups corresponding to 8Tx precoders for N_{g}=2 are included and TPMI groups corresponding to 8Tx precoders for N_{g}=8 are included.
In one example, TPMI groups corresponding to 8Tx precoders for N_{g}=2 are included and a subset of TPMI groups corresponding to 8Tx precoders for N_{g}=8 are included.
In one example, a subset of TPMI groups corresponding to 8Tx precoders for N_{g}=2 are included and TPMI groups corresponding to 8Tx precoders for N_{g}=8 are included.
In one example, a subset of TPMI groups corresponding to 8Tx precoders for N_{g}=2 are included and a subset of TPMI groups corresponding to 8Tx precoders for N_{g}=8 are included.

In one example, the set S_{PC,Ng2} includes TPMI groups corresponding to 8Tx precoders for N_{g}=4. The details of the TPMI groups for N_{g}=4 is according to at least one of the examples described herein.
In one example, TPMI groups corresponding to 8Tx precoders for N_{g}=4 are included.
In one example, a subset of TPMI groups corresponding to 8Tx precoders for N_{g}=4 are included.

In one example, the set S_{PC,Ng2} includes TPMI groups corresponding to 8Tx precoders for N_{g}=2 or/and 8Tx precoders for N_{g}=4. The details of the TPMI groups for N_{g}=4 is according to at least one of the examples described herein. The details of the TPMI groups for N_{g}=2 is according to at least one of the examples described herein.
In one example, TPMI groups corresponding to 8Tx precoders for N_{g}=2 are included and TPMI groups corresponding to 8Tx precoders for N_{g}=4 are included.
In one example, TPMI groups corresponding to 8Tx precoders for N_{g}=2 are included and a subset of TPMI groups corresponding to 8Tx precoders for N_{g}=4 are included.
In one example, a subset of TPMI groups corresponding to 8Tx precoders for N_{g}=2 are included and TPMI groups corresponding to 8Tx precoders for N_{g}=4 are included.
In one example, a subset of TPMI groups corresponding to 8Tx precoders for N_{g}=2 are included and a subset of TPMI groups corresponding to 8Tx precoders for N_{g}=4 are included.

In one example, the set S_{PC,Ng2} includes TPMI groups corresponding to 8Tx precoders for N_{g}=2 or/and 8Tx precoders for N_{g}=4 or/and 8Tx precoders for N_{g}=8. The details of the TPMI groups for N_{g}=8 is according to at least one of the examples described herein. The details of the TPMI groups for N_{g}=4 is according to at least one of the examples described herein. The details of the TPMI groups for N_{g}=2 is according to at least one of the examples described herein.
In one example, TPMI groups corresponding to 8Tx precoders for N_{g}=2 are included and TPMI groups corresponding to 8Tx precoders for N_{g}=4 are included and TPMI groups corresponding to 8Tx precoders for N_{g}=8 are included.
In one example, TPMI groups corresponding to 8Tx precoders for N_{g}=2 are included and a subset of TPMI groups corresponding to 8Tx precoders for N_{g}=4 are included and TPMI groups corresponding to 8Tx precoders for N_{g}=8 are included.
In one example, a subset of TPMI groups corresponding to 8Tx precoders for N_{g}=2 are included and TPMI groups corresponding to 8Tx precoders for N_{g}=4 are included and TPMI groups corresponding to 8Tx precoders for N_{g}=8 are included.
In one example, a subset of TPMI groups corresponding to 8Tx precoders for N_{g}=2 are included and a subset of TPMI groups corresponding to 8Tx precoders for N_{g}=4 are included and TPMI groups corresponding to 8Tx precoders for N_{g}=8 are included.
In one example, TPMI groups corresponding to 8Tx precoders for N_{g}=2 are included and TPMI groups corresponding to 8Tx precoders for N_{g}=4 are included and a subset of TPMI groups corresponding to 8Tx precoders for N_{g}=8 are included.
In one example, TPMI groups corresponding to 8Tx precoders for N_{g}=2 are included and a subset of TPMI groups corresponding to 8Tx precoders for N_{g}=4 are included and a subset of TPMI groups corresponding to 8Tx precoders for N_{g}=8 are included.
In one example, a subset of TPMI groups corresponding to 8Tx precoders for N_{g}=2 are included and TPMI groups corresponding to 8Tx precoders for N_{g}=4 are included and a subset of TPMI groups corresponding to 8Tx precoders for N_{g}=8 are included.
In one example, a subset of TPMI groups corresponding to 8Tx precoders for N_{g}=2 are included and a subset of TPMI groups corresponding to 8Tx precoders for N_{g}=4 are included and a subset of TPMI groups corresponding to 8Tx precoders for N_{g}=8 are included.

FIG. 7 illustrates a diagram of example virtualized and non-virtualized SRS ports 700 according to embodiments of the present disclosure. For example, virtualized and non-virtualized SRS ports 700 can be implemented in the UE 111A of FIG. 1. This example is for illustration only and other embodiments can be used without departing from the scope of the present disclosure.

The abovementioned UL power-related issues can also be handled by configuring SRS resources with different or same number of SRS ports, wherein the SRS ports can be virtualized, i.e., multiple PAs associated with multiple antenna ports can be combined/virtualized to obtain one SRS port. In Rel.16 NR specification [TS 38.306, 38.331], such SRS configuration is supported for 2 and 4 antenna ports. Here, the UE can virtualize Tx chains when configured with an SRS resource that has fewer ports than the number of Tx chains. With reference to FIG. 7, virtualized SRS port is shown for the UE with two Tx chains, where w₀ and w₁ are virtualization weights used at the two Tx chains. A few example embodiments are provided in the present disclosure. The scope of the present disclosure is not limited to only these embodiments, but includes any extensions or combinations of the provided embodiments.

In this disclosure, several embodiments are provided for SRS configuration with same of different number of SRS ports for a UE with >4 antenna ports (e.g., 8 antenna ports).

The present disclosure relates to SRS configuration for a UE with >4 (e.g., 8) antenna ports. The present disclosure includes the following:
SRS configuration with SRS resources with different or same number of SRS ports (for 2 or 4 or 8 antenna ports)
UE capability
Associated signaling/configuration

In one example, we assume each of the antenna ports of the UE (e.g., UE 116) belong to a single antenna panel (i.e., they are co-located, for example, at one plane, side, or edge of the UE). We further assume that N₁ and N₂ are the number of antenna ports with the same polarization in the first and second dimensions, respectively. For 2D antenna port layouts, we have N₁>1, N₂>1, and for 1D antenna port layouts, we either have N₁>1 and N₂=1 or N₂>1 and N₁=1. In the rest of the present disclosure, 1D antenna port layouts with N₁>1 and N₂=1 is considered. The present disclosure, however, is applicable to the other 1D port layouts with N₂>1 and N₁=1. Also, in the rest of the present disclosure, we assume that N₁≥N₂. The present disclosure, however, is applicable to the case when N₁<N₂, and the embodiments for N₁>N₂ applies to the case N₁<N₂ by swapping/switching (N₁, N₂) with (N₂, N₁). For a (single-polarized) co-polarized antenna port layout, the total number of antenna ports is N₁N₂ and for a dual-polarized antenna port layout, the total number of antenna ports is 2N₁N₂. An illustration of antenna port layouts for {2, 4, 6, 8, 12} antenna ports at UE is shown in Table 46.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

In one example, the UL codebook W for P antenna ports at the UE is based on pre-coding vectors which are according to one of the two alternatives in Table depending on whether the antenna ports are co-polarized or cross-/dual-polarized.

TABLE 46
Pre-coding vectors

| Co-pol | Dual-pol |
|---|---|
| ${v}_{l , m} = \frac{{v}_{l , m}}{\sqrt{{N}_{1} {N}_{2}}}$ | ${v}_{l , m , n} = \frac{1}{\sqrt{2 {N}_{1} {N}_{2}}} [ \begin{matrix}{v}_{l , m} \\ {φ}_{n} {v}_{l , m}\end{matrix} ]$ |

Here, v_{l,m} is a Kronecker product (⊗) of vectors wₗ and uₘ of lengths N₁ and N₂, respectively. In one example, wₗ and uₘ are oversampled DFT vectors, i.e.,

$${w}_{l} = [ \begin{matrix}1 & {e}^{j \frac{2 π l}{{O}_{1} {N}_{1}}} & {e}^{j \frac{4 π l}{{O}_{1} {N}_{1}}} & … & {{e}^{j \frac{2 π l ( {N}_{1} - 1 )}{{O}_{1} {N}_{1}}} ]}^{T}\end{matrix}$$

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} & {N}_{2} > 1 \\ 1 & {N}_{2} = 1\end{matrix}$$

where O₁ and O₂ are oversampling factors in two dimensions, and v_{l,m} is then given by

$${v}_{l , m} = {w}_{l} ⊗ {u}_{m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T}\end{matrix}$$

In one example, both O₁, O₂∈{2,4,8}. In one example, O₁ and O₂ can take the same values as Rel.15 NR Type I codebook (cf. 5.2.2.2.1, TS 38.214), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g., via higher layer).

The quantity φₙ is a co-phase for dual-polarized antenna port layouts. In one example, φₙ=e^{jπn/2}, where n∈{0,1,2,3} implying that φₙ belongs to QPSK alphabet {1, j, −1, −j}.

In one example, the values of N₁ and N₂ are configured, e.g., with the higher layer parameter n1-n2-ul. The supported configurations of (N₁, N₂) for a given number of antenna ports (P) is given in Table 47.

TABLE 47
Configurations of (N₁, N₂)

| Number of | Dual-pol | Co-pol |
|---|---|---|
| antenna ports, P | (N₁, N₂) | (N₁, N₂) |
| 2 | (1, 1) | (2, 1) |
| 4 | (2, 1) | (2, 2), (4, 1) |
| 6 | (3, 1) | (3, 2), (6, 1) |
| 8 | (2, 2), (4, 1) | (4, 2), (8, 1) |
| 12 | (3, 2), (6, 1) | (4, 3), (6, 2), (12, 1) |
| 16 | (4, 2), (8, 1) | (8, 2), (4, 4), (16, 1) |

In one example, the values of N₁ and N₂ are fixed for a given number of antenna ports. For example, (N₁, N₂)=(P, 1) for co-pol and

$$( \frac{P}{2} , 1 )$$

for dual-pol antenna. In one example, only one (N₁, N₂) is supported for each value of P, where the supported (N₁, N₂) is one of pairs in Table 47.

The dual-polarized antenna layout is assumed in the rest of the disclosure. The number of antenna ports is assumed to be P=8 in the rest of the disclosure.

In one example, P antenna ports can be divided into multiple groups. Let N_{g} be the number of antenna port groups. When each group comprises the same number of antenna ports, then each groups has the antenna layout with (N₁, N₂) value as shown in Table 48.

TABLE 48

| N_{g} | (N₁, N₂) |
|---|---|
| 1 | (4, 1), (2, 2) |
| 2 | (2, 1) |
| 4 | (1, 1) |
| 8 | Not applicable |

In one example, N_{g}=1 corresponds to a single antenna panel. In one example, N_{g}=1 corresponds to a full coherent (FC) UE or FC antenna layout.

In one example, N_{g}=2 corresponds to two antenna panels. In one example, N_{g}=2 corresponds to a partial coherent (PC) UE or PC antenna layout.

In one example, N_{g}=4 corresponds to four antenna panels. In one example, N_{g}=4 corresponds to a partial coherent (PC) UE or PC antenna layout.

In one example, N_{g}=8 corresponds to eight antenna panels. In one example, N_{g}=8 corresponds to a non-coherent (NC) UE or NC antenna layout.

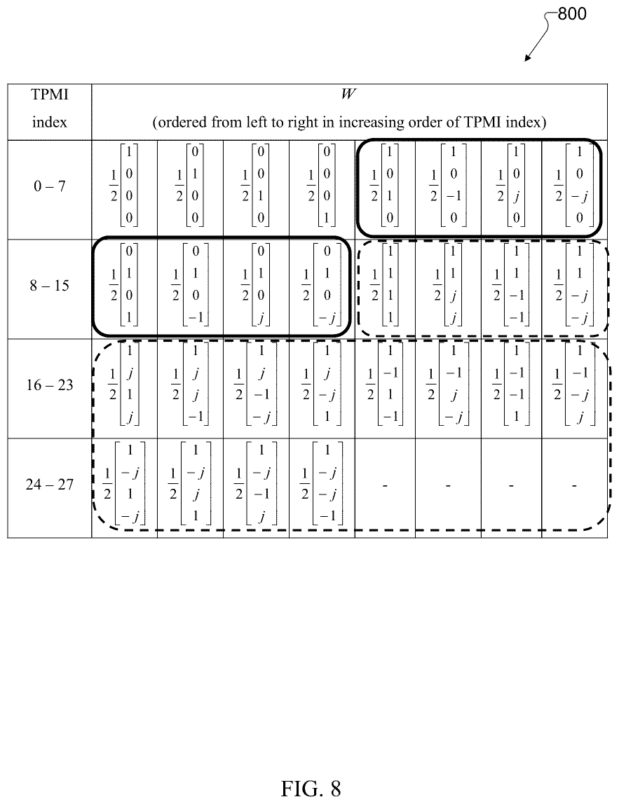

FIG. 8 illustrates a diagram of an example TPMI index 800 according to embodiments of the present disclosure. For example, TPMI index 800 can be utilized by the UE 116 of FIG. 3. This example is for illustration only and other embodiments can be used without departing from the scope of the present disclosure.

In one embodiment, the UL codebook includes partial-coherent (PC) precoding matrices, and a PC precoding matrix can be defined as a matrix whose each column comprises both zero and non-zero entries, e.g., at least two non-zero and remaining zero elements/entries in each column.

In one example, the codebook for 8 antenna ports includes partial coherent precoders or precoding matrices that are based on the precoders or precoding matrices included in Rel. 15 UL 4Tx or UL 2Tx codebooks (Table 36-Table 41).

The partial coherent precoders for N_{g}=2 can be constructed according to one of the following alternatives.
Alt1: based on UL 4Tx codebook
   Rank 1: one 4Tx rank 1 TPMI+indication of 1 of the 2 groups
      FC only
   Rank 2: depending on distribution of layers across groups
      Ex1 (each layer in one group): one 4Tx rank 2 TPMI+indication of 1 of the 2 groups
         1. FC only
      Ex2 (one layer per group): two 4Tx rank 1 TPMIs, one for each group
         1. Ex2a: both FC
         2. Ex2b: one FC and one PC
   Rank>3: similar to rank 2
Alt2: based on UL 2Tx codebook+co-phase across 2Tx TPMIs (to obtain a 4Tx precoder)
   Rank 1: two 2Tx rank 1 TPMIs+one rank 1 co-phase+indication of 1 of the 2 groups
      FC only
   Rank 2: depending on distribution of layers across groups
      Ex3 (each layer in one group): two 2Tx rank 2 TPMIs+rank 2 co-phase+indication of 1 of the 2 groups
      Ex4 (one layer per group): Two pairs of (two 2Tx rank 1 TPMIs+one rank 1 co-phase), one pair for each group
         1. Ex4a: both FC
         2. Ex4b: one FC and one PC
   Rank>3: similar to rank 2
Alt3: based on both UL 2Tx and 4Tx codebooks
   Rank 1: a combination based on examples in Alt1 and Alt2
      Ex5: one 4Tx rank 1 TPMI
      Ex6: two 2Tx rank 1 TPMIs+co-phase across 2Tx TPMIs
   Rank 2: a combination based on examples in Alt1 and Alt2
   Rank>3: similar to rank 2

Among these alternatives, Alt1 is the simplest and makes the most sense since the antenna ports within a group are expected to be coherent. In particular, the FC precoders in the UL 4Tx codebook can be used to design the 8Tx UL codebook for N_{g}=2.

For N_{g}=4, there are two alternatives:
Alt1: Rel.15 UL 4Tx partial-coherent precoders
Alt2: Rel. 15 UL 2Tx full-coherent precoders

One advantage of Alt1 is that Rel.15 4Tx PC precoders based design can reduce the number of candidate precoders significantly, when compared with 2Tx full-coherent based design.

With reference to FIG. 8, an example of the PC precoder design for rank 1 is shown.
N_{g}=2: based on FC precoders (shown in red boxes)
   1 FC precoder:
      group 1

$$[ \begin{matrix}g \\ 0\end{matrix} ] ( g$$

from TPMI12-27)
group 2

$$[ \begin{matrix}0 \\ g\end{matrix} ] ( g$$

from TPMI12-27)
2 FC precoders:

$$[ \begin{matrix}{g}_{1} \\ {g}_{2}\end{matrix} ]$$

(gᵢ from TPMI12-27)
N_{g}=4: based on PC 4Tx precoders (shown in blue boxes)
   1 PC precoder:
      group 1

$$[ \begin{matrix}g \\ 0\end{matrix} ]$$

(g from TPMI4-7)
group 2

$$[ \begin{matrix}g \\ 0\end{matrix} ]$$

(g from TPMI8-11)
group 3

$$[ \begin{matrix}0 \\ g\end{matrix} ]$$

(g from TPMI4-7)
group 4

$$[ \begin{matrix}0 \\ g\end{matrix} ]$$

(g from TPMI8-11)
2 PC precoders:

$$[ \begin{matrix}{g}_{1} \\ {g}_{2}\end{matrix} ]$$

(gᵢ from TPMI4-11)

Likewise for N_{g}=2, if numbering A is used to construct 8Tx precoders based on 4Tx precoders, then the 4Tx precoders are applied to consecutive 4 out of 8 ports, i.e., for n=1, 2, 4 ports are (g_{n,1}, . . . , g_{n,4})={(1,2,3,4),(5,6,7,8)} or {(0,1,2,3),(4,5,6,7)}. Or, if numbering B is used to construct 8Tx precoders based on 4Tx precoders, then the 4Tx precoders are applied to one of the following port tuples, for n=1, 2, 4 ports are (g_{n,1}, . . . , g_{n,4})={(1,2,5,6),(3,4,7,8)} or {(0,1,4,5),(2,3,6,7)}.

Likewise for N_{g}=4, if numbering A is used to construct 8Tx precoders based on 2Tx precoders, then the 2Tx precoders are applied to consecutive 2 out of 8 ports, i.e., for n=1, 2, 3, 4, 2 ports are (g_{n,1}, g_{n,2})={(1,2),(3,4),(5,6),(7,8)} or {(0,1),(2,3),(4,5),(6,7)}. Or, if numbering B is used to construct 8Tx precoders based on 2Tx precoders, then the 2Tx precoders are applied to one of the following port pairs, for n=1, 2, 3, 4, port pairs are (g_{n,1}, g_{n,2})={(1,5), (2,6), (3,7), (4,8)} or {(0,4), (1,5),(2,6), (3,7)}.

In one example, the precoding matrix W=W_{B} for numbering scheme B can be obtained by row permutation (ordering) of the precoding matrix W=W_{A} for numbering scheme A. For example,

W_{B}=W_{f(j)}=W′ⱼ=W_{A}
where the subscripts j and iⱼ=f(j) denote the row of the respective matrix; f(j) is given by Table 49.

TABLE 49
The port mapping function f (j) for
transmission using 8 antenna ports

| j | f(j): N_{g} = 1, 8 | f(j): N_{g} = 2 | f(j): N_{g} = 4 |
|---|---|---|---|
| 0 | 0 | 0 | 0 |
| 1 | 1 | 1 | 4 |
| 2 | 2 | 4 | 1 |
| 3 | 3 | 5 | 5 |
| 4 | 4 | 2 | 2 |
| 5 | 5 | 3 | 6 |
| 6 | 6 | 6 | 3 |
| 7 | 7 | 7 | 7 |

The row index j∈{0, 1, . . . , 7} maps to ports f(j)∈{g_{1,1}, g_{1,2}, g_{2,1}, g_{2,2}, g_{3,1}, g_{3,2}, g_{4,1}, g_{4,2}}, respectively, {g_{a,b}} are defined herein. In one example, W_{f(j)}=W′ⱼ is referred to as intermediate precoder or precoding matrix.

In one embodiment, a UE reports, via UE capability signaling, whether it is capable of full power UL transmission based on “virtualized” SRS transmission (referred to as full power mode 2 herein). When the UE (e.g., UE 116) is capable of full power UL transmission based on “virtualized” SRS transmission, then the UE is configured with at least one or multiple of the following two types of SRS resources (either in one SRS resource set or in two different SRS resource sets):
Type 1 (non-virtualized or non-precoded): comprises K₁ SRS resources with N₁ SRS ports, where N₁ equals the number of Tx chains (or antenna ports) at the UE, where K₁≥1
Type 2 (virtualized or precoded): comprises K₂ SRS resources with N₂ SRS ports, where N₂ is less than the number of Tx chains (or antenna ports) at the UE, where K₂≥1

For the Type 1 SRS resources, the UE does not virtualize (precode) multiple Tx chains (or antenna ports) before transmitting SRS resources from them. For the Type 2 SRS resources, on the other hand, the UE virtualizes (precodes) multiple Tx chains (or antenna ports) to obtain N₂ SRS ports before transmitting SRS resources from them. The virtualization weight (or precoding vector) is either transparent (not known at the gNB) or is reported by the UE to the gNB (e.g., BS 102) or is configured by the gNB (e.g., via TPMI together with SRS configuration). Here, the virtualization refers to assigning (using) non-zero weights to multiple Tx chains (each associated with a power amplifier, PA) and combing the weighted Tx chains (or PAs) to form a single “virtualized” SRS port (or virtualized Tx chain). In one example, for the Type 2 SRS resources, the UE may be further configured with CSI-RS resources (e.g., via associated-CSIRS configuration) to link the virtualized SRS resources with CSI-RS resources, where the CSI-RS resources are measured by the UE to obtain virtualization weights (precoding vectors) to virtualize the corresponding Type 2 SRS resources.

In one example, N₁∈{2,4,6,8}. In one example, N₂=1 is fixed. In one example, N₂∈{1,2}. In one example, N₂∈{1,2,3}. In one example, N₂∈{1,2,3,4}. In one example, N₂∈{1,2,4}. In one example, N₂∈{1,2,4,8}. In one example, N₂∈{1, . . . , N₁}.

In one example, when K₂>1, then the number of SRS ports (N₂) in each Type 2 SRS resource is the same. In another example, when K₂>1, then the number of SRS ports (N₂) in different Type 2 SRS resources can be different.

The UE transmits Type 1 or/and 2 SRS resources according to the SRS configuration received from the gNB. The gNB measures the corresponding SRS ports and calculates SRI/TPMI, and indicates the calculated SRI/TPMI to the UE (e.g., via DCI or higher layer RRC signaling). The UE uses SRI/TPMI to select a SRS resource and corresponding SRS ports (with non-zero power) for UL (PUSCH) transmission. The PUSCH power (via UL power control) is scaled by a factor β=ρ₀/ρ, where ρ₀=number of SRS ports with non-zero power, and ρ=number of SRS ports in SRS resource indicated by SRI.

In one embodiment, a UE equipped with >4 (e.g., 8) antenna ports is configured with a number of SRS resources N_{SRS} in one SRS resource set with usage set to ‘codebook’ for full power Mode 2, where N_{SRS}≤M, and M is a maximum number of SRS resources in one SRS resource set with usage set to ‘codebook’ for full power Mode 2. The UE is further configured with a full power UL (e.g., PUSCH) transmission via higher layer parameter ul-FullPowerTransmission8Tx-r18 set to fullpowerMode2 in PUSCH-Config. The UL transmission can be RRC-configured (e.g., configured-grant PUSCH) or granted by UL-DCI, and the information about one of the N_{SRS} SRS resources can be provided (e.g., via SRI) which indicates the SRS antenna ports that correspond to or associated with the PUSCH (ports for) transmission.

The value of M is reported by the UE (e.g., UE 116) via UE capability reporting, either as a separate feature group (FG) or as a component of an FG comprising multiple components. An example is shown below, where the notation n1 implies a number ‘1’, n2 implies a number ‘2’, and so on.
The maximum number of SRS resources in one SRS resource set with usage set to ‘codebook’ for Mode 2
ul-FullPwrMode2-MaxSRS-ResInSet-8Tx-r18 ENUMERATED {n1, n2, n4, n} OPTIONAL

In one example, n is empty or NULL, i.e., M∈S₁={1,2,4} or ={n1, n2, n4}. In one example, n is non-empty, i.e., M∈S₂={1,2,4,n} or {n1, n2, n4, n}.
In one example, n=3 or n3.
In one example, n=8 or n8.
In one example, n={3,8} or {n3, n8}.
In one example, n={6} or n6.
In one example, n={3,6} or {n3, n6}.
In one example, n={6,8} or {n6, n8}.
In one example, n={3,6,8} or {n3, n6, n8}.
In one example, n={5,6,7,8} or {n5, n6, n7, n8}.
In one example, n={3,5,6,7,8} or {n3, n5, n6, n7, n8}.

In one example, when 8 SRS (antenna) ports are divided into N_{g}=2 SRS (antenna) port groups (e.g., each with 4 ports), the UE can report a maximum number of SRS (antenna) port groups, via UE capability reporting, either as a separate feature group (FG) or as a component of an FG comprising multiple components.
The maximum number of SRS (antenna) port groups in SRS resources in one SRS resource set with usage set to ‘codebook’ for Mode 2
ul-FullPwrMode2-MaxSRS-TwoPortGroup-8Tx-r18 ENUMERATED {n1, n2}
OPTIONAL

In one example, when ul-FullPwrMode2-MaxSRS-TwoPortGroup-8Tx-r18=n1, one of the 2 port groups can achieve full power according to full power mode 2. In this case, the UE reports a value of M based on ul-FullPwrMode2-MaxSRS-ResInSet-r18 ENUMERATED {n1, n2, n4}.

In one example, when ul-FullPwrMode2-MaxSRS-TwoPortGroup-8Tx-r18=n2, each of the 2 port groups can achieve full power according to full power mode 2. In this case, the UE reports a value of M based on one of the following.

In one example, it is based on a pair (m₁, m₂), each based on ul-FullPwrMode2-MaxSRS-ResInSet-r18 ENUMERATED {n1, n2, n4}. In one example, M=m₁+m₂. In one example, M=max(m₁,m₂). In one example, (m₁,m₂) belongs to {(1,1), (1,2), (2,1), (1,4), (4,1), (2,2), (2,4), (4,2), (4,4)}.

In one example, it is based on ul-FullPwrMode2-MaxSRS-ResInSet-8Tx-r18 ENUMERATED {n1, n2, n4, n}, where n is according to one of the examples described herein.

In one example, it is based on a pair of common parameters, as shown below, where each parameter is associated with an antenna group.
The maximum number of SRS resources in one SRS resource set with usage set to ‘codebook’ for Mode 2
ul-FullPwrMode2-MaxSRS-ResInSet-Group1-r18 ENUMERATED {n1, n2, n4}

### OPTIONAL

ul-FullPwrMode2-MaxSRS-ResInSet-Group2-r18 ENUMERATED {n1, n2, n4}OPTIONAL

In one example, when 8 SRS (antenna) ports are divided into N_{g}=4 SRS (antenna) port groups (e.g., each with 2 ports), the UE can report a maximum number of SRS (antenna) port groups, via UE capability reporting, either as a separate feature group (FG) or as a component of an FG comprising multiple components.
The maximum number of SRS (antenna) port groups in SRS resources in one SRS resource set with usage set to ‘codebook’ for Mode 2
ul-FullPwrMode2-MaxSRS-FourPortGroup-8Tx-r18 ENUMERATED {n1, n2, n3, n4}
OPTIONAL

In one example, when ul-FullPwrMode2-MaxSRS-FourPortGroup-8Tx-r18=n1, one of the 4 port groups can achieve full power according to full power mode 2. In this case, the UE reports a value of M based on ul-FullPwrMode2-MaxSRS-ResInSet-r18 ENUMERATED {n1, n2}.

In one example, when ul-FullPwrMode2-MaxSRS-FourPortGroup-8Tx-r18=n2, two of the 4 port groups can achieve full power according to full power mode 2. In this case, the UE reports a value of M based on one of the following.
In one example, it is based on a pair (m₁, m₂), each based on ul-FullPwrMode2-MaxSRS-ResInSet-r18 ENUMERATED {n1, n2}. In one example, M=m₁+m₂. In one example, M=max(m₁,m₂). In one example, (m₁, m₂) belongs to one of the following {(1,1), (1,2), (2,1), (2,2)}.
In one example, it is based on a pair of common parameters, as shown below, where each parameter is associated with an antenna group.
The maximum number of SRS resources in one SRS resource set with usage set to ‘codebook’ for Mode 2
ul-FullPwrMode2-MaxSRS-ResInSet-Group1-r18 ENUMERATED {n1, n2} OPTIONAL
ul-FullPwrMode2-MaxSRS-ResInSet-Group2-r18 ENUMERATED {n1, n2} OPTIONAL

In one example, when ul-FullPwrMode2-MaxSRS-FourPortGroup-8Tx-r18=n3, three of the 4 port groups can achieve full power according to full power mode 2. In this case, the UE reports a value of M based on one of the following.
In one example, it is based on a pair (m₁, m₂, m₃), each based on ul-FullPwrMode2-MaxSRS-ResInSet-r18 ENUMERATED {n1, n2}. In one example, M=m₁+m₂+m₃. In one example, M=max(m₁, m₂, m₃). In one example, (m₁, m₂, m₃) belongs to one of the following
   {(1,1,1), (1,2,1), (2,1,1), (2,2,1), (1,1,2), (1,2,2), (2,1,2), (2,2,2)}1.
In one example, it is based on a triple of common parameters, as shown below, where each parameter is associated with an antenna group.
The maximum number of SRS resources in one SRS resource set with usage set to ‘codebook’ for Mode 2
ul-FullPwrMode2-MaxSRS-ResInSet-Group1-r18 ENUMERATED {n1, n2} OPTIONAL
ul-FullPwrMode2-MaxSRS-ResInSet-Group2-r18 ENUMERATED {n1, n2} OPTIONAL
ul-FullPwrMode2-MaxSRS-ResInSet-Group3-r18 ENUMERATED {n1, n2} OPTIONAL

In one example, when ul-FullPwrMode2-MaxSRS-PortGroup-8Tx-r18=n4, each of the 4 port groups can achieve full power according to full power mode 2. In this case, the UE reports a value of M based on one of the following.
In one example, it is based on ul-FullPwrMode2-MaxSRS-ResInSet-8Tx-r18 ENUMERATED {n1, n2, n4, n}, where n is according to one of the examples described herein.
In one example, it is based on a tuple (m₁, . . . , m₄), each based on ul-FullPwrMode2-MaxSRS-ResInSet-r18 ENUMERATED {n1, n2}. In one example, M=m₁+ . . . +m₄. In one example, M=max(m₁, . . . , m₄). In one example, (m₁, m₂, m₃, m₄) belongs to one of the following.
   {(1,1,1,1), (1,2,1,1), (2,1,1,1), (2,2,1,1)}.
   {(1,1,1,2), (1,2,1,2), (2,1,1,2), (2,2,1,2)}.
   {(1,1,2,1), (1,2,2,1), (2,1,2,1), (2,2,2,1)}.
   {(1,1,2,2), (1,2,2,2), (2,1,2,2), (2,2,2,2)}.
In one example, it is based on a tuple of common parameters, as shown below, where each parameter is associated with an antenna group.
The maximum number of SRS resources in one SRS resource set with usage set to ‘codebook’ for Mode 2

ul-FullPwrMode2-MaxSRS-ResInSet-Group1-r18 ENUMERATED {n1, n2} OPTIONAL
ul-FullPwrMode2-MaxSRS-ResInSet-Group2-r18 ENUMERATED {n1, n2} OPTIONAL
ul-FullPwrMode2-MaxSRS-ResInSet-Group3-r18 ENUMERATED {n1, n2} OPTIONAL
ul-FullPwrMode2-MaxSRS-ResInSet-Group4-r18 ENUMERATED {n1, n2} OPTIONAL

In one embodiment, when the UE reports a value of M (as explained herein), the UE can further report a SRS configuration for multiple SRS resources with different number of SRS ports in a SRS resource set, via UE capability reporting, either as a separate feature group (FG) or as a component of an FG comprising multiple components. An example is shown below, where the notation n1 implies a number ‘1’, n2 implies a number ‘2’, and so on.
Ports configuration for Mode 2
ul-FullPwrMode2-SRSConfig-diffNumSRSPorts-8Tx-r18 ENUMERATED {p1-2, p1-4, p1-2-4, N}OPTIONAL

In one example, N is empty or NULL, i.e., the UE can report only common values, i.e., {p1-2, p1-4, p1-2-4}.

In one example, N is non-empty, i.e., the UE can report a common value from {p1-2, p1-4, p1-2-4, or a new value (N).
In one example, N is one of {p1-8, p2-8, p4-8, p1-2-8, p1-4-8, p2-4-8, p1-2-4-8}.
In one example, N is one of values in a set S, which is a subset of {p1-8, p2-8, p4-8, p1-2-8, p1-4-8, p2-4-8, p1-2-4-8}.
   In one example, when the number of different ports=2, the set S={p1-8} or {p2-8}, or {p4-8}.
   In one example, when the number of different ports=3, the set S={p1-2-8} or {p1-4-8} or {p2-4-8}.
   In one example, when the number of different ports=4, the set S={p1-2-4-8}.
   In one example, when the number of different ports=2 or 3, the set S includes one of the following.
      p1-8, p1-2-8
      p1-8, p1-4-8
      p1-8, p2-4-8
      p2-8, p1-2-8
      p2-8, p1-4-8
      p2-8, p2-4-8
      p4-8, p1-2-8
      p4-8, p1-4-8
      p4-8, p2-4-8
   In one example, when the number of different ports=2 or 4, the set S includes one of the following.
      p1-8, p1-2-4-8
      p2-8, p1-2-4-8
      p4-8, p1-2-4-8
   In one example, when the number of different ports=3 or 4, the set S includes one of the following.
      p1-2-8, p1-2-4-8
      p1-4-8, p1-2-4-8
      p2-4-8, p1-2-4-8

In one example, when 8 SRS (antenna) ports are divided into N_{g}=2 SRS (antenna) port groups (e.g., each with 4 ports), the UE can report a maximum number of SRS (antenna) port groups, via UE capability reporting, either as a separate feature group (FG) or as a component of an FG comprising multiple components.
The maximum number of SRS (antenna) port groups in SRS resources in one SRS resource set with usage set to ‘codebook’ for Mode 2
ul-FullPwrMode2-MaxSRS-TwoPortGroup-8Tx-r18 ENUMERATED {n1, n2}
OPTIONAL,

In one example, when ul-FullPwrMode2-MaxSRS-TwoPortGroup-8Tx-r18=n1, one of the 2 port groups can achieve full power according to full power mode 2. In this case, the UE reports a SRS configuration for multiple SRS resources with different number of SRS ports in a SRS resource set based on ul-FullPwrMode2-SRSConfig-diffNumSRSPorts-r18 ENUMERATED {p1-2, p1-4, p1-2-4}.

In one example, when ul-FullPwrMode2-MaxSRS-TwoPortGroup-8Tx-r18=n2, each of the 2 port groups can achieve full power according to full power mode 2. In this case, the UE reports a SRS configuration for multiple SRS resources with different number of SRS ports in a SRS resource set based on one of the following.

In one example, it is based on a pair (m₁, m₂), each based on ul-FullPwrMode2-SRSConfig-diffNumSRSPorts-r18 ENUMERATED {p1-2, p1-4, p1-2-4}.

In one example, it is based on ul-FullPwrMode2-SRSConfig-diffNumSRSPorts-8Tx-r18 ENUMERATED {p1-2, p1-4, p1-2-4, N}, where N is according to one of the examples described herein.

In one example, it is based on a pair of common parameters, as shown below, where each parameter is associated with an antenna group.
Ports configuration for Mode 2
ul-FullPwrMode2-SRSConfig-diffNumSRSPorts-Group1-r18 ENUMERATED {p1-2, p1-4, p1-2-4} OPTIONAL
ul-FullPwrMode2-SRSConfig-diffNumSRSPorts-Group2-r18 ENUMERATED {p1-2, p1-4, p1-2-4} OPTIONAL

In one example, when 8 SRS (antenna) ports are divided into N_{g}=4 SRS (antenna) port groups (e.g., each with 2 ports), the UE can report a maximum number of SRS (antenna) port groups, via UE capability reporting, either as a separate feature group (FG) or as a component of an FG comprising multiple components.
The maximum number of SRS (antenna) port groups in SRS resources in one SRS resource set with usage set to ‘codebook’ for Mode 2
ul-FullPwrMode2-MaxSRS-FourPortGroup-8Tx-r18 ENUMERATED {n1, n2, n3, n4}OPTIONAL

In one example, when ul-FullPwrMode2-MaxSRS-FourPortGroup-8Tx-r18=n1, one of the 4 port groups can achieve full power according to full power mode 2. In this case, the UE reports a SRS configuration for multiple SRS resources with different number of SRS ports in a SRS resource set based on ul-FullPwrMode2-SRSConfig-diffNumSRSPorts-r18 ENUMERATED {p1-2}.

In one example, when ul-FullPwrMode2-MaxSRS-FourPortGroup-8Tx-r18=n2, two of the 4 port groups can achieve full power according to full power mode 2. In this case, the UE reports a SRS configuration for multiple SRS resources with different number of SRS ports in a SRS resource set based on one of the following.
In one example, it is based on a pair (m₁, m₂), each based on ul-FullPwrMode2-SRSConfig-diffNumSRSPorts-r18 ENUMERATED {p1-2}.
In one example, it is based on a pair of common parameters, as shown below, where each parameter is associated with an antenna group.
Ports configuration for Mode 2
ul-FullPwrMode2-SRSConfig-diffNumSRSPorts-Group1-r18 ENUMERATED {p1-2}
OPTIONAL
ul-FullPwrMode2-SRSConfig-diffNumSRSPorts-Group2-r18 ENUMERATED {p1-2}
OPTIONAL

In one example, when ul-FullPwrMode2-MaxSRS-FourPortGroup-8Tx-r18=n3, three of the 4 port groups can achieve full power according to full power mode 2. In this case, the UE reports a SRS configuration for multiple SRS resources with different number of SRS ports in a SRS resource set based on one of the following.
In one example, it is based on a pair (m₁, m₂, m₃), each based on ul-FullPwrMode2-SRSConfig-diffNumSRSPorts-r18 ENUMERATED {p1-2}.
In one example, it is based on a triple of common parameters, as shown below, where each parameter is associated with an antenna group.
Ports configuration for Mode 2
ul-FullPwrMode2-SRSConfig-diffNumSRSPorts-Group1-r18 ENUMERATED {p1-2}
OPTIONAL
ul-FullPwrMode2-SRSConfig-diffNumSRSPorts-Group2-r18 ENUMERATED {p1-2}
OPTIONAL
ul-FullPwrMode2-SRSConfig-diffNumSRSPorts-Group3-r18 ENUMERATED {p1-2}
OPTIONAL

In one example, when ul-FullPwrMode2-MaxSRS-PortGroup-8Tx-r18=n4, each of the 4 port groups can achieve full power according to full power mode 2. In this case, the UE reports a SRS configuration for multiple SRS resources with different number of SRS ports in a SRS resource set based on one of the following.
In one example, it is based on ul-FullPwrMode2-SRSConfig-diffNumSRSPorts-8Tx-r18 ENUMERATED {p1-2, p1-4, p1-2-4, N}, where N is according to one of the examples described herein.
In one example, it is based on a tuple (m₁, . . . , m₄), each based on ul-FullPwrMode2-SRSConfig-diffNumSRSPorts-r18 ENUMERATED {p1-2}.
In one example, it is based on a tuple of common parameters, as shown below, where each parameter is associated with an antenna group.
Ports configuration for Mode 2
ul-FullPwrMode2-SRSConfig-diffNumSRSPorts-Group1-r18 ENUMERATED {p1-2}
OPTIONAL
ul-FullPwrMode2-SRSConfig-diffNumSRSPorts-Group2-r18 ENUMERATED {p1-2}
OPTIONAL
ul-FullPwrMode2-SRSConfig-diffNumSRSPorts-Group3-r18 ENUMERATED {p1-2}
OPTIONAL
ul-FullPwrMode2-SRSConfig-diffNumSRSPorts-Group4-r18 ENUMERATED {p1-2}
OPTIONAL

In one embodiment, for codebook based transmission, the UE (e.g., UE 116) determines its codebook subsets based on TPMI(s) and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ or N_{g}=1 (8TXfullCoherent) or N_{g}=2 (8TXpartialCoherent1) or N_{g}=4 (8TXpartialCoherent2) or N_{g}=8 (8TXnonCoherent), depending on the UE capability.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=2’ or ‘8TXpartialCoherent1’, and when the SRS-resourceSet with usage set to “codebook” includes at least one SRS resource with 4 ports and one SRS resource with 2 ports, then at least one of the following is configured/supported (e.g. subject to UE capability reporting).
The codebookSubset associated with the 4-port SRS resource is ‘fullyAndPartialAndNonCoherent’ and the codebookSubset associated with the 2-port SRS resource is ‘nonCoherent’.
The codebookSubset associated with the 4-port SRS resource is ‘fullyAndPartialAndNonCoherent’ and the codebookSubset associated with the 2-port SRS resource is ‘fullyAndPartialAndNonCoherent’.
The codebookSubset associated with the 4-port SRS resource is ‘partialAndNonCoherent’ and the codebookSubset associated with the 2-port SRS resource is ‘nonCoherent’.
The codebookSubset associated with the 4-port SRS resource is ‘partialAndNonCoherent’ and the codebookSubset associated with the 2-port SRS resource is ‘fullyAndPartialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=2’ or ‘8TXpartialCoherent1’, and when the SRS-resourceSet with usage set to “codebook” includes at least one SRS resource with 8 ports and one SRS resource with 2 ports, then at least one of the following is configured/supported (e.g. subject to UE capability reporting).
The codebookSubset associated with the 2-port SRS resource is ‘nonCoherent’.
The codebookSubset associated with the 2-port SRS resource is ‘fullyAndPartialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=2’ or ‘8TXpartialCoherent1’, and when the SRS-resourceSet with usage set to “codebook” includes at least one SRS resource with 8 ports and one SRS resource with 4 ports, then at least one of the following is configured/supported.
The codebookSubset associated with the 4-port SRS resource is ‘fullyAndPartialAndNonCoherent’.
The codebookSubset associated with the 4-port SRS resource is ‘partialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=2’ or ‘8TXpartialCoherent1’, and when the SRS-resourceSet with usage set to “codebook” includes at least one SRS resource with 8 ports and one SRS resource with 4 ports and one SRS resource with 2 ports, then at least one of the following is configured/supported (e.g. subject to UE capability reporting).
The codebookSubset associated with the 4-port SRS resource is ‘fullyAndPartialAndNonCoherent’ and the codebookSubset associated with the 2-port SRS resource is ‘nonCoherent’.
The codebookSubset associated with the 4-port SRS resource is ‘fullyAndPartialAndNonCoherent’ and the codebookSubset associated with the 2-port SRS resource is ‘fullyAndPartialAndNonCoherent’.
The codebookSubset associated with the 4-port SRS resource is ‘partialAndNonCoherent’ and the codebookSubset associated with the 2-port SRS resource is ‘nonCoherent’.
The codebookSubset associated with the 4-port SRS resource is ‘partialAndNonCoherent’ and the codebookSubset associated with the 2-port SRS resource is ‘fullyAndPartialAndNonCoherent’.
The codebookSubset associated with the 4-port SRS resource is ‘nonCoherent’ and the codebookSubset associated with the 2-port SRS resource is ‘nonCoherent’.
The codebookSubset associated with the 4-port SRS resource is ‘nonCoherent’ and the codebookSubset associated with the 2-port SRS resource is ‘fullyAndPartialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=4’ or ‘8TXpartialCoherent1’, and when the SRS-resourceSet with usage set to “codebook” includes at least one SRS resource with 4 ports and one SRS resource with 2 ports, then at least one of the following is configured/supported (e.g. subject to UE capability reporting).
The codebookSubset associated with the 4-port SRS resource is ‘partialAndNonCoherent’ The codebookSubset associated with the 2-port SRS resource is ‘nonCoherent’.
The codebookSubset associated with the 4-port SRS resource is ‘partialAndNonCoherent’ and the codebookSubset associated with the 2-port SRS resource is ‘fullyAndPartialAndNonCoherent’.
The codebookSubset associated with the 4-port SRS resource is ‘nonCoherent’ and the codebookSubset associated with the 2-port SRS resource is ‘nonCoherent’.
The codebookSubset associated with the 4-port SRS resource is ‘nonCoherent’ and the codebookSubset associated with the 2-port SRS resource is ‘fullyAndPartialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=4’ or ‘8TXpartialCoherent1’, and when the SRS-resourceSet with usage set to “codebook” includes at least one SRS resource with 8 ports and one SRS resource with 2 ports, then at least one of the following is configured/supported (e.g. subject to UE capability reporting).
The codebookSubset associated with the 2-port SRS resource is ‘nonCoherent’.
The codebookSubset associated with the 2-port SRS resource is ‘fullyAndPartialAndNonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=4’ or ‘8TXpartialCoherent1’, and when the SRS-resourceSet with usage set to “codebook” includes at least one SRS resource with 8 ports and one SRS resource with 4 ports, then at least one of the following is configured/supported.
The codebookSubset associated with the 4-port SRS resource is ‘partialAndNonCoherent’.
The codebookSubset associated with the 4-port SRS resource is ‘nonCoherent’.

When higher layer parameter ul-FullPowerTransmission8Tx-r18 is set to ‘fullpowerMode2’ and the higher layer parameter codebookSubset or the higher layer parameter codebookSubsetDCI-0-2 is set to ‘N_{g}=4’ or ‘8TXpartialCoherent1’, and when the SRS-resourceSet with usage set to “codebook” includes at least one SRS resource with 8 ports and one SRS resource with 4 ports and one SRS resource with 2 ports, then at least one of the following is configured/supported (e.g. subject to UE capability reporting).
The codebookSubset associated with the 4-port SRS resource is ‘partialAndNonCoherent’ and the codebookSubset associated with the 2-port SRS resource is ‘nonCoherent’.
The codebookSubset associated with the 4-port SRS resource is ‘partialAndNonCoherent’ and the codebookSubset associated with the 2-port SRS resource is ‘fullyAndPartialAndNonCoherent’.
The codebookSubset associated with the 4-port SRS resource is ‘nonCoherent’ and the codebookSubset associated with the 2-port SRS resource is ‘nonCoherent’.
The codebookSubset associated with the 4-port SRS resource is ‘nonCoherent’ and the codebookSubset associated with the 2-port SRS resource is ‘fullyAndPartialAndNonCoherent’.

A UE reporting its UE capability of N_{g}=2 (8TXpartialCoherent1) transmission shall not expect to be configured by either codebookSubset or codebookSubsetDCI-0-2 with N_{g}=1 (8TXfullCoherent).

A UE reporting its UE capability of N_{g}=4 (8TXpartialCoherent2) transmission shall not expect to be configured by either codebookSubset or codebookSubsetDCI-0-2 with N_{g}=1 (8TXfullCoherent) or with N_{g}=2 (8TXpartialCoherent1).

A UE reporting its UE capability of N_{g}=8 (8TXnonCoherent) transmission shall not expect to be configured by either codebookSubset or codebookSubsetDCI-0-2 with N_{g}=1 (8TXfullCoherent) or with N_{g}=2 (8TXpartialCoherent1) or with N_{g}=4 (8TXpartialCoherent2).

For codebook-based transmission, only one SRS resource can be indicated based on the SRI from within the SRS resource set. Except when higher layer parameter ul-FullPowerTransmission ul-FullPowerTransmission8Tx-r18 is set to ‘fullpowerMode2’, the maximum number of configured SRS resources for codebook-based transmission is 2. If aperiodic SRS is configured for a UE, the SRS request field in DCI triggers the transmission of aperiodic SRS resources.

A UE shall not expect to be configured with higher layer parameter ul-FullPowerTransmission or ul-FullPowerTransmission8Tx-r18 set to ‘fullpowerMode1’ and codebookSubset or codebookSubsetDCI-0-2 set to ‘fullAndPartialAndNonCoherent’ or N_{g}=1 (8TXfullCoherent) simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The DM-RS antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission or ul-FullPowerTransmission8Tx-r18 is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for these SRS resources.

When higher layer parameter ul-FullPowerTransmission or ul-FullPowerTransmission8Tx-r18 is set to ‘fullpowerMode2’:
The UE can be configured with one SRS resource or multiple SRS resources with same or different number of SRS ports within an SRS resource set with usage set to ‘codebook’.
Except for 8-port SRS resource, up to 2 different (Ex: 3 or 4 for 8Tx, or up to Ng value) spatial relations can be configured for SRS resources in the SRS resource set with usage set to ‘codebook’ when multiple SRS resources are configured in the SRS resource set.
For 8-port SRS resource, up to X different spatial relations can be configured for SRS resources in the SRS resource set with usage set to ‘codebook’ when multiple SRS resources are configured in the SRS resource set, where X is fixed (e.g., 2 or 3 or 4) or up to Ng value or reported by the UE (e.g., via UE capability reporting).
Except for 8-port SRS resource, subject to UE capability, a maximum of 2 or 4 SRS resources are supported in an SRS resource set with usage set to ‘codebook’.
For 8-port SRS resource, subject to UE capability, a maximum of Y SRS resources are supported in an SRS resource set with usage set to ‘codebook’, where Y is one or multiple of {2, 4, 6, 8}.

TABLE 50

| Ng | Rank r = 1 | Rank r = 2, 3 | Rank r = 4, 5, 6, 7 | Rank r = 8 |
|---|---|---|---|---|
| 1 | Full power (FP): power = 1 | FP: power = 1 | FP: power = 1 | FP: power = 1 |
| 2 | Non full power (NFP): power = 1/2 | FP: power = 1 | FP: power = 1 | FP: power = 1 |
| 4 | NFP: power = ¼ | NFP: power = ½, ¾ | FP: power = 1 | FP: power = 1 |
| 8 | NFP: power = ⅛ | NFP: power = ¼, ⅜ | NFP: power = r/8 | FP power = 1 |

Let

$$x = \frac{8}{{N}_{g}}$$

be the number of antenna ports in each antenna group. Let P be the power or a fraction of the number of non-zero (NZ) antenna ports or number of non-zero rows in the precoder. When each antenna group is fully coherent (FC), i.e., precoder for an antenna group is FC, then:
For N_{g}=8, the power

$$P = min ( 1 , x \frac{r}{{N}_{g}} ) = \frac{r}{8} ,$$

for r=1, . . . , 7.
For N_{g}=4, the power

$$P = min ( 1 , x \frac{r}{{N}_{9}} ) = min ( 1 , \frac{r}{4} ) ,$$

where r=1, 2, 3, i.e., number of non-zero (NZ) antenna ports or number of non-zero rows in the precoder.
For N_{g}=2, the power

$$P = min ( 1 , x \frac{r}{{N}_{g}} ) = min ( 1 , \frac{r}{2} ) ,$$

where r=1, 2, 3, i.e., number of non-zero (NZ) antenna ports or number of non-zero rows in the precoder.

A summary of FP or NFP precoders for different rank r and N_{g} values are shown in Table 50.

A UE with 8 antenna ports can be configured with higher layer parameter ul-FullPowerTransmission or ul-FullPowerTransmission8Tx-r18 set to ‘fullpowerMode1’ and a value of N_{g} from {2,4,8}. The UL codebook for 8 antenna ports for full power mode 1 is according to at least one of the following embodiments.

In one embodiment, the UL codebook for 8 antenna ports for full power mode 1 includes Zᵣ full power precoders/precoding matrices for each rank value r that is NFP (as described herein).
In one example, Zᵣ>1 for N_{g}=2,4 and Zᵣ>1 for N_{g}=8.
In one example, Zᵣ>1 for N_{g}=2 and Zᵣ>1 for N_{g}=4,8.
In one example, Zᵣ>1 for N_{g}=2,4,8.
In one example, Zᵣ=1 for N_{g}=2,4,8.

When Zᵣ>1, then Zᵣ can be fixed, e.g., 2 or 4 or 8 or configured (RRC). Or Zᵣ for N_{g}=x∈{2,4,8} is equal to the number of FP precoders for rank r and N_{g}=x−1 or N_{g}=1.

In one embodiment, the UL codebook for 8 antenna ports for full power mode 1 includes Zᵣ>1 full power precoders/precoding matrices for rank value r≤t that is NFP (as described herein), and Zᵣ=1 full power precoders/precoding matrices for rank value r>t that is NFP (as described herein). In one example, t is fixed to 2 or 4 or 1 or

$$\frac{{N}_{g}}{2} .$$

For a given rank r, Zᵣ is according to one of the examples described herein.

In one embodiment, the UL codebook for 8 antenna ports for full power mode 1 is supported for a subset of rank values that are NFP when N_{g}=4,8 or N_{g}=8.
In one example, the subset value corresponds to r≤s, In one example, s is fixed to 2 or 3 or 4 or 1 or

$$\frac{{N}_{g}}{2} .$$

For a given rank r, Zᵣ is according to one or more examples herein.
In one example, the subset value r∈{1,2} or r∈{1,2,3} or r∈{1,2,4} or r∈{1,2,4,6}.

In one embodiment, the UL codebook for 8 antenna ports for full power mode 1 is according to at least one of the following examples.
In one example, Zᵣ full power precoders/precoding matrices for each rank value r (as described herein) are additional precoders that are added to the codebooks for Ng=2, 4, 8 when full power mode 1 is not configured. In this case, the TPMI payload (number of bits) can increase by at least 1 bit when compared with when full power mode 1 is not configured.
In one example, Zᵣ full power precoders/precoding matrices for each rank value r (as described herein) replace the same number of precoders from the codebooks for Ng=2, 4, 8, when full power mode 1 is not configured.
In one example, for a given rank r, Zᵣ full power precoders/precoding matrices are added when the TPMI payload (number of bits) does not increase, and replace the same number of precoders when the TPMI payload (number of bits) can increase if they were added (without replacement).

The notation Iᵢ^{(N}^{_{g}}^{,r)} is used to denote an index i of a rank r precoder or precoding matrix for a given N_{g} value.

In one embodiment, for an 8TX UE with Ng=2, when configured for full power transmission with ‘fullpowerMode1’, at least one of following precoders shown in Table 51 is included (or they replace the same number of precoders, as described herein) in the 8Tx UL codebooks for NFP rank values.
In one example, the codebook includes one rank 1 precoder. An example of rank 1 precoder is I₀^{(2,1)} in Table 51. In one example, the rank 1 (single-layer) codebook is as shown in Table 52 and Table 53.

TABLE 51

| Index | Precoding matrix |
|---|---|
| I₀^{(2,1)} | $\frac{1}{2 \sqrt{2}} [ \begin{matrix}1 \\ 1 \\ 1 \\ 1 \\ 1 \\ 1 \\ 1 \\ 1\end{matrix} ]$ |
| I₁^{(2,1)} | $\frac{1}{2 \sqrt{2}} [ \begin{matrix}1 \\ j \\ - 1 \\ - j \\ j \\ - 1 \\ - j \\ 1\end{matrix} ]$ |
| I₂^{(2,1)} | $\frac{1}{2 \sqrt{2}} [ \begin{matrix}1 \\ - 1 \\ 1 \\ - 1 \\ 1 \\ - 1 \\ 1 \\ - 1\end{matrix} ]$ |

TABLE 52
Intermediate precoding matrix W′ for N_{g} = 2 and single-
layer transmission

| TPMI index i | Intermediate precoder matrix W′ |
|---|---|
| 0-15 | $\frac{1}{\sqrt{2}} [ \begin{matrix}{\overline{W}}_{1 , i} \\ {0}_{4 \times 1}\end{matrix} ]$ |
| 16-31 | $\frac{1}{\sqrt{2}} [ \begin{matrix}{0}_{4 \times 1} \\ {\overline{W}}_{1 , ( i - 16 )}\end{matrix} ]$ |
| 32 | $( {I}_{0}^{( 2 , 1 )} in Table 51 ) : \frac{1}{2 \sqrt{2}} [ \begin{matrix}1 \\ 1 \\ 1 \\ 1 \\ 1 \\ 1 \\ 1 \\ 1\end{matrix} ]$ |

TABLE 53
Submatrices W̅_{4,i} for N_{g} = 2

| i | W̅_{4,i} | |
|---|---|---|
| | (ordered from left to right in increasing order of i) | |
| 0-1 | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

In one example, the full power codebook for Ng=2 includes one of the following:
16 precoders: TPMI indices {0-15} for Ng=1 and (N1, N2)=(4, 1)
8 precoders: TPMI indices {0-7} for Ng=1 and (N1, N2)=(2, 2)
16 precoders: TPMI indices {0-15} for Ng=1 and (N1, N2)=(4, 1) and 8 precoders: TPMI indices {0-7} for Ng=1 and (N1, N2)=(2, 2)

In one embodiment, for an 8TX UE with Ng=4, when configured for full power transmission with ‘fullpowerMode1’, for NFP rank r, at least one of following precoders shown in Table 54—Table is included (or they replace the same number of precoders, as described herein) in the 8Tx UL codebooks for NFP rank values.
In one example, the codebook includes one rank 1 precoder. An example of rank 1 precoder is I₀^{(4,1)} in Table 54. In one example, the rank 1 (single-layer) codebook is as shown in Table 57 and Table 58.
In one example, the codebook includes one rank 2 precoder. An example of rank 2 precoder is I₀^{(4,2)} or I₁^{(4,2)} in Table 55. Note that when I₀^{(4,2)}=W and W′=I₁^{(4,2)} then W_{f(j)}=Wⱼ′, whereas described herein, the subscripts j and f(j) denote the row of the respective matrix. In one example, the rank 2 (two-layer) codebook is as shown in Table 57 and Table 59.
In one example, for rank 3, the codebook includes one rank 3 precoding matrix with a first layer based on an 8Tx PC rank 1 precoder for Ng=2 (corresponding to Group comprising ports 1,2,5,6), a second layer based on an 8Tx PC rank 1 precoder for Ng=4 (corresponding to Group 3 comprising ports 3 and 7), and a third layer based on an 8Tx PC rank 1 precoder for Ng=4 (corresponding to Group 4 comprising ports 3 and 7). An example of rank 3 precoding matrix is I₂^{(4,3)} or I₃^{(4,3)} in Table 56. Note that when I₃^{(4,3)}=W and W′=I₂^{(4,3)} then W_{f(j)}=Wⱼ′, whereas described herein, the subscripts j and f(j) denote the row of the respective matrix. In one example, the rank 3 (three-layer) codebook is as shown in Table 57 and Table 60.

TABLE 54
r = 1

| | Precoding |
|---|---|
| Index | matrix |
| I₀^{(4,1)} | $\frac{1}{2 \sqrt{2}} [ \begin{matrix}1 \\ 1 \\ 1 \\ 1 \\ 1 \\ 1 \\ 1 \\ 1\end{matrix} ]$ |
| I₁^{(4,1)} | $\frac{1}{2 \sqrt{2}} [ \begin{matrix}1 \\ j \\ - 1 \\ - j \\ j \\ - 1 \\ - j \\ 1\end{matrix} ]$ |

TABLE 55
rank r = 2

| | Precoding |
|---|---|
| Index | matrix |
| I₀^{(4,2)} | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| I₁^{(4,2)} | $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |

TABLE 56
rank r = 3

| | Precoding |
|---|---|
| Index | matrix |
| I₀^{(4,3)} | $\frac{1}{2 \sqrt{2}} [ \begin{matrix}1 & 0 & 0 \\ 1 & 0 & 0 \\ 0 & 1 & 0 \\ 0 & 1 & 0 \\ 1 & 0 & 0 \\ 0 & 0 & 1 \\ 0 & 1 & 0 \\ 0 & 0 & 1\end{matrix} ]$ |
| I₁^{(4,3)} | $\frac{1}{2 \sqrt{2}} [ \begin{matrix}1 & 0 & 0 \\ 0 & 0 & 1 \\ 0 & 1 & 0 \\ 1 & 0 & 0 \\ 1 & 0 & 0 \\ 0 & 0 & 1 \\ 0 & 1 & 0 \\ 1 & 0 & 0\end{matrix} ]$ |
| I₂^{(4,3)} | $\frac{1}{2 \sqrt{2}} [ \begin{matrix}1 & 0 & 0 \\ 1 & 0 & 0 \\ 0 & 1 & 0 \\ 1 & 0 & 1 \\ 1 & 0 & 0 \\ 0 & 0 & 0 \\ 0 & 1 & 0 \\ 0 & 0 & 1\end{matrix} ]$ |
| I₃^{(4,3)} | $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

TABLE 57
Submatrices W̅_{2,i} for N_{g} = 4

| | W̅_{2,i} | |
|---|---|---|
| i | (ordered from left to right in increasing order of i) | |
| 0-1 | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 58
Intermediate precoding matrix W′ for N_{g} = 4 and single-
layer transmission

| TPMI index i | Intermediate precoder matrix W′ |
|---|---|
| 0-3 | $\frac{1}{2} [ \begin{matrix}{\overline{W}}_{1 , i} \\ {0}_{2 \times 1} \\ {0}_{2 \times 1} \\ {0}_{2 \times 1}\end{matrix} ]$ |
| 4-7 | $\frac{1}{2} [ \begin{matrix}{0}_{2 \times 1} \\ {\overline{W}}_{1 , ( i - 4 )} \\ {0}_{2 \times 1} \\ {0}_{2 \times 1}\end{matrix} ]$ |
| 8-11 | $\frac{1}{2} [ \begin{matrix}{0}_{2 \times 1} \\ {0}_{2 \times 1} \\ {\overline{W}}_{1 , ( i - 8 )} \\ {0}_{2 \times 1}\end{matrix} ]$ |
| 12-15 | $\frac{1}{2} [ \begin{matrix}{0}_{2 \times 1} \\ {0}_{2 \times 1} \\ {0}_{2 \times 1} \\ {\overline{W}}_{1 , ( i - 12 )}\end{matrix} ]$ |
| 16 | $( {I}_{0}^{( 4 , 1 )} in Table ) : \frac{1}{2 \sqrt{2}} [ \begin{matrix}1 \\ 1 \\ 1 \\ 1 \\ 1 \\ 1 \\ 1 \\ 1\end{matrix} ]$ |

TABLE 59
Intermediate precoding matrix W′ for N_{g} = 4 and two-
layer transmission

| TPMI index i | Intermediate precoder matrix W′ |
|---|---|
| 0-1 | $\frac{1}{2} [ \begin{matrix}{\overline{W}}_{2 , i} \\ {0}_{2 \times 2} \\ {0}_{2 \times 2} \\ {0}_{2 \times 2}\end{matrix} ]$ |
| 2-3 | $\frac{1}{2} [ \begin{matrix}{0}_{2 \times 2} \\ {\overline{W}}_{2 , ( i - 2 )} \\ {0}_{2 \times 2} \\ {0}_{2 \times 2}\end{matrix} ]$ |
| 4-5 | $\frac{1}{2} [ \begin{matrix}{0}_{2 \times 2} \\ {0}_{2 \times 2} \\ {\overline{W}}_{2 , ( i - 4 )} \\ {0}_{2 \times 2}\end{matrix} ]$ |
| 6-7 | $\frac{1}{2} [ \begin{matrix}{0}_{2 \times 2} \\ {0}_{2 \times 2} \\ {0}_{2 \times 2} \\ {\overline{W}}_{2 , ( i - 6 )}\end{matrix} ]$ |
| 8-23 | $\frac{1}{2} [ \begin{matrix}{\overline{W}}_{1 , ⌊ ( i - 8 ) / 4 ⌋} & {0}_{2 \times 1} \\ {0}_{2 \times 1} & {\overline{W}}_{1 , ( i mod 4 )} \\ {0}_{2 \times 1} & {0}_{2 \times 1} \\ {0}_{2 \times 1} & {0}_{2 \times 1}\end{matrix} ]$ |
| 24-39 | $\frac{1}{2} [ \begin{matrix}{\overline{W}}_{1 , ⌊ ( i - 24 ) / 4 ⌋} & {0}_{2 \times 1} \\ {0}_{2 \times 1} & {0}_{2 \times 1} \\ {0}_{2 \times 1} & {\overline{W}}_{1 , ( i mod 4 )} \\ {0}_{2 \times 1} & {0}_{2 \times 1}\end{matrix} ]$ |
| 40-55 | $\frac{1}{2} [ \begin{matrix}{\overline{W}}_{1 , ⌊ ( i - 40 ) / 4 ⌋} & {0}_{2 \times 1} \\ {0}_{2 \times 1} & {0}_{2 \times 1} \\ {0}_{2 \times 1} & {0}_{2 \times 1} \\ {0}_{2 \times 1} & {\overline{W}}_{1 , ( i mod 4 )}\end{matrix} ]$ |
| 56-71 | $\frac{1}{2} [ \begin{matrix}{0}_{2 \times 1} & {0}_{2 \times 1} \\ {\overline{W}}_{1 , ⌊ ( i - 56 ) / 4 ⌋} & {0}_{2 \times 1} \\ {0}_{2 \times 1} & {\overline{W}}_{1 , ( i mod 4 )} \\ {0}_{2 \times 1} & {0}_{2 \times 1}\end{matrix} ]$ |
| 72-87 | $\frac{1}{2} [ \begin{matrix}{0}_{2 \times 1} & {0}_{2 \times 1} \\ {\overline{W}}_{1 , ⌊ ( i - 72 ) / 4 ⌋} & {0}_{2 \times 1} \\ {0}_{2 \times 1} & {0}_{2 \times 1} \\ {0}_{2 \times 1} & {\overline{W}}_{1 , ( i mod 4 )}\end{matrix} ]$ |
| 88-103 | $\frac{1}{2} [ \begin{matrix}{0}_{2 \times 1} & {0}_{2 \times 1} \\ {0}_{2 \times 1} & {0}_{2 \times 1} \\ {\overline{W}}_{1 , ⌊ ( i - 88 ) / 4 ⌋} & {0}_{2 \times 1} \\ {0}_{2 \times 1} & {\overline{W}}_{1 , ( i mod 4 )}\end{matrix} ]$ |
| 104 | $( {I}_{1}^{( 4 , 2 )} in Table ) : \frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |

TABLE 60
Intermediate precoding matrix W′ for N_{g} = 4 and
three-layer transmission

| TPMI index i | Intermediate precoder matrix W′ |
|---|---|
| 0-7 | $\frac{1}{2} [ \begin{matrix}{\overline{W}}_{2 , ⌊ i / 4 ⌋} & {0}_{2 \times 1} \\ {0}_{2 \times 2} & {\overline{W}}_{1 , ( i mod 4 )} \\ {0}_{2 \times 2} & {0}_{2 \times 1} \\ {0}_{2 \times 2} & {0}_{2 \times 1}\end{matrix} ]$ |
| 8-15 | $\frac{1}{2} [ \begin{matrix}{\overline{W}}_{2 , ⌊ ( i - 8 ) / 4 ⌋} & {0}_{2 \times 1} \\ {0}_{2 \times 2} & {0}_{2 \times 1} \\ {0}_{2 \times 2} & {\overline{W}}_{1 , ( i mod 4 )} \\ {0}_{2 \times 2} & {0}_{2 \times 1}\end{matrix} ]$ |
| 16-23 | $\frac{1}{2} [ \begin{matrix}{\overline{W}}_{2 , ⌊ ( i - 16 ) / 4 ⌋} & {0}_{2 \times 1} \\ {0}_{2 \times 2} & {0}_{2 \times 1} \\ {0}_{2 \times 2} & {0}_{2 \times 1} \\ {0}_{2 \times 2} & {\overline{W}}_{1 , ( i mod 4 )}\end{matrix} ]$ |
| 24-31 | $\frac{1}{2} [ \begin{matrix}{0}_{2 \times 2} & {0}_{2 \times 1} \\ {\overline{W}}_{2 , ⌊ ( i - 24 ) / 4 ⌋} & {0}_{2 \times 1} \\ {0}_{2 \times 2} & {\overline{W}}_{1 , ( i mod 4 )} \\ {0}_{2 \times 2} & {0}_{2 \times 1}\end{matrix} ]$ |
| 32-39 | $\frac{1}{2} [ \begin{matrix}{0}_{2 \times 2} & {0}_{2 \times 1} \\ {\overline{W}}_{2 , ⌊ ( i - 32 ) / 4 ⌋} & {0}_{2 \times 1} \\ {0}_{2 \times 2} & {0}_{2 \times 1} \\ {0}_{2 \times 2} & {\overline{W}}_{1 , ( i mod 4 )}\end{matrix} ]$ |
| 40-47 | $\frac{1}{2} [ \begin{matrix}{0}_{2 \times 2} & {0}_{2 \times 1} \\ {0}_{2 \times 2} & {0}_{2 \times 1} \\ {\overline{W}}_{2 , ⌊ ( i - 40 ) / 4 ⌋} & {0}_{2 \times 1} \\ {0}_{2 \times 2} & {\overline{W}}_{1 , ( i mod 4 )}\end{matrix} ]$ |
| 48-111 | $\frac{1}{2} [ \begin{matrix}{\overline{W}}_{1 , ⌊ ( i - 48 ) / 16 ⌋} & {0}_{2 \times 1} & {0}_{2 \times 1} \\ {0}_{2 \times 1} & {\overline{W}}_{1 , ⌊ ( i mod 16 ) / 4 ⌋} & {0}_{2 \times 1} \\ {0}_{2 \times 1} & {0}_{2 \times 1} & {\overline{W}}_{1 , ( i mod 4 )} \\ {0}_{2 \times 1} & {0}_{2 \times 1} & {0}_{2 \times 1}\end{matrix} ]$ |
| 112-175 | $\frac{1}{2} [ \begin{matrix}{\overline{W}}_{1 , ⌊ ( i - 112 ) / 16 ⌋} & {0}_{2 \times 1} & {0}_{2 \times 1} \\ {0}_{2 \times 1} & {\overline{W}}_{1 , ⌊ ( i mod 16 ) / 4 ⌋} & {0}_{2 \times 1} \\ {0}_{2 \times 1} & {0}_{2 \times 1} & {0}_{2 \times 1} \\ {0}_{2 \times 1} & {0}_{2 \times 1} & {\overline{W}}_{1 , ( i mod 4 )}\end{matrix} ]$ |
| 176-239 | $\frac{1}{2} [ \begin{matrix}{\overline{W}}_{1 , ⌊ ( i - 176 ) / 16 ⌋} & {0}_{2 \times 1} & {0}_{2 \times 1} \\ {0}_{2 \times 1} & {0}_{2 \times 1} & {0}_{2 \times 1} \\ {0}_{2 \times 1} & {\overline{W}}_{1 , ⌊ ( i mod 16 ) / 4 ⌋} & {0}_{2 \times 1} \\ {0}_{2 \times 1} & {0}_{2 \times 1} & {\overline{W}}_{1 , ( i mod 4 )}\end{matrix} ]$ |
| 240-303 | $\frac{1}{2} [ \begin{matrix}{0}_{2 \times 1} & {0}_{2 \times 1} & {0}_{2 \times 1} \\ {\overline{W}}_{1 , ⌊ ( i - 240 ) / 16 ⌋} & {0}_{2 \times 1} & {0}_{2 \times 1} \\ {0}_{2 \times 1} & {\overline{W}}_{1 , ⌊ ( i mod 16 ) / 4 ⌋} & {0}_{2 \times 1} \\ {0}_{2 \times 1} & {0}_{2 \times 1} & {\overline{W}}_{1 , ( i mod 4 )}\end{matrix} ]$ |
| 304 | $( {I}_{3}^{( 4 , 3 )} in Table ) : \frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

In one example, the full power codebook for Ng=4 includes one of the following:
Rank 1: 4 precoders, TPMI indices {0-3} for rank 1 Ng=1 and (N1, N2)=(4, 1) or (2,2)
Rank 2: 2 precoders, TPMI indices {0-1} for rank 2 Ng=1 and (N1, N2)=(4, 1) or (2,2)
Rank 3: 2 precoders, TPMI indices {0-1} for rank 3 Ng=1 and (N1, N2)=(4, 1) or (2,2)

In one embodiment, for an 8TX UE with Ng=8, when configured for full power transmission with ‘fullpowerMode1’, for NFP rank r, at least one of following precoders shown in Table 61-Table 68 is included (or they replace the same number of precoders, as described herein) in the 8Tx UL codebooks for NFP rank values.

In one example, when N_{g}=8, the full power mode 1 for rank r=4, 5, 6, 7 is not supported, i.e., the full power mode 1 is supported for rank r=1, 2,3. Hence, the UE (e.g., UE 116) can be configured with 8Tx codebook for full power mode 1 only for rank 1,2,3, and 8Tx NFP codebook or 8Tx codebook without any FP precoding matrix for rank 4,5,6,7.

### Rank 1:

In one example, at least one 8Tx FC precoder is included.
In one example, for rank 1, the codebook includes one rank 1 precoding matrix. An example of rank 1 precoding matrix is I₀^{(8,1)} in Table 61.

TABLE 61
rank r = 1

| | Precoding |
|---|---|
| Index | matrix |
| I₀^{(8,1)} | $\frac{1}{2 \sqrt{2}} [ \begin{matrix}1 \\ 1 \\ 1 \\ 1 \\ 1 \\ 1 \\ 1 \\ 1\end{matrix} ]$ |

### Rank 2:

In one example, at least one 8Tx PC precoder with Ng=2 is included.
In one example, at least one 8Tx FC precoder (Ng=1) is included.
In one example, at least one 8Tx PC precoder with Ng=2 and at least one 8Tx FC precoder is included.
In one example, for rank 2, the codebook includes one rank 2 precoding matrix. An example of rank 2 precoding matrix is I₀^{(8,2)} in Table 62.

TABLE 62
rank r = 2

| | Precoding |
|---|---|
| Index | matrix |
| I₀^{(8,2)} | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| I₁^{(8,2)} | $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |

### Rank 3:

In one example, at least one 8Tx PC precoder with Ng=2 is included.
In one example, at least one 8Tx FC precoder (Ng=1) is included.
In one example, at least one 8Tx PC precoder with Ng=2 and at least one 8Tx FC precoder is included.
In one example, the codebook includes one rank 3 precoding matrix with a first layer based on an 8Tx PC rank 1 precoder for Ng=2 (corresponding to Group comprising ports 1,2,5,6), a second layer based on an 8Tx PC rank 1 precoder for Ng=4 (corresponding to Group 3 comprising ports 3 and 7), and a third layer based on an 8Tx PC rank 1 precoder for Ng=4 (corresponding to Group 4 comprising ports 3 and 7). An example of rank 3 precoding matrix is I₃^{(8,3)} in Table 63.

TABLE 63
rank r = 3

| | Precoding |
|---|---|
| Index | matrix |
| I₀^{(8,3)} | $\frac{1}{2 \sqrt{2}} [ \begin{matrix}1 & 0 & 0 \\ 1 & 0 & 0 \\ 0 & 1 & 0 \\ 0 & 1 & 0 \\ 1 & 0 & 0 \\ 0 & 0 & 1 \\ 0 & 1 & 0 \\ 0 & 0 & 1\end{matrix} ]$ |
| I₁^{(8,3)} | $\frac{1}{2 \sqrt{2}} [ \begin{matrix}1 & 0 & 0 \\ 1 & 0 & 0 \\ 0 & 1 & 1 \\ 0 & 1 & 1 \\ 1 & 0 & 0 \\ 1 & 0 & 0 \\ 0 & 1 & - 1 \\ 0 & 1 & - 1\end{matrix} ]$ |
| I₂^{(8,3)} | $\frac{1}{2 \sqrt{2}} [ \begin{matrix}1 & 0 & 0 \\ 0 & 1 & 0 \\ 0 & 0 & 1 \\ 0 & 1 & 0 \\ 1 & 0 & 0 \\ 0 & 1 & 0 \\ 0 & 0 & 1 \\ 0 & 0 & 1\end{matrix} ]$ |
| I₃^{(8,3)} | $\frac{1}{2 \sqrt{2}} [ \begin{matrix}1 & 0 & 0 \\ 1 & 0 & 0 \\ 0 & 1 & 0 \\ 1 & 0 & 1 \\ 1 & 0 & 0 \\ 0 & 0 & 0 \\ 0 & 1 & 0 \\ 0 & 0 & 1\end{matrix} ]$ |
| I₄^{(8,3)} | $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

In one example, the up to rank 8 (eight-layer) codebook with the three FC precoders for rank 1,2,3 is as shown in Table 64.

TABLE 64
Precoding matrix W for N_{g} = 8 and up to eight layers

| TPMI index | W |
|---|---|
| 0-254 | $W = \frac{1}{2 \sqrt{2}} [ {e}_{{p}_{0}} ... {e}_{{p}_{v - 1}} ]$ |
| | where column i of W, denoted eᵢ, has an element 1 on |
| | the row corresponding to the port pᵢ on which layer i is |
| | to be transmitted, and element 0 in other rows, pᵢ < pᵢ₊₁ |
| 255 | $( {I}_{0}^{( 8 , 1 )} in Table 61 ) : \frac{1}{2 \sqrt{2}} [ \begin{matrix}1 \\ 1 \\ 1 \\ 1 \\ 1 \\ 1 \\ 1 \\ 1\end{matrix} ]$ |
| 256 | $( {I}_{0}^{( 8 , 2 )} in Table 62 ) : \frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| 257 | $( {I}_{0}^{( 8 , 3 )} in Table 63 ) : \frac{1}{2 \sqrt{2}} [ \begin{matrix}1 & 0 & 0 \\ 1 & 0 & 0 \\ 0 & 1 & 0 \\ 0 & 0 & 1 \\ 1 & 0 & 0 \\ 1 & 0 & 0 \\ 0 & 1 & 0 \\ 0 & 0 & 1\end{matrix} ]$ |

### Rank 4.

In one example, FC 8Tx FC/PC precoder is not included.
In one example, at least one 8Tx PC precoder with Ng=2 or 4 is included.
In one example, at least one 8Tx PC precoder with Ng=4 is included.
In one example, at least one 8Tx FC precoder (Ng=1) is included.
In one example, at least one 8Tx PC precoder with Ng=2 and at least one 8Tx PC precoder (Ng=4) is included.

TABLE 65
rank r = 4

| | Precoding |
|---|---|
| Index | matrix |
| | $\frac{1}{2 \sqrt{2}} [ \begin{matrix}1 & 0 & 0 & 0 \\ 1 & 0 & 0 & 0 \\ 0 & 1 & 0 & 0 \\ 0 & 1 & 0 & 0 \\ 0 & 0 & 1 & 0 \\ 0 & 0 & 1 & 0 \\ 0 & 0 & 0 & 1 \\ 0 & 0 & 0 & 1\end{matrix} ]$ |
| | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 1 & 0 & 0 & 0 \\ 0 & 1 & 0 & 0 \\ 0 & 0 & 1 & 0 \\ 0 & 0 & 0 & 1\end{matrix} ]$ |

### Rank 5:

In one example, FC 8Tx FC/PC precoder is not included.
In one example, at least one 8Tx PC precoder with Ng=2 or 4 is included.
In one example, at least one 8Tx PC precoder with Ng=4 is included.
In one example, at least one 8Tx FC precoder (Ng=1) is included.
In one example, at least one 8Tx PC precoder with Ng=2 and at least one 8Tx PC precoder (Ng=4) is included.

TABLE 66
rank r = 5

| Index | Precoding matrix |
|---|---|
| | $\frac{1}{2 \sqrt{2}} [ \begin{matrix}1 & 0 & 0 & 0 & 0 \\ 1 & 0 & 0 & 0 & 0 \\ 0 & 1 & 0 & 0 & 0 \\ 0 & 1 & 0 & 0 & 0 \\ 0 & 0 & 1 & 0 & 0 \\ 0 & 0 & 1 & 0 & 0 \\ 0 & 0 & 0 & 1 & 0 \\ 0 & 0 & 0 & 0 & 1\end{matrix} ]$ |
| | $[ \begin{matrix}1 & 0 & 0 & 0 & 0 \\ 0 & 1 & 0 & 0 & 0 \\ 0 & 0 & 1 & 1 & 0 \\ 0 & 0 & 0 & 0 & 1 \\ 1 & 0 & 0 & 0 & 0 \\ 0 & 1 & 0 & 0 & 0 \\ 0 & 0 & 1 & - 1 & 0 \\ 0 & 0 & 0 & 0 & 1\end{matrix} ]$ |
| | $[ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 1 & 0 & 0 & 0 & 0 \\ 0 & 1 & 0 & 0 & 0 \\ 0 & 0 & 1 & 0 & 0 \\ 0 & 0 & 0 & 0 & 1\end{matrix} ]$ |

### Rank 6:

In one example, FC 8Tx FC/PC precoder is not included.
In one example, at least one 8Tx PC precoder with Ng=2 or 4 is included.
In one example, at least one 8Tx PC precoder with Ng=4 is included.
In one example, at least one 8Tx FC precoder (Ng=1) is included.
In one example, at least one 8Tx PC precoder with Ng=2 and at least one 8Tx PC precoder (Ng=4) is included.

TABLE 67
rank k = 6

| Index | Precoding matrix |
|---|---|
| | $\frac{1}{2 \sqrt{2}} [ \begin{matrix}1 & 0 & 0 & 0 & 0 & 0 \\ 1 & 0 & 0 & 0 & 0 & 0 \\ 0 & 0 & 1 & 0 & 0 & 0 \\ 0 & 0 & 0 & 1 & 0 & 0 \\ 0 & 1 & 0 & 0 & 0 & 0 \\ 0 & 1 & 0 & 0 & 0 & 0 \\ 0 & 0 & 0 & 0 & 1 & 0 \\ 0 & 0 & 0 & 0 & 0 & 1\end{matrix} ]$ |
| | $[ \begin{matrix}1 & 1 & 0 & 0 & 0 & 0 \\ 0 & 0 & 1 & 0 & 0 & 0 \\ 0 & 0 & 0 & 1 & 1 & 0 \\ 0 & 0 & 0 & 0 & 0 & 1 \\ 1 & - 1 & 0 & 0 & 0 & 0 \\ 0 & 0 & 1 & 0 & 0 & 0 \\ 0 & 0 & 0 & 1 & - 1 & 0 \\ 0 & 0 & 0 & 0 & 0 & 1\end{matrix} ]$ |
| | $[ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 1 & 0 & 0 & 0 & 0 & 0 \\ 0 & 1 & 0 & 0 & 0 & 0 \\ 0 & 0 & 0 & 0 & 1 & 0 \\ 0 & 0 & 0 & 0 & 0 & 1\end{matrix} ]$ |

### Rank 7:

In one example, FC 8Tx FC/PC precoder is not included.
In one example, at least one 8Tx PC precoder with Ng=2 or 4 is included.
In one example, at least one 8Tx PC precoder with Ng=4 is included.
In one example, at least one 8Tx FC precoder (Ng=1) is included.
In one example, at least one 8Tx PC precoder with Ng=2 and at least one 8Tx PC precoder (Ng=4) is included.

TABLE 68
rank r = 7

| Index | Precoding matrix |
|---|---|
| | $\frac{1}{2 \sqrt{2}} [ \begin{matrix}1 & 0 & 0 & 0 & 0 & 0 \\ 1 & 0 & 0 & 0 & 0 & 0 \\ 0 & 0 & 0 & 1 & 0 & 0 \\ 0 & 0 & 0 & 0 & 1 & 0 \\ 0 & 1 & 0 & 0 & 0 & 0 \\ 0 & 0 & 1 & 0 & 0 & 0 \\ 0 & 0 & 0 & 0 & 0 & 1 \\ 0 & 0 & 0 & 0 & 0 & 0\end{matrix} ]$ |
| | $[ \begin{matrix}1 & 1 & 0 & 0 & 0 & 0 \\ 0 & 0 & 1 & 0 & 0 & 0 \\ 0 & 0 & 0 & 1 & 1 & 0 \\ 0 & 0 & 0 & 0 & 0 & 1 \\ 1 & - 1 & 0 & 0 & 0 & 0 \\ 0 & 0 & 1 & 0 & 0 & 0 \\ 0 & 0 & 0 & 1 & - 1 & 0 \\ 0 & 0 & 0 & 0 & 0 & 1\end{matrix} ]$ |
| | $[ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 1 & 0 & 0\end{matrix} ]$ |

In one example, for Ng=8:
In one example, FC 8Tx FC/PC precoder is not included.
Rank 1: at least one 8Tx FC precoder with Ng=1
Rank 2,3: at least one 8Tx FC precoder with Ng=2
Rank 4,5,6,7: at least one 8Tx FC precoder with Ng=4

In one example, for Ng=8, precoders with fewer than 8 non-zero ports are also included. For example, for rank1, the at least one of the following is included.

$$[ \begin{matrix}1 \\ 0 \\ 0 \\ 0 \\ 1 \\ 0 \\ 0 \\ 0\end{matrix} ] ; [ \begin{matrix}0 \\ 1 \\ 0 \\ 0 \\ 0 \\ 1 \\ 0 \\ 0\end{matrix} ] ; [ \begin{matrix}0 \\ 0 \\ 1 \\ 0 \\ 0 \\ 0 \\ 1 \\ 0\end{matrix} ] ; [ \begin{matrix}0 \\ 0 \\ 0 \\ 1 \\ 0 \\ 0 \\ 0 \\ 1\end{matrix} ] ; [ \begin{matrix}1 \\ 1 \\ 0 \\ 0 \\ 1 \\ 1 \\ 0 \\ 0\end{matrix} ] ; [ \begin{matrix}0 \\ 0 \\ 1 \\ 1 \\ 0 \\ 0 \\ 1 \\ 1\end{matrix} ]$$

In one example, when N_{g}=8, the full power mode 1 for rank r=4, 5, 6, 7 is not supported, i.e., the full power mode 1 is supported for rank r=1, 2,3. Hence, the UE can be configured with 8Tx codebook for full power mode 1 only for rank 1,2,3, and 8Tx NFP codebook or 8Tx codebook without any FP precoding matrix for rank 4,5,6,7.

In one example, the FP and NFP precoding matrices for full power mode 1 for different rank r and N_{g} is summarized in Table 69 for the case when only 1 FP TPMI is included in the 8Tx codebook for rank 1 in case of N_{g}=2 and rank 1,2,3 in case of N_{g}=4,8.

TABLE 69

| | Full power precoding matrix | | Non-full power precoding matrix | |
|---|---|---|---|---|
| Rank r | Index | Precoding matrix | Index | Precoding matrix |
| 1 | I₀^{(N}^{_{g}}^{,1)} N_{g} = 2,4,8 | $\frac{1}{2 \sqrt{2}} [ \begin{matrix}1 \\ 1 \\ 1 \\ 1 \\ 1 \\ 1 \\ 1 \\ 1\end{matrix} ]$ | | All NFP (precoding matrices with zero rows) |
| 2 | I₀^{(N}^{_{g}}^{,2)} N_{g} = 4,8 | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ] or$ $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ | | All NFP (precoding matrices with zero rows) |
| 3 | I₃^{(N}^{_{g}}^{,3)} N_{g} = 4,8 | $\frac{1}{2 \sqrt{2}} [ \begin{matrix}1 & 0 & 0 \\ 1 & 0 & 0 \\ 0 & 1 & 0 \\ 1 & 0 & 1 \\ 1 & 0 & 0 \\ 0 & 0 & 0 \\ 0 & 1 & 0 \\ 0 & 0 & 1\end{matrix} ] or$ $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ | | All NFP (precoding matrices with zero rows) |
| 4-7 | N_{g} = 8 | Not supported | | All NFP |
| | | | | (precoding matrices with zero rows) |

| | |
|---|---|
| 8 | All FP |
| | (precoding matrices with non-zero rows) |
| | (no need for full power mode 1) |

In one example, a value of B=C_{R}_{ₘₐₓ} where C_{R}_{ₘₐₓ} is a total number of precoders in the 8Tx UL codebook for Ng=2 or 4 when max rank (e.g., configured via higher layer parameter maxRank) is Rₘₐₓ. Note Rₘₐₓ∈{1, 2, . . . , 8}. For the rank and layer split combinations as shown in Table 70 (or Table) and Table 72, for Ng=2 and Ng=4, respectively, the value of C_{R}_{ₘₐₓ} and TPMI payload are also shown.

The number of precoding matrices for full power mode 1 and the TPMI/TRI payload (number of bits) are summarized in Table 73 (or Table 74) and Table 75 for the following two examples.
Ex-A: 1 FP TPMI replaces 1 non-full power (NPF) TPMI.
Ex-B: 1 FP TPMI is included additionally.

TABLE 70
N_{g} = 2

| | Each layer in one | Layers split across 2 | #8Tx | | | |
|---|---|---|---|---|---|---|
| Rank | Antenna Group | Antenna Groups | precoders | Rₘₐₓ | C_{R}_{ₘₐₓ} | Payload |
| 1 | (1, 0), (0, 1) | | 32 | 1 | 32 | 5 |
| 2 | (2, 0), (0, 2) | (1, 1) | 16 + 256 | 2 | 304 | 9 |
| 3 | (3, 0), (0, 3) | (1, 2), (2, 1) | 8 + 256 | 3 | 568 | 10 |
| 4 | (4, 0), (0, 4) | (2, 2) | 4 + 64 | 4 | 636 | 10 |
| 5 | — | (2, 3), (3, 2) | 64 | 5 | 700 | 10 |
| 6 | — | (3, 3) | 16 | 6 | 716 | 10 |
| 7 | — | (3, 4), (4, 3) | 16 | 7 | 732 | 10 |
| 8 | — | (4, 4) | 4 | 8 | 736 | 10 |

TABLE 71
N_{g} = 2

| | Each layer | Layers split | | | | |
|---|---|---|---|---|---|---|
| | in one | across 2 | #8Tx | | | |
| | Antenna | Antenna | pre- | | | Pay- |
| Rank | Group | Groups | coders | Rₘₐₓ | C_{R}_{ₘₐₓ} | load |
| 1 | (1, 0), (0, 1) | | 32 | 1 | 32 | 5 |
| 2 | (2, 0), (0, 2) | (1, 1) | 16 + 256 | 2 | 304 | 9 |
| 3 | (3, 0), (0, 3) | (1, 2), (2, 1) | 8 + 256 | 3 | 568 | 10 |
| 4 | (4, 0), (0, 4) | (2, 2) | 4 + 64 | 4 | 636 | 10 |
| 5 | — | (2, 3) | 32 | 5 | 668 | 10 |
| 6 | — | (3, 3) | 16 | 6 | 684 | 10 |
| 7 | — | (3, 4) | 8 | 7 | 692 | 10 |
| 8 | — | (4, 4) | 4 | 8 | 696 | 10 |

TABLE 72
N_{g} = 4

| | Each layer in | | | | | |
|---|---|---|---|---|---|---|
| | one Antenna | Layers split across | #8Tx | | | |
| Rank | Group | 4 Antenna Groups | precoders | Rₘₐₓ | C_{R}_{ₘₐₓ} | Payload |
| 1 | (1, 0, 0, 0), | — | 16 | 1 | 16 | 4 |
| | (0, 1, 0, 0), | | | | | |
| | (0, 0, 1, 0), | | | | | |
| | (0, 0, 0, 1) | | | | | |
| 2 | (2, 0, 0, 0), | (1, 1, 0, 0), (1, 0, 1, 0), | 8 + 96 | 2 | 120 | 7 |
| | (0, 2, 0, 0), | (1, 0, 0, 1) | | | | |
| | (0, 0, 2, 0), | (0, 1, 1, 0), (0, 1, 0, 1), | | | | |
| | (0, 0, 0, 2) | (0, 0, 1, 1) | | | | |
| 3 | — | (2, 1, 0, 0), (2, 0, 1, 0), | 48 + 256 | 3 | 424 | 9 |
| | | (2, 0, 0, 1), (0, 2, 1, 0), | | | | |
| | | (0, 2, 0, 1), (0, 0, 2, 1), | | | | |
| | | (1, 1, 1, 0), (1, 1, 0, 1), | | | | |
| | | (1, 0, 1, 1), (0, 1, 1, 1) | | | | |
| 4 | — | (1, 1, 1, 1) | 256 + 24 | 4 | 704 | 10 |
| | | (2, 2, 0, 0), (2, 0, 2, 0), | | | | |
| | | (2, 0, 0, 2) | | | | |
| | | (0, 2, 2, 0), (0, 2, 0, 2), | | | | |
| | | (0, 0, 2, 2) | | | | |
| 5 | — | (2, 0, 2, 1), (0, 2, 2, 1) | 32 + 128 | 5 | 864 | 10 |
| | | (1, 1, 2, 1) | | | | |
| 6 | — | (2, 2, 2, 0), (2, 0, 2, 2) | 16 + 64 | 6 | 944 | 10 |
| | | (2, 1, 2, 1) | | | | |
| 7 | — | (2, 1, 2, 2) | 32 | 7 | 976 | 10 |
| 8 | — | (2, 2, 2, 2) | 16 | 8 | 992 | 10 |

TABLE 73
N_{g} = 2

| | Ex-A: 1 FP TPMI | | | | Ex-B: 1 FP TPMI is | | |
|---|---|---|---|---|---|---|---|
| | replaces 1 NPF TPMI | | | | included additionally | | |
| | #8Tx | | | | #8Tx | | |
| | pre- | | Pay- | | pre- | | Pay- |
| Rₘₐₓ | coders | C_{R}_{ₘₐₓ} | load | Rₘₐₓ | coders | C_{R}_{ₘₐₓ} | load |
| 1 | 32 | 32 | 5 | 1 | 32 + 1 | 33 | 6 |
| 2 | 16 + 256 | 304 | 9 | 2 | 16 + 256 | 305 | 9 |
| 3 | 8 + 256 | 568 | 10 | 3 | 8 + 256 | 569 | 10 |
| 4 | 4 + 64 | 636 | 10 | 4 | 4 + 64 | 637 | 10 |
| 5 | 32 | 668 | 10 | 5 | 64 | 669 | 10 |
| 6 | 16 | 684 | 10 | 6 | 16 | 685 | 10 |
| 7 | 8 | 692 | 10 | 7 | 16 | 693 | 10 |
| 8 | 4 | 696 | 10 | 8 | 4 | 697 | 10 |

TABLE 74
N_{g} = 2

| | Ex-A: 1 FP TPMI | | | | Ex-B: 1 FP TPMI is | | |
|---|---|---|---|---|---|---|---|
| | replaces 1 NPF TPMI | | | | included additionally | | |
| | #8Tx | | | | #8Tx | | |
| | pre- | | Pay- | | pre- | | Pay- |
| Rₘₐₓ | coders | C_{R}_{ₘₐₓ} | load | Rₘₐₓ | coders | C_{R}_{ₘₐₓ} | load |
| 1 | 32 | 32 | 5 | 1 | 32 + 1 | 33 | 6 |
| 2 | 16 + 256 | 304 | 9 | 2 | 16 + 256 | 305 | 9 |
| 3 | 8 + 256 | 568 | 10 | 3 | 16 + 256 | 569 | 10 |
| 4 | 4 + 64 | 636 | 10 | 4 | 4 + 64 | 637 | 10 |
| 5 | 64 | 700 | 10 | 5 | 64 | 701 | 10 |
| 6 | 16 | 716 | 10 | 6 | 16 | 717 | 10 |
| 7 | 16 | 732 | 10 | 7 | 16 | 733 | 10 |
| 8 | 4 | 736 | 10 | 8 | 4 | 737 | 10 |

TABLE 75
N_{g} = 4

| | Ex-A: 1 FP TPMI | | | | Ex-B: 1 FP TPMI is | | |
|---|---|---|---|---|---|---|---|
| | replaces 1 NPF TPMI | | | | included additionally | | |
| | #8Tx | | | | #8Tx | | |
| | pre- | | Pay- | | pre- | | Pay- |
| Rₘₐₓ | coders | C_{R}_{ₘₐₓ} | load | Rank | coders | C_{R}_{ₘₐₓ} | load |
| 1 | 16 | 16 | 4 | 1 | 16 + 1 | 17 | 5 |
| 2 | 8 + 96 | 120 | 7 | 2 | 8 + | 122 | 7 |
| | | | | | 96 + 1 | | |
| 3 | 48 + 256 | 424 | 9 | 3 | 48 + | 427 | 9 |
| | | | | | 256 + 1 | | |
| 4 | 256 + 24 | 704 | 10 | 4 | 256 | 704 | 10 |
| 5 | 32 + 128 | 864 | 10 | 5 | 32 + 128 | 864 | 10 |
| 6 | 16 + 64 | 944 | 10 | 6 | 16 + 64 | 944 | 10 |
| 7 | 32 | 976 | 10 | 7 | 32 | 976 | 10 |
| 8 | 16 | 992 | 10 | 8 | 16 | 992 | 10 |

In one example, when N_{g}=8, the number of precoders is 255 that include rank 1-8 precoders based on antenna port selection (i.e., 1 port per layer).

TABLE 76
N_{g} = 8

| | Ex-A: 1 FP TPMI | | | | Ex-B: 1 FP TPMI is | | |
|---|---|---|---|---|---|---|---|
| | replaces 1 NPF TPMI | | | | included additionally | | |
| | #8Tx | | | | #8Tx | | |
| | pre- | | Pay- | | pre- | | Pay- |
| Rₘₐₓ | coders | C_{R}_{ₘₐₓ} | load | Rank | coders | C_{R}_{ₘₐₓ} | load |
| 1 | 8 | 8 | 3 | 1 | 8 + 1 | 9 | 4 |
| 2 | 28 | 36 | 6 | 2 | 28 + 1 | 38 | 6 |
| 3 | 56 | 92 | 7 | 3 | 56 + 1 | 96 | 7 |
| 4 | 70 | 162 | 8 | 4 | 70 | 165 | 8 |
| 5 | 56 | 218 | 8 | 5 | 56 | 221 | 8 |
| 6 | 28 | 246 | 8 | 6 | 28 | 249 | 8 |
| 7 | 8 | 254 | 8 | 7 | 8 | 257 | 9 |
| 8 | 1 | 255 | 8 | 8 | 1 | 258 | 9 |

At least one of the following examples is used regarding TPMI/TRI indication (e.g., via UL-DCI format 0_1 or/and 0_2).
In one example, Ex-A is used for rank 1 (1 FP TPMI replaces 1 NFP TPMI), and Ex-B is used for rank=2, 3 (i.e., 1 FP TPMI is included additionally).
In one example, Ex-A is used for rank and N_{g} values.
In one example, Ex-B is used for rank and N_{g} values.
In one example, when maxRank=1, Ex-A is used for N_{g} values, and when maxRank>1, Ex=B is used for N_{g} values.

TABLE 77
Precoding information and number of layers, for 8 antenna ports, maxRank =
2, 3 or 4, Ng = 8, and ul-FullPowerTransmission configured to fullpowerMode1

| Bit field | maxRank = | Bit field | maxRank = |
|---|---|---|---|
| mapped to index | 2 | mapped to index | 3 |
| 0 | 1 layer: TPMI = 0 | 0 | 1 layer: TPMI = 0 |
| . . . | . . . | . . . | . . . |
| 7 | 1 layer: TPMI = 7 | 7 | 1 layer: TPMI = 7 |
| 8 | 2 layers: TPMI = 8 | 8 | 2 layers: TPMI = 8 |
| . . . | . . . | . . . | . . . |
| 35 | 2 layers: TPMI = 35 | 35 | 2 layers: TPMI = 35 |
| 36 | 1 layer: TPMI = 255 | 36 | 3 layers: TPMI = 36 |
| | of Ng = 8, or | | |
| | 1 layer: TPMI = 0 | | |
| | of Ng = 1 | | |
| 37 | 2 layers: TPMI = 256 | . . . | . . . |
| | of Ng = 8, or | | |
| | 2 layers: TPMI = 16 | | |
| | of Ng = 2 | | |
| 38-63 | reserved | 91 | 3 layers: TPMI = 91 |
| | | 92 | 1 layer: TPMI = 255 |
| | | | of Ng = 8, or |
| | | | 1 layer: TPMI = 0 |
| | | | of Ng = 1 |
| | | 93 | 2 layers: TPMI = 256 |
| | | | of Ng = 8, or |
| | | | 2 layers: TPMI = 16 |
| | | | of Ng = 2 |
| | | 94 | 3 layers: TPMI = 257 |
| | | | of Ng = 8 |
| | | 95-127 | reserved |

TABLE 78
Precoding information and number of layers, for
8 antenna ports, maxRank = 1, Ng = 8,
and ul-FullPowerTransmission configured to fullpowerMode1

| Bit field mapped | Precoding information |
|---|---|
| to index | and number of layers |
| 0 | 1 layer: TPMI = 0 |
| . . . | . . . |
| 7 | 1 layer: TPMI = 7 |
| 8 | 1 layer: TPMI = 255 |
| | of Ng = 8, or |
| | 1 layer: TPMI = 0 |
| | of Ng = 1 |
| 9-15 | reserved |

TABLE 79
Precoding information and number of layers, for
8 antenna ports, maxRank = 1, Ng = 2,
and ul-FullPowerTransmission configured to fullpowerMode1

| Bit field mapped | Precoding information |
|---|---|
| to index | and number of layers |
| 0 | 1 layer: TPMI = 0 |
| . . . | . . . |
| 31 | 1 layer: TPMI = 31 |
| 32 | 1 layer: TPMI = 32 |
| | of Ng = 2, or |
| | 1 layer: TPMI = 0 |
| | of Ng = 1 |
| 33-63 | reserved |

TABLE 80
Precoding information and number of layers, for 8 antenna ports, maxRank =
1, 2 or 3, Ng = 4, and ul-FullPowerTransmission configured to fullpowerMode1

| | Transform precoder is | | transform | | transform |
|---|---|---|---|---|---|
| Bit field | enabled, or maxRank = | Bit field | precoder is | Bit field | precoder is |
| mapped to | 1 if transform | mapped to | disabled and | mapped to | disabled and |
| index | precoder is disabled | index | maxRank = 2 | index | maxRank = 3 |
| 0 | 1 layer: TPMI = 0 | 0 | 1 layer: TPMI = 0 | 0 | 1 layer: TPMI = 0 |
| . . . | . . . | . . . | . . . | . . . | . . . |
| 15 | 1 layer: TPMI = 15 | 15 | 1 layer: TPMI = 15 | 15 | 1 layer: TPMI = 15 |
| 16 | 1 layer: TPMI = 16 | 16 | 2 layers: TPMI = 0 | 16 | 2 layers: TPMI = 0 |
| | of Ng = 4, or | | | | |
| | 1 layer: TPMI = 0 | | | | |
| | of Ng = 1 | | | | |
| 17-31 | reserved | . . . | . . . | . . . | . . . |
| | | 119 | 2 layers: TPMI = 103 | 119 | 2 layers: TPMI = 103 |
| | | 120 | 1 layer: TPMI = 16 | 120 | 3 layers: TPMI = 0 |
| | | | of Ng = 4, or | | |
| | | | 1 layer: TPMI = 0 | | |
| | | | of Ng = 1 | | |
| | | 121 | 2 layers: TPMI = 104 | . . . | . . . |
| | | | of Ng = 4, or | | |
| | | | 2 layers: TPMI = 16 | | |
| | | | of Ng = 2 | | |
| | | 122-127 | reserved | 423 | 3 layers: TPMI = 303 |
| | | | | 424 | 1 layer: TPMI = 16 |
| | | | | | of Ng = 4, or |
| | | | | | 1 layer: TPMI = 0 |
| | | | | | of Ng = 1 |
| | | | | 425 | 2 layers: TPMI = 104 |
| | | | | | of Ng = 4, or |
| | | | | | 2 layers: TPMI = 16 |
| | | | | | of Ng = 2 |
| | | | | 426 | 3 layers: TPMI = 304 |
| | | | | | of Ng = 4 |
| | | | | 427-511 | reserved |

In one example, UL-DCI (DCI format 0_1 or 0_2) is used for the scheduling of one or multiple PUSCH in one cell or indicating configured grant (CG) downlink feedback information (CG-DFI) to a UE. The information (Precoding information and number of layers, TPMI/TRI, field) is transmitted by means of the DCI format 0_1 with cyclic redundancy check (CRC) scrambled by cell radio network temporary identifier (C-RNTI) or configured scheduling RNTI (CS-RNTI) or Semi-Persistent CSI RNTI (SP-CSI-RNTI) or modulation and coding scheme C-RNTI (MCS-C-RNTI).

Precoding information and number of layers—number of bits determined by the following:
6 or 7 or 8 bits according to Table 77 for 8 antenna ports, if Ng=8, transform precoder is disabled, maxRank=2 or 3, ul-FullPowerTransmission is configured to fullpowerrMode1, and according to maxRank.
4 bits according to Table 78 for 8 antenna ports, if Ng=8, transform precoder is enabled or maxRank=1 if transform precoder is disabled, ul-FullPowerTransmission is configured to fullpowerMode1.
6 bits according to Table 79 for 8 antenna ports, if Ng=2, transform precoder is enabled or maxRank=1 if transform precoder is disabled, ul-FullPowerTransmission is configured to fullpowerMode1.
5, 7 or 9 bits according to Table 80 for 8 antenna ports, if Ng=4, transform precoder is enabled or maxRank=1, 2, or 3 if transform precoder is disabled, ul-FullPowerTransmission is configured to fullpowerMode1, and according to transform precoder and maxRank.

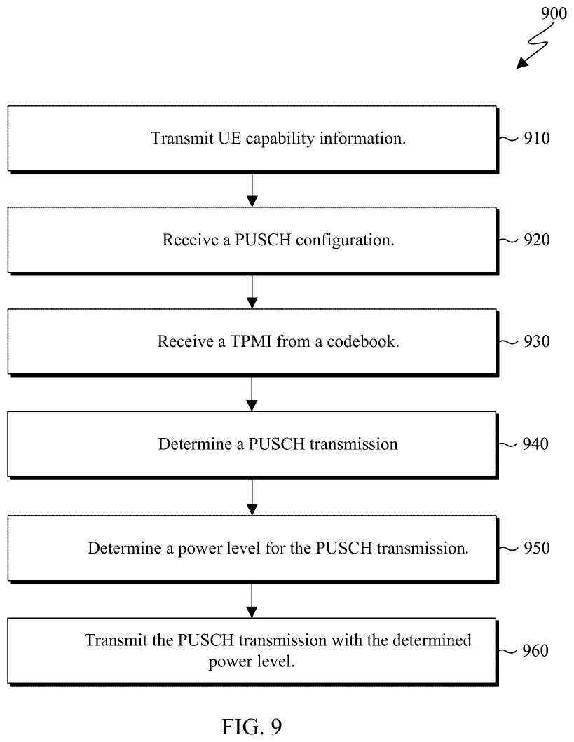

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE transmitting UE capability information (910). For example, in 910, the UE capability information may include information for a codebook-based UL transmission using eight antenna ports and information indicating whether the UE supports a UL full power transmission mode of fullpowerMode1 or fullpowerMode2. The UE then receives a PUSCH configuration (920). For example, in 920, the PUSCH configuration includes a first parameter indicating a codebook and a second parameter ul-FullPowerTransmission8Tx.

The UE then receives a TPMI from the codebook (930). For example, in 930, the TPMI indicates a precoding matrix and a number of layers for the PUSCH transmission. The UE then determines a PUSCH transmission (940). For example, in 940, the determination may be based on the PUSCH configuration. The UE then determines a power level for the PUSCH transmission (950). For example, in 950, the determination may be based on the PUSCH configuration. The power level corresponds to full power if the TPMI is a full power TPMI. The UE then transmits the PUSCH transmission with the determined power level (960).

In various embodiments, the UE is capable of supporting the UL full power transmission mode of fullpowerMode1, ul-FullPowerTransmission8Tx is set to fullpowerMode1 and the UE is capable of supporting the UL full power transmission mode of fullpowerMode2.

In various embodiments, the ul-FullPowerTransmission8Tx is set to fullpowerMode2, the UE capability information further indicates a group of full power TPMIs, and the power level corresponds to full power if the TPMI is included in the group of full power TPMIs. In various embodiments, the when the codebook corresponds to N_{g}=2, the eight antenna ports is partitioned into two antenna groups {g1, g2}, each with four antenna ports and the UE capability information further indicates the group of full power TPMIs via a parameter taking a value from {g1, g2} to indicate one of the two antenna groups corresponding to the indicated full power TPMIs. In various embodiments, the the full power TPMIs corresponds to FC TPMIs for four antenna ports.

In various embodiments, the UE is capable of supporting the UL full power transmission mode of fullpowerMode2, ul-FullPowerTransmission8Tx is set to fullpowerMode2, the UE capability information further indicates whether the UE supports SRS configurations with different number of antenna ports per SRS resource, and the PUSCH configuration includes a third parameter indicating a set of SRS resources, including (i) at least one SRS resource with eight ports and one SRS resource with four ports or (ii) one SRS resource with two ports. In various embodiments, when the codebook for eight antenna ports corresponds to N_{g}=2, the codebook associated with the two port SRS resource is ‘nonCoherent’, when the codebook for eight antenna ports corresponds to N_{g}=2, the codebook associated with the four port SRS resource can be configured as ‘partialAndNonCoherent’ or ‘nonCoherent’, subject to UE capability, and when the codebook for eight antenna ports corresponds to N_{g}=4, the codebook associated with the four port SRS resource is ‘nonCoherent’.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to:
transmit UE capability information including (i) information for a codebook-based uplink (UL) transmission using eight antenna ports and (ii) information indicating whether the UE supports a UL full power transmission mode of fullpowerMode1 or fullpowerMode2,
receive a physical uplink shared channel (PUSCH) configuration, wherein the PUSCH configuration includes a first parameter indicating a codebook for a transmit precoding matrix indicator (TPMI) and a second parameter ul-FullPowerTransmission8Tx, and
receive the TPMI; and
a processor operably coupled to the transceiver, the processor, based on the PUSCH configuration, configured to:
determine a PUSCH transmission; and
determine a power level for the PUSCH transmission,
wherein the transceiver is further configured to transmit the PUSCH transmission with the determined power level,
wherein the power level corresponds to full power when the TPMI is a full power TPMI, and
wherein the TPMI indicates a precoding matrix and a number of layers for the PUSCH transmission.

2. The UE of claim 1, wherein:
the UE is capable of supporting the UL full power transmission mode of fullpowerMode1,
ul-FullPowerTransmission8Tx is set to fullpowerMode1, and
when the codebook corresponds to N_{g}=2, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |

when the codebook corresponds to N_{g}=4, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

when the codebook corresponds to N_{g}=8, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 0 & 1 & 0 \\ 0 & 0 & 1 \\ 1 & 0 & 0 \\ 1 & 0 & 0 \\ 0 & 1 & 0 \\ 0 & 0 & 1\end{matrix} ]$ |
| Four-layer | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 1 & 0 & 0 & 0 \\ 0 & 1 & 0 & 0 \\ 0 & 0 & 1 & 0 \\ 0 & 0 & 0 & 1\end{matrix} ]$ |

3. The UE of claim 1, wherein:
the UE is capable of supporting the UL full power transmission mode of fullpowerMode2,
ul-FullPowerTransmission8Tx is set to fullpowerMode2,
the UE capability information further indicates a group of full power TPMIs, and
the power level corresponds to full power if the TPMI is included in the group of full power TPMIs.

4. The UE of claim 3, wherein:
when the codebook corresponds to N_{g}=2, the eight antenna ports is partitioned into two antenna port groups {g1, g2}, each with four antenna ports, and
the UE capability information further indicates the group of full power TPMIs via a parameter taking a value from {g1, g2} to indicate one of the two antenna port groups corresponding to the indicated full power TPMIs.

5. The UE of claim 4, wherein the full power TPMIs are based on full-coherent (FC) TPMIs for four antenna ports, and are given by

| Rank (number of layers) | TPMI group | FC TPMI for 4 antenna ports |
|---|---|---|
| 1 | Q0 | Rank 1 TPMI 12-27 |
| 2 | Q1 | Rank 2 TPMI 14-21 |
| 3 | Q2 | Rank 3 TPMI 3-6 |
| 4 | Q3 | Rank 4 TPMI 3-4 |

where

| Rank 1 | | | | | | | | |
|---|---|---|---|---|---|---|---|---|
| TPMI | | | | | | | | |
| Index | (ordered from left to right in increasing order of TPMI index) | | | | | | | |
| 12-19 | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ |
| 20-27 | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ 1\end{matrix} ]$ | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ |
| Rank 2 | | | | |
|---|---|---|---|---|
| TPMI | | | | |
| Index | (ordered from left to right in increasing order of TPMI index) | | | |
| 14-17 | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ |
| 18-21 | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |
| Rank 3 | | | | |
| TPMI | | | | |
| Index | (ordered from left to right in increasing order of TPMI index) | | | |
| 3-6 | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |
| Rank 4 | | |
|---|---|---|
| TPMI | | |
| Index | (ordered from left to right in increasing order of TPMI index) | |
| 3-4 | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

6. The UE of claim 1, wherein:
the UE is capable of supporting the UL full power transmission mode of fullpowerMode2,
ul-FullPowerTransmission8Tx is set to fullpowerMode2,
the UE capability information further indicates whether the UE supports sounding reference signal (SRS) configurations with different number of antenna ports per SRS resource, and
the PUSCH configuration includes a third parameter indicating a set of SRS resources, including (i) at least one SRS resource with eight ports and (ii) one SRS resource with four ports or one SRS resource with two ports.

7. The UE of claim 6, wherein:
when the codebook for eight antenna ports corresponds to N_{g}=2, the codebook associated with the two port SRS resource is ‘nonCoherent’,
when the codebook for eight antenna ports corresponds to N_{g}=2, the codebook associated with the four port SRS resource can be configured as ‘partialAndNonCoherent’ or ‘nonCoherent’, subject to UE capability, and
when the codebook for eight antenna ports corresponds to N_{g}=4, the codebook associated with the four port SRS resource is ‘nonCoherent’.

8. A base station (BS) comprising:
a transceiver configured to:
receive, from a user equipment (UE), UE capability information including (i) information for a codebook-based uplink (UL) transmission using eight antenna ports and (ii) information indicating whether the UE supports a UL full power transmission mode of fullpowerMode1 or fullpowerMode2,
transmit a physical uplink shared channel (PUSCH) configuration, wherein the PUSCH configuration includes a first parameter indicating a codebook for a transmit precoding matrix indicator (TPMI) and a second parameter ul-FullPowerTransmission8Tx,
transmit the TPMI, and
receive a PUSCH associated with the PUSCH configuration,
wherein a power level for the PUSCH corresponds to full power when the TPMI is a full power TPMI, and
wherein the TPMI indicates a precoding matrix and a number of layers for the PUSCH.

9. The BS of claim 8, wherein:
the UE is capable of supporting the UL full power transmission mode of fullpowerMode1,
ul-FullPowerTransmission8Tx is set to fullpowerMode1, and
when the codebook corresponds to N_{g}=2, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |

when the codebook corresponds to N_{g}=4, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

when the codebook corresponds to N_{g}=8, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 0 & 1 & 0 \\ 0 & 0 & 1 \\ 1 & 0 & 0 \\ 1 & 0 & 0 \\ 0 & 1 & 0 \\ 0 & 0 & 1\end{matrix} ]$ |
| Four-layer | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 1 & 0 & 0 & 0 \\ 0 & 1 & 0 & 0 \\ 0 & 0 & 1 & 0 \\ 0 & 0 & 0 & 1\end{matrix} ]$ |

10. The BS of claim 8, wherein:
the UE is capable of supporting the UL full power transmission mode of fullpowerMode2,
ul-FullPowerTransmission8Tx is set to fullpowerMode2,
the UE capability information further indicates a group of full power TPMIs, and
the power level corresponds to full power if the TPMI is included in the group of full power TPMIs.

11. The BS of claim 10, wherein:
when the codebook corresponds to N_{g}=2, the eight antenna ports is partitioned into two antenna port groups {g1, g2}, each with four antenna ports, and
the UE capability information further indicates the group of full power TPMIs via a parameter taking a value from {g1, g2} to indicate one of the two antenna port groups corresponding to the indicated full power TPMIs.

12. The BS of claim 11, wherein the full power TPMIs are based on full-coherent (FC) TPMIs for four antenna ports, and are given by

| Rank (number of layers) | TPMI group | FC TPMI for 4 antenna ports |
|---|---|---|
| 1 | Q0 | Rank 1 TPMI 12-27 |
| 2 | Q1 | Rank 2 TPMI 14-21 |
| 3 | Q2 | Rank 3 TPMI 3-6 |
| 4 | Q3 | Rank 4 TPMI 3-4 |

where

| Rank 1 | | | | | | | | |
|---|---|---|---|---|---|---|---|---|
| TPMI | | | | | | | | |
| Index | (ordered from left to right in increasing order of TPMI index) | | | | | | | |
| 12-19 | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ |
| 20-27 | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ |
| Rank 2 | | | | |
|---|---|---|---|---|
| TPMI | | | | |
| Index | (ordered from left to right in increasing order of TPMI index) | | | |
| 14-17 | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ |
| 18-21 | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |
| Rank 3 | | | | |
| TPMI | | | | |
| Index | (ordered from left to right in increasing order of TPMI index) | | | |
| 3-6 | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |
| Rank 4 | | |
|---|---|---|
| TPMI | | |
| Index | (ordered from left to right in increasing order of TPMI index) | |
| 3-4 | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

13. The BS of claim 8, wherein:
the UE is capable of supporting the UL full power transmission mode of fullpowerMode2,
ul-FullPowerTransmission8Tx is set to fullpowerMode2,
the UE capability information further indicates whether the UE supports sounding reference signal (SRS) configurations with different number of antenna ports per SRS resource, and
the PUSCH configuration includes a third parameter indicating a set of SRS resources, including (i) at least one SRS resource with eight ports and (ii) one SRS resource with four ports or one SRS resource with two ports.

14. The BS of claim 13, wherein:
when the codebook for eight antenna ports corresponds to N_{g}=2, the codebook associated with the two port SRS resource is ‘nonCoherent’,
when the codebook for eight antenna ports corresponds to N_{g}=2, the codebook associated with the four port SRS resource can be configured as ‘partialAndNonCoherent’ or ‘nonCoherent’, subject to UE capability, and
when the codebook for eight antenna ports corresponds to N_{g}=4, the codebook associated with the four port SRS resource is ‘nonCoherent’.

15. A method performed by a user equipment (UE), the method comprising:
transmitting UE capability information including (i) information for a codebook-based uplink (UL) transmission using eight antenna ports and (ii) information indicating whether the UE supports a UL full power transmission mode of fullpowerMode1 or fullpowerMode2;
receiving a physical uplink shared channel (PUSCH) configuration, wherein the PUSCH configuration includes a first parameter indicating a codebook for a transmit precoding matrix indicator (TPMI) and a second parameter ul-FullPowerTransmission8Tx;
receiving the TPMI;
determining a PUSCH transmission based on the PUSCH configuration;
determining a power level for the PUSCH transmission based on the PUSCH configuration; and
transmitting the PUSCH transmission with the determined power level,
wherein the power level corresponds to full power when the TPMI is a full power TPMI, and
wherein the TPMI indicates a precoding matrix and a number of layers for the PUSCH transmission.

16. The method of claim 15, wherein:
the UE is capable of supporting the UL full power transmission mode of fullpowerMode1,
ul-FullPowerTransmission8Tx is set to fullpowerMode1, and
when the codebook corresponds to N_{g}=2, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |

when the codebook corresponds to N_{g}=4, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 1 & 0 \\ 1 & 0 \\ 0 & 1 \\ 0 & 1 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ]$ |

when the codebook corresponds to N_{g}=8, the full power TPMI indicates a precoding matrix W given by

| Full power TPMI for | Precoding matrix W |
|---|---|
| Single-layer | $\frac{1}{2 \sqrt{2}} [ \begin{matrix}1 \\ 1 \\ 1 \\ 1 \\ 1 \\ 1 \\ 1 \\ 1\end{matrix} ]$ |
| Two-layer | $\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & 1 \\ 0 & 1\end{matrix} ]$ |
| Three-layer | $\frac{1}{2 \sqrt{2}} [ \begin{matrix}1 & 0 & 0 \\ 1 & 0 & 0 \\ 0 & 1 & 0 \\ 0 & 0 & 1 \\ 1 & 0 & 0 \\ 1 & 0 & 0 \\ 0 & 1 & 0 \\ 0 & 0 & 1\end{matrix} ]$ |
| Four-layer | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 1 & 0 & 0 & 0 \\ 0 & 1 & 0 & 0 \\ 0 & 0 & 1 & 0 \\ 0 & 0 & 0 & 1\end{matrix} ]$ |

17. The method of claim 15, wherein:
the UE is capable of supporting the UL full power transmission mode of fullpowerMode2,
ul-FullPowerTransmission8Tx is set to fullpowerMode2,
the UE capability information further indicates a group of full power TPMIs, and
the power level corresponds to full power if the TPMI is included in the group of full power TPMIs.

18. The method of claim 17, wherein:
when the codebook corresponds to N_{g}=2, the eight antenna ports is partitioned into two antenna port groups {g1, g2}, each with four antenna ports, and
the UE capability information further indicates the group of full power TPMIs via a parameter taking a value from {g1, g2} to indicate one of the two antenna port groups corresponding to the indicated full power TPMIs.

19. The method of claim 18, wherein the full power TPMIs are based on full-coherent (FC) TPMIs for four antenna ports, and are given by

| Rank (number of layers) | TPMI group | FC TPMI for 4 antenna ports |
|---|---|---|
| 1 | Q0 | Rank 1 TPMI 12-27 |
| 2 | Q1 | Rank 2 TPMI 14-21 |
| 3 | Q2 | Rank 3 TPMI 3-6 |
| 4 | Q3 | Rank 4 TPMI 3-4 |

where

| Rank 1 | | | | | | | | |
|---|---|---|---|---|---|---|---|---|
| TPMI | | | | | | | | |
| Index | (ordered from left to right in increasing order of TPMI index) | | | | | | | |
| 12-19 | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}\begin{matrix}1 \\ j \\ - j\end{matrix} \\ 1\end{matrix} ]$ |
| 20-27 | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ |
| Rank 2 | | | | |
|---|---|---|---|---|
| TPMI | | | | |
| Index | (ordered from left to right in increasing order of TPMI index) | | | |
| 14-17 | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ |
| 18-21 | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |
| Rank 3 | | | | |
| TPMI | | | | |
| Index | (ordered from left to right in increasing order of TPMI index) | | | |
| 3-6 | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |
| Rank 4 | | |
|---|---|---|
| TPMI | | |
| Index | (ordered from left to right in increasing order of TPMI index) | |
| 3-4 | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

20. The method of claim 15, wherein:
the UE is capable of supporting the UL full power transmission mode of fullpowerMode2,
ul-FullPowerTransmission8Tx is set to fullpowerMode2,
the UE capability information further indicates whether the UE supports sounding reference signal (SRS) configurations with different number of antenna ports per SRS resource,
the PUSCH configuration includes a third parameter indicating a set of SRS resources, including (i) at least one SRS resource with eight ports and (ii) one SRS resource with four ports or one SRS resource with two ports,
when the codebook for eight antenna ports corresponds to N_{g}=2, the codebook associated with the two port SRS resource is ‘nonCoherent’,
when the codebook for eight antenna ports corresponds to N_{g}=2, the codebook associated with the four port SRS resource can be configured as ‘partialAndNonCoherent’ or ‘nonCoherent’, subject to UE capability, and
when the codebook for eight antenna ports corresponds to N_{g}=4, the codebook associated with the four port SRS resource is ‘nonCoherent’.
